(19) United States
(12) Patent Application Publication
(10) Pub. No.: US 2022/0411692 A1
(43) Pub. Date: Dec. 29, 2022

(54) COMPOSITION CONTAINING SEMICONDUCTOR NANOPARTICLES, COLOR FILTER, AND IMAGE DISPLAY DEVICE

(71) Applicant: MITSUBISHI CHEMICAL CORPORATION, Tokyo (JP)

(72) Inventors: Koki ISHII, Tokyo (JP); Masaaki NISHIMURA, Tokyo (JP); Takashi FUJIWARA, Tokyo (JP); Tomotaka TANIGUCHI, Tokyo (JP); Shigeki HATTORI, Tokyo (JP); Shiharu HIRAOKA, Tokyo (JP); Yasushi SHIGA, Tokyo (JP); Hiroko INAGAKI, Tokyo (JP)

(73) Assignee: MITSUBISHI CHEMICAL CORPORATION, Tokyo (JP)

(21) Appl. No.: 17/881,828

(22) Filed: Aug. 5, 2022

Related U.S. Application Data
(63) Continuation of application No. PCT/JP2021/003863, filed on Feb. 3, 2021.

(30) Foreign Application Priority Data
Feb. 10, 2020 (JP) 2020-020428
Mar. 23, 2020 (JP) 2020-050698
Mar. 23, 2020 (JP) 2020-050699
Apr. 7, 2020 (JP) 2020-068974
Jun. 17, 2020 (JP) 2020-104194

(51) Int. Cl. C09K 11/02; C09K 11/06; C09K 11/88; C09K 11/08; C09B 67/20; G02B 5/22

(52) U.S. Cl. CPC C09K 11/02; C09K 11/06; C09K 11/883; C09K 11/0883; C09B 67/0063; G02B 5/22; C09K 2211/1018; C09K 2211/1007; C09K 2211/1014; B82Y 20/00

(57) ABSTRACT

Provided is a semiconductor nanoparticle-containing composition capable of forming a wavelength conversion layer that efficiently converts the wavelength of excitation light and exhibits sufficient luminescence intensity. An aspect of the semiconductor nanoparticle-containing composition of the present invention contains semiconductor nanoparticles (A) and a coloring matter (B) and further contains a polymerizable compound (C), in which the semiconductor nanoparticles (A) have a maximum emission wavelength in the range of 500 to 670 nm over a wavelength range of 300 to 780 nm, and the coloring matter (B) contains at least one selected from coloring matters (B1) to (B5) having specific structures.

This application is a continuation application of International Application No. PCT/JP2021/003863, filed Feb. 3, 2021, which claims the benefit of priorities of the prior Japanese Patent Application No. 2020-020428, filed Feb. 10, 2020; Japanese Patent Application No. 2020-050698, filed Mar. 23, 2020; Japanese Patent Application No. 2020-050699, filed Mar. 23, 2020; Japanese Patent Application No. 2020-068974, filed Apr. 7, 2020; and Japanese Patent Application No. 2020-104194, filed Jun. 17, 2020, the contents of which are incorporated herein by reference.

### TECHNICAL FIELD

The present invention relates to a semiconductor nanoparticle-containing composition, a color filter, and an image display device.

### BACKGROUND ART

Display devices such as liquid crystal display devices have low power consumption and are being used in an increasing number of applications as space-saving image display devices year by year; however, in recent years, further power saving and improvement of color reproducibility are required.

Due to such a background, it has been proposed to utilize a wavelength conversion layer including, as a luminescent material, semiconductor nanoparticles such as quantum dots, quantum rods, and other inorganic fluorescent particles, which emit light by converting the wavelength of incident light in order to increase the light utilization efficiency and enhance the color reproducibility.

Generally, such semiconductor nanoparticles such as quantum dots are dispersed in a resin or the like to be used, for example, as a wavelength conversion film that performs wavelength conversion or as a wavelength conversion type color filter pixel part.

Meanwhile, conventionally, a color filter pixel part in a display such as a liquid crystal display device has been produced by a photolithography method by using, for example, a curable resist material containing a pigment and an alkali-soluble resin and/or an acrylic monomer.

However, when an attempt is made to form a wavelength conversion type color filter pixel part by applying a method for producing a color filter according to the above-described photolithography method, there is a drawback that most of the resist material including semiconductor nanoparticles is lost in a developing process. Therefore, it has also been considered to form a wavelength conversion type color filter pixel part by an inkjet method (Patent Document 1).

### CITATION LIST

### Patent Document

### [Patent Document 1]

Japanese Unexamined Patent Application, First Publication No. 2019-85537

### SUMMARY OF INVENTION

### Technical Problem

According to the investigation made by the inventors of the present invention, it was found that since semiconductor nanoparticles have low absorbance in the excitation wavelength range, semiconductor nanoparticles have a problem that when a wavelength conversion layer produced by using a semiconductor nanoparticle-containing composition is used for a display, a sufficient luminescence intensity is not obtained. Specifically, it was found that in the pixel part of the wavelength conversion type color filter formed by using a semiconductor nanoparticle-containing composition disclosed in Patent Document 1 and the like, there is a problem that a sufficient luminescence intensity is not obtained with desired pixels of red, green, and the like.

Thus, an object of the present invention is to provide a semiconductor nanoparticle-containing composition capable of forming a wavelength conversion layer that efficiently converts the wavelength of excitation light and exhibits a sufficient luminescence intensity, a color filter having a pixel part obtained by curing the composition, and an image display device having the color filter.

### Solution to Problem

The present inventors conducted a thorough investigation, and as a result, the inventors found that the above-described problems can be solved by using specific semiconductor nanoparticles and a specific coloring matter in combination, thus completing the present invention.

The gist of the present invention is as follows.

[1] A semiconductor nanoparticle-containing composition comprising:

semiconductor nanoparticles (A); and

a coloring matter (B),

wherein the semiconductor nanoparticle-containing composition further comprises a polymerizable compound (C),

the semiconductor nanoparticles (A) have a maximum emission wavelength in a range of 500 to 670 nm over a wavelength range of 300 to 780 nm, and

the coloring matter (B) comprises at least one selected from the group consisting of:

a coloring matter (B1) having a partial structure represented by General Formula [I]:

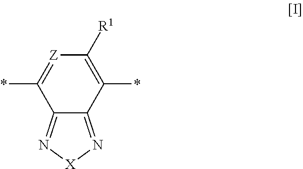

in General Formula [I], X represents an O atom or a S atom,

Z represents CR² or a N atom,

R¹ and R² each independently represent a hydrogen atom or any substituent, and

* represents a linking bond;

a coloring matter (B2) represented by General Formula [II]:

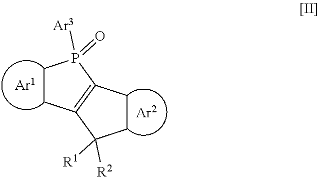

in General Formula [II], Ar¹, Ar², and Ar³ each independently represent an aryl group which may have a substituent, and

R¹ and R² each independently represent an alkyl group which may have a substituent, or an aryl group which may have a substituent;

a coloring matter (B3) represented by General Formula [III] and having a total degree of branching of 3 or more:

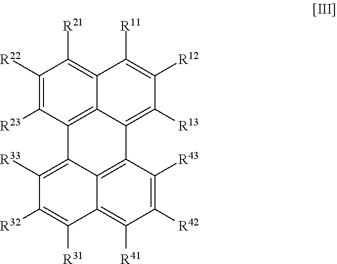

in General Formula [III], R¹¹, R²¹, R³¹, and R⁴¹ each independently represent a hydrogen atom or any substituent, provided that one or more of R¹¹, R²¹, R³¹, and R⁴¹ are each a group represented by General Formula [IIIa]:

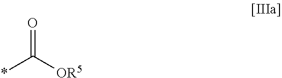

in General Formula [Ina], R⁵ represents a hydrogen atom or any substituent, and

* represents a linking bond;

R¹², R¹³, R²², R²³, R³², R³³, R⁴², and R⁴³ each independently represent a hydrogen atom or any substituent,

a coloring matter (B4) having a coumarin skeleton and having a total degree of branching of 3 or more; and

a coloring matter (B5) represented by General Formula [V]:

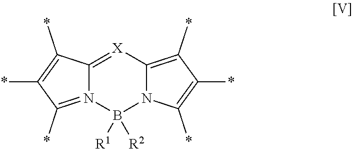

in General Formula [V], X represents C—* or N,

* represents a linking bond, and

R¹ and R² each independently represent a fluorine atom or a cyano group.

[2] A semiconductor nanoparticle-containing composition comprising:

semiconductor nanoparticles (A); and

a coloring matter (B),

the semiconductor nanoparticle-containing composition further comprises light-scattering particles,

the semiconductor nanoparticles (A) have a maximum emission wavelength in a range of 500 to 670 nm over a wavelength range of 300 to 780 nm, and

the coloring matter (B) comprises at least one selected from the group consisting of:

a coloring matter (B1) having a partial structure represented by General Formula [I]:

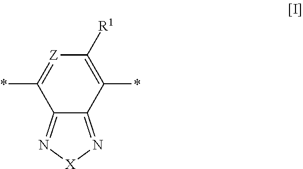

in General Formula [I], X represents an O atom or a S atom,

Z represents CR² or a N atom,

R¹ and R² each independently represent a hydrogen atom or any substituent, and

* represents a linking bond;

a coloring matter (B2) represented by General Formula [II]:

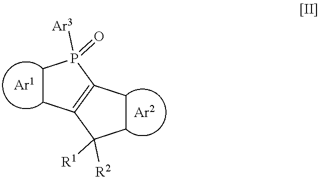

in General Formula [II], Ar¹, Ar², and Ar³ each independently represent an aryl group which may have a substituent, and

R¹ and R² each independently represent an alkyl group which may have a substituent, or an aryl group which may have a substituent;

a coloring matter (B3) represented by General Formula [III] and having a total degree of branching of 3 or more:

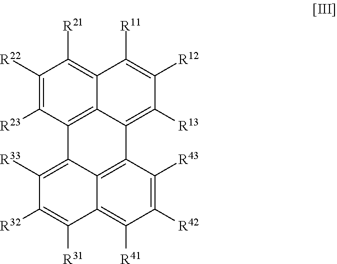

in General Formula [III], R¹¹, R²¹, R³¹, and R⁴⁰ each independently represent a hydrogen atom or any substituent, provided that one or more of R¹¹, R²¹, R³¹, and R⁴¹ are each a group represented by General Formula [IIIa]:

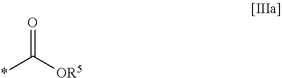

in General Formula [Ina], R⁵ represents a hydrogen atom or any substituent, and

* represents a linking bond;

R¹², R¹³, R²², R²³, R³², R³³, R⁴², and R⁴³ each independently represent a hydrogen atom or any substituent,

a coloring matter (B4) having a coumarin skeleton and having a total degree of branching of 3 or more; and

a coloring matter (B5) represented by General Formula [V]:

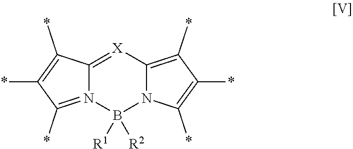

in General Formula [V], X represents C—* or N,

* represents a linking bond, and

R¹ and R² each independently represent a fluorine atom or a cyano group.

[3] A semiconductor nanoparticle-containing composition comprising:

semiconductor nanoparticles (A) whose maximum emission wavelength over a wavelength range of 300 to 780 nm is in a range of 500 to 670 nm; and

a coloring matter (B),

wherein the coloring matter (B) comprises a coloring matter (B1) having a partial structure represented by General Formula [I]:

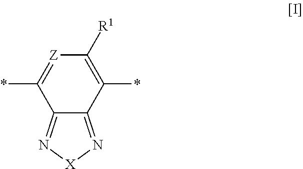

in General Formula [I], X represents an O atom or a S atom,

Z represents CR² or a N atom,

R¹ and R² each independently represent a hydrogen atom or any substituent, and

* represents a linking bond.

[4] A semiconductor nanoparticle-containing composition comprising:

semiconductor nanoparticles (A) whose maximum emission wavelength over a wavelength range of 300 to 780 nm is in a range of 500 to 670 nm; and

a coloring matter (B),

wherein the coloring matter (B) comprises a coloring matter (B2) represented by General Formula [II]:

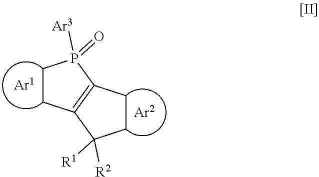

in General Formula [II], Ar¹, Ar², and Ar³ each independently represent an aryl group which may have a substituent, and

R¹ and R² each independently represent an alkyl group which may have a substituent, or an aryl group which may have a substituent.

[5] A semiconductor nanoparticle-containing composition comprising:

semiconductor nanoparticles (A) whose maximum emission wavelength over a wavelength range of 300 to 780 nm is in a range of 500 to 670 nm; and

a coloring matter (B),

wherein the coloring matter (B) comprises a coloring matter (B3) represented by General Formula [III] and having a total degree of branching of 3 or more:

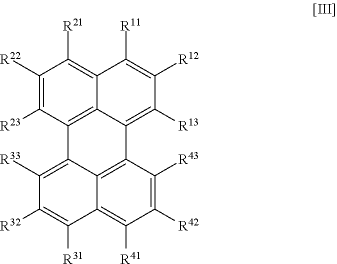

in General Formula [III], R¹¹, R²¹, R³¹, and R⁴¹ each independently represent a hydrogen atom or any substituent, provided that one or more of R¹¹, R²¹, R³¹, and R⁴¹ are each a group represented by General Formula [IIIa]:

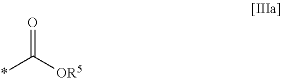

in General Formula [Ina], R⁵ represents a hydrogen atom or any substituent, and

* represents a linking bond;

R¹³, R²², R²³, R³², R³³, R⁴², and R⁴³ each independently represent a hydrogen atom or any substituent.

[6] A semiconductor nanoparticle-containing composition comprising:

semiconductor nanoparticles (A) whose maximum emission wavelength over a wavelength range of 300 to 780 nm is in a range of 500 to 670 nm; and

a coloring matter (B),

wherein the coloring matter (B) comprises a coloring matter (B4) having a coumarin skeleton and having a total degree of branching of 3 or more.

[7] A semiconductor nanoparticle-containing composition comprising:

semiconductor nanoparticles (A) whose maximum emission wavelength over a wavelength range of 300 to 780 nm is in a range of 500 to 670 nm; and

a coloring matter (B),

wherein the coloring matter (B) comprises a coloring matter (B5) represented by General Formula [V]:

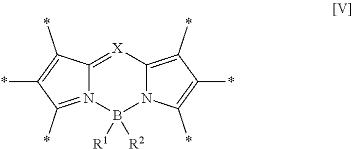

in General Formula [V], X represents C—* or N,

* represents a linking bond, and

R¹ and R² each independently represent a fluorine atom or a cyano group.

[8] The semiconductor nanoparticle-containing composition according to any one of [1] to [3],

wherein the coloring matter (B1) is a coloring matter represented by General Formula [1-1]:

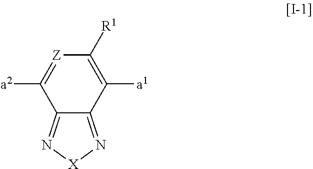

in General Formula [I-1], X represents an O atom or a S atom,

Z represents CR² or a N atom,

R¹ and R² each independently represent a hydrogen atom or any substituent, and

a¹ and a² each independently represent a group represented by General Formula [I-1a]:

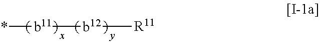

in General Formula [I-1a], b¹¹ represents an arylene group which may have a substituent, a —CH═CH— group which may have a substituent, a —CC— group, a —CH═N— group which may have a substituent, a —N═CH— group which may have a substituent, a —CO— group, or a —N═N— group,

b¹² represents a single bond or a divalent group other than b¹¹,

x represents an integer of 0 to 3, when x is an integer of 2 or more, a plurality of b¹¹'s may be identical or different,

y represents an integer of 1 to 3, when y is an integer of 2 or more, a plurality of b¹²'s may be identical or different,
R¹¹ represents a hydrogen atom or any substituent, and

* represents a linking bond.

[9] The semiconductor nanoparticle-containing composition according to any one of [1], [2], and [4],

wherein Ar² in General Formula [II] is a group represented by any one of General Formula [IIa], General Formula [IIb], and General Formula [IIc]:

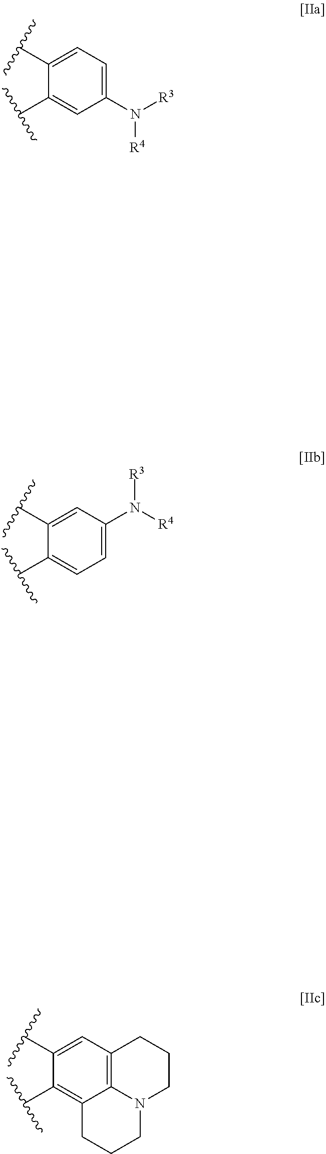

in General Formulae [IIa] and [IIb], R³ and R⁴ each independently represent an alkyl group which may have a substituent, or an aryl group which may have a substituent.

[10] The semiconductor nanoparticle-containing composition according to any one of [1], [2], [4], and [9],

wherein Ar¹ in General Formula [II] is a benzene ring group or a naphthalene ring group.

[11] The semiconductor nanoparticle-containing composition according to any one of [1], [2], [4], [9], and [10],

wherein R¹ and R² in General Formula [II] are each independently an aryl group which may have a substituent.

[12] The semiconductor nanoparticle-containing composition according to any one of [1], [2], and [5],

wherein R⁵ in General Formula [III] is a hydrogen atom or a hydrocarbon group which may have a substituent, provided that some of —CH₂— in the hydrocarbon group may be substituted with —O—.

[13] The semiconductor nanoparticle-containing composition according to any one of [1], [2], [5], and [12],

wherein in General Formula [III], two or more of R¹¹, R²¹, R³¹, and R⁴¹ are each a group represented by General Formula [IIIa]:

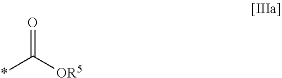

in General Formula [IIIa], R⁵ represents a hydrogen atom or any substituent, and

* represents a linking bond.

[14] The semiconductor nanoparticle-containing composition according to any one of [1], [2], and [6],

wherein the coloring matter (B4) is a coloring matter represented by General Formula [IV-1] and having a total degree of branching of 3 or more:

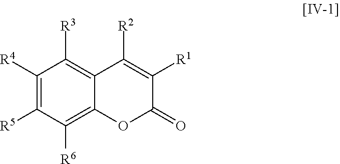

in General Formula [IV-1], R¹, R², R³, R⁴, and R⁶ each independently represent a hydrogen atom or any substituent,

R⁵ represents a hydrogen atom, N(R⁷)₂, or OR⁷, when R⁵ is N(R⁷)₂, R⁷'s may be linked to form a ring,

R⁷ represents a hydrogen atom or any substituent, and

two or more selected from the group consisting of R⁴, R⁵, and R⁶ may be linked to form a ring.

[15] The semiconductor nanoparticle-containing composition according to [14],

wherein R¹ in General Formula [IV-1] is a group represented by General Formula [IV-1a]:

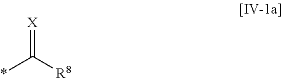

in General Formula [IV-1a], X represents an oxygen atom, a sulfur atom, or NR⁹,

R⁸ represents a hydrogen atom or any substituent,

R⁹ represents a hydrogen atom or an alkyl group,

when X is NR⁹, R⁹ and R⁸ may be linked to form a ring, and

* represents a linking bond.

[16] The semiconductor nanoparticle-containing composition according to any one of [1], [2], and [7],

wherein the coloring matter (B5) is represented by General Formula [V-1]:

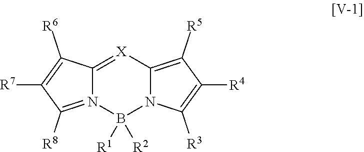

in General Formula [V-1], X represents C—R⁹ or N,

R³ to R⁹ each independently represent a hydrogen atom or any substituent,

R⁴ and R³ or R⁵ may be linked to form a ring,

R⁷ and R⁶ or R⁸ may be linked to form a ring, and

R¹ and R² each independently represent a fluorine atom or a cyano group.

[17] The semiconductor nanoparticle-containing composition according to [16],

wherein in General Formula [V-1], R¹ and R² are each a fluorine atom, X is C—R⁹, and R⁹ is a hydrogen atom or any substituent.

[18] The semiconductor nanoparticle-containing composition according to any one of [2] to [7], further comprising a polymerizable compound (C).

[19] The semiconductor nanoparticle-containing composition according to [1] or [18],

wherein the semiconductor nanoparticle-containing composition includes a (meth)acrylate-based compound as the polymerizable compound (C).

[20] The semiconductor nanoparticle-containing composition according to any one of [1] to [19], further comprising a polymerization initiator (D).

[21] The semiconductor nanoparticle-containing composition according to any one of [1] and [3] to [7], further comprising light-scattering particles.

[22] The semiconductor nanoparticle-containing composition according to any one of [1] to [21],

wherein the semiconductor nanoparticle-containing composition is used for an inkjet method.

[23] A color filter comprising a pixel part prepared by curing the semiconductor nanoparticle-containing composition according to any one of [1] to [22].

[24] An image display device comprising the color filter according to [23].

### Advantageous Effects of Invention

According to the present invention, a semiconductor nanoparticle-containing composition capable of forming a wavelength conversion layer that efficiently converts the wavelength of excitation light and exhibits a sufficient luminescence intensity, a color filter having a pixel part obtained by curing the composition, and an image display device having the color filter, can be provided.

### BRIEF DESCRIPTION OF DRAWINGS

FIG. 1 is a schematic cross-sectional view of a color filter of the present invention.

### DESCRIPTION OF EMBODIMENTS

Hereinafter, the present invention will be described in detail. The following description is an example of embodiments of the present invention, and the present invention is not intended to be specified by these as long as the gist of the invention is maintained.

According to the present invention, the term “(meth)acryl” means “acryl and/or methacryl”.

According to the present invention, the term “total solid content” means all components other than a solvent in the semiconductor nanoparticle-containing composition, and when the semiconductor nanoparticle-containing composition does not include a solvent, the total solid content means all the components of the semiconductor nanoparticle-containing composition. Even when the components other than a solvent are liquid at normal temperature, those components are not included in the solvent and are included in the total solid content.

According to the present invention, a numerical value range expressed by using the term “to” means a range including the numerical values described before and after the term “to” as the lower limit value and the upper limit value. The expression “A and/or B” means either or both of A and B and specifically means A, B, or A and B.

According to the present invention, the weight average molecular weight means the weight average molecular weight (Mw) obtained by gel permeation chromatography (GPC) and calculated relative to polystyrene standards.

The semiconductor nanoparticle-containing composition of the present invention can be widely used for a use application for producing a wavelength conversion layer, and this wavelength conversion layer is suitable for use in a display use application. When the wavelength conversion layer is a wavelength conversion sheet, the wavelength conversion layer may be included in a film, may be applied on a film surface by a known method, or may be present between a film and another film.

The semiconductor nanoparticle-containing composition of the present invention can be applied as an ink to be used in a known and conventional method for producing a color filter; however, from the viewpoint that a necessary amount of materials such as relatively expensive semiconductor nanoparticles can be used at necessary parts, without wasting the materials, to form a pixel part (wavelength conversion layer), it is preferable to prepare and use the semiconductor nanoparticle-containing composition so as to be suitable for an inkjet method. That is, the semiconductor nanoparticle-containing composition of the present invention can be suitably used for use applications of forming a pixel part by an inkjet method.

[1] Semiconductor Nanoparticle-Containing Composition

A semiconductor nanoparticle-containing composition of a first aspect of the present invention contains semiconductor nanoparticles (A) and a coloring matter (B) and further contains a polymerizable compound (C), the semiconductor nanoparticles (A) have a maximum emission wavelength in the range of about 500 to 670 nm over a wavelength range of 300 to 780 nm, and the semiconductor nanoparticle-containing composition contains at least one selected from coloring matters (B1) to (B5) that will be described later, as the coloring matter (B).

The semiconductor nanoparticle-containing composition of the present aspect may further contain a polymerization initiator (D), light-scattering particles, and other components, as necessary.

A semiconductor nanoparticle-containing composition of a second aspect of the present invention contains semiconductor nanoparticles (A) and a coloring matter (B) and further contains light-scattering particles, the semiconductor nanoparticles (A) have a maximum emission wavelength in the range of 500 to 670 nm over the wavelength range of 300 to 780 nm, and the semiconductor nanoparticle-containing composition contains at least one selected from coloring matters (B1) to (B5) that will be described later, as the coloring matter (B).

The semiconductor nanoparticle-containing composition of the present aspect may further contain a polymerizable compound (C), a polymerization initiator (D), and other components, as necessary.

A semiconductor nanoparticle-containing composition of a third aspect of the present invention contains semiconductor nanoparticles (A) and a coloring matter (B), the semiconductor nanoparticles (A) have a maximum emission wavelength in the range of 500 to 670 nm over the wavelength range of 300 to 780 nm, and the semiconductor nanoparticle-containing composition contains at least a coloring matter (B1) that will be described later, as the coloring matter (B).

The semiconductor nanoparticle-containing composition of the present aspect may further contain a polymerizable compound (C), a polymerization initiator (D), light-scattering particles, and other components, as necessary.

A semiconductor nanoparticle-containing composition of a fourth aspect of the present invention contains semiconductor nanoparticles (A) and a coloring matter (B), the semiconductor nanoparticles (A) have a maximum emission wavelength in the range of 500 to 670 nm over the wavelength range of 300 to 780 nm, and the semiconductor nanoparticle-containing composition contains at least a coloring matter (B2) that will be described later, as the coloring matter (B).

The semiconductor nanoparticle-containing composition of the present aspect may further contain a polymerizable compound (C), a polymerization initiator (D), light-scattering particles, and other components, as necessary.

A semiconductor nanoparticle-containing composition of a fifth aspect of the present invention contains semiconductor nanoparticles (A) and a coloring matter (B), the semiconductor nanoparticles (A) have a maximum emission wavelength in the range of 500 to 670 nm over the wavelength range of 300 to 780 nm, and the semiconductor nanoparticle-containing composition contains at least a coloring matter (B3) that will be described later, as the coloring matter (B).

The semiconductor nanoparticle-containing composition of the present aspect may further contain a polymerizable compound (C), a polymerization initiator (D), light-scattering particles, and other components, as necessary.

A semiconductor nanoparticle-containing composition of a sixth aspect of the present invention contains semiconductor nanoparticles (A) and a coloring matter (B), the semiconductor nanoparticles (A) have a maximum emission wavelength in the range of 500 to 670 nm over the wavelength range of 300 to 780 nm, and the semiconductor nanoparticle-containing composition contains at least a coloring matter (B4) that will be described later, as the coloring matter (B).

The semiconductor nanoparticle-containing composition of the present aspect may further contain a polymerizable compound (C), a polymerization initiator (D), light-scattering particles, and other components, as necessary.

A semiconductor nanoparticle-containing composition of a seventh aspect of the present invention contains semiconductor nanoparticles (A) and a coloring matter (B), the semiconductor nanoparticles (A) have a maximum emission wavelength in the range of 500 to 670 nm over the wavelength range of 300 to 780 nm, and the semiconductor nanoparticle-containing composition contains at least a coloring matter (B5) that will be described later, as the coloring matter (B).

The semiconductor nanoparticle-containing composition of the present aspect may further contain a polymerizable compound (C), a polymerization initiator (D), light-scattering particles, and other components, as necessary.

[1-1] Semiconductor Nanoparticles (A)

The semiconductor nanoparticle-containing composition of the present invention contains semiconductor nanoparticles (A) whose maximum emission wavelength over the wavelength range of 300 to 780 nm (hereinafter, unless specified otherwise, the “maximum emission wavelength” means a maximum emission wavelength in the range of 300 to 780 nm) is in the range of 500 to 670 nm (hereinafter, may be referred to as “semiconductor nanoparticles (A)”).

The semiconductor nanoparticles are nano-sized particles that absorb excitation light and emit fluorescence or phosphorescence, and the semiconductor nanoparticles are, for example, particles having a maximum particle size of 100 nm or less as measured by a transmission electron microscope or a scanning electron microscope.

The semiconductor nanoparticles can absorb, for example, light having a predetermined wavelength and thereby emit light (fluorescence or phosphorescence) having a wavelength different from the absorbed wavelength.

The maximum emission wavelength of the semiconductor nanoparticles (A) exists in the range of 500 to 670 nm; however, the semiconductor nanoparticles (A) may be red light-emitting semiconductor nanoparticles (red semiconductor nanoparticles) that emit red light, or may be green light-emitting semiconductor nanoparticles (green semiconductor nanoparticles) that emit green light. It is preferable that the semiconductor nanoparticles (A) are red semiconductor nanoparticles and/or green semiconductor nanoparticles.

The light absorbed by the semiconductor nanoparticles is not particularly limited; however, the light may be, for example, light having a wavelength in the range of 400 to 500 nm (blue light) and/or light having a wavelength in the range of 200 to 400 nm (ultraviolet light).

Generally, semiconductor nanoparticles have a wide absorption in a region of shorter wavelengths than the maximum emission wavelength. For example, when the maximum emission wavelength is 530 nm, the semiconductor nanoparticles have a wide absorption band in the wavelength region of 300 to 530 nm with the bottom being near 530 nm, and when the maximum emission wavelength is 630 nm, the semiconductor nanoparticles have a wide absorption band in the wavelength region of 300 to 630 nm with the bottom being near 630 nm.

The maximum emission wavelength of the semiconductor nanoparticles (A) can be checked, for example, in a fluorescence spectrum or a phosphorescence spectrum measured by using a spectrofluorophotometer, and it is preferable to perform measurement under the conditions of an excitation wavelength of 450 nm and an absorptance of 20% to 50%.

When red semiconductor nanoparticles are included as the semiconductor nanoparticles (A), the maximum emission wavelength thereof is preferably 605 nm or more, more preferably 610 nm or more, even more preferably 615 nm or more, still more preferably 620 nm or more, and particularly preferably 625 nm or more, and the maximum emission wavelength thereof is preferably 665 nm or less, more preferably 655 nm or less, even more preferably 645 nm or less, still more preferably 640 nm or less, particularly preferably 635 nm or less, and most preferably 630 nm or less. When the maximum emission wavelength is set to the above-described lower limit value or more, the red color gamut is expanded, and there is a tendency that richer colors can be expressed as a display. Furthermore, when the maximum emission wavelength is set to the above-described upper limit value or less, there is a tendency that a brighter red color can be expressed in view of the relationship of luminosity factor. The above-described upper limits and lower limits can be arbitrarily combined. For example, the maximum emission wavelength is preferably 605 to 665 nm, more preferably 605 to 655 nm, even more preferably 610 to 645 nm, still more preferably 615 to 640 nm, particularly preferably 620 to 635 nm, and most preferably 625 to 630 nm.

When green semiconductor nanoparticles are included as the semiconductor nanoparticles (A), the maximum emission wavelength thereof is preferably 500 nm or more, more preferably 505 nm or more, even more preferably 510 nm or more, still more preferably 515 nm or more, particularly preferably 520 nm or more, and most preferably 525 nm or more, and the maximum emission wavelength thereof is preferably 560 nm or less, more preferably 550 nm or less, even more preferably 545 nm or less, still more preferably 540 nm or less, particularly preferably 535 nm or less, and most preferably 530 nm or less. When the maximum emission wavelength is set to the above-described lower limit value or more, the green color gamut can be expanded, and there is a tendency that a brighter green color can be expressed in view of the relationship of luminosity factor. Furthermore, when the maximum emission wavelength is set to the above-described upper limit value or less, the green color gamut is expanded, and there is a tendency that richer colors can be expressed as a display. The above-described upper limits and lower limits can be arbitrarily combined. For example, the maximum emission wavelength is preferably 500 to 560 nm, more preferably 505 to 550 nm, even more preferably 510 to 545 nm, still more preferably 515 to 540 nm, particularly preferably 500 to 520 nm, and most preferably 525 to 530 nm.

According to the solution of the Schrodinger wave equation of the well-type potential model, the maximum emission wavelength (emission color) of the light emitted by a semiconductor nanoparticles is dependent on the size (for example, particle size) of the semiconductor nanoparticles but is also dependent on the energy gap of the semiconductor nanoparticles. For that reason, the emission color can be selected by changing the constituent material and the size of the semiconductor nanoparticles used.

The semiconductor nanoparticles (A) can have various shapes such as a sphere, a cube, a rod, a wire, a disk, and a multipod, all of them having a dimension in one dimension of 30 nm or less. For example, a CdSe nanorod having a length of 20 nm and a diameter of 4 nm may be mentioned. Furthermore, the semiconductor nanoparticles can also be used in combination with particles having a different shape. For example, a combination of spherical semiconductor nanoparticles and rod-shaped semiconductor nanoparticles can be used. Among these, spherical semiconductor nanoparticles are preferred from the viewpoint that the emission spectrum can be easily controlled, and the production cost can be reduced and the mass productivity can be enhanced while reliability can be secured.

The semiconductor nanoparticles (A) may be composed only of a core including a first semiconductor material or may have a core including a first semiconductor material and a shell that covers at least a portion of the core and includes a second semiconductor material different from the first semiconductor material. That is, the structure of the semiconductor nanoparticles (A) may be a structure composed only of a core (core structure) or may be a structure composed of a core part and a shell part (core-shell structure).

The semiconductor nanoparticles (A) may further have a shell (second shell) that covers at least a portion of the core or the first shell and includes a third semiconductor material different from the first and second semiconductor materials, in addition to the shell (first shell) containing the second semiconductor material. That is, the structure of the semiconductor nanoparticles (A) may be a structure composed of a core part, a first shell part, and a second shell part (core-shell-shell structure). Each of the core and shells may be a mixed crystal including two or more kinds of semiconductor materials (for example, CdSe+CdS, CuInSe+ZnS, and InP+ZnSeS+ZnS).

The type of the semiconductor material constituting the semiconductor nanoparticles (A) is not particularly limited; however, from the viewpoint that the quantum efficiency is high and production is relatively easy, it is preferable that the semiconductor material includes at least one selected from the group consisting of Group II-VI semiconductors, Group III-V semiconductors, Group I-III-VI semiconductors, Group IV semiconductors, and Group I-II-IV-VI semiconductors.

Specific examples of the semiconductor material include CdS, CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, CdHgZnTe, CdZnSeS, CdZnSeTe, CdZnSTe, CdHgSeS, CdHgSeTe, CdHgSTe, HgZnSeS, HgZnSeTe, HgZnSTe;

GaN, GaP, GaAs, GaSb, AlN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb;

SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe, SnPbSTe;

Si, Ge, SiC, SiGe, AgInSe₂, AglnGaS₂, CuGaSe₂, CulnS₂, CuGaS₂, CuInSe₂, AgInS₂, AgGaSe₂, AgGaS₂, C, and Cu₂ZnSnS₄.

Among these, from the viewpoint that the emission spectrum can be easily controlled, and the production cost can be reduced and the mass productivity can be enhanced while heat resistance and light resistance can be secured, it is preferable that at least one selected from the group consisting of CdS, CdSe, CdTe, ZnS, ZnSe, ZnTe, ZnO, HgS, HgSe, HgTe, InP, InAs, InSb, GaP, GaAs, GaSb, AglnS₂, AgInSe₂, AgInGaS₂, AgInTe₂, AgGaS₂, AgGaSe₂, AgGaTe₂, CuInS₂, CuInSe₂, CuInTe₂, CuGaS₂, CuGaSe₂, CuGaTe₂, Si, C, Ge, and Cu₂ZnSnS₄ is included.

Examples of the red semiconductor nanoparticles include nanoparticles of CdSe; nanoparticles having a core-shell structure in which the shell part is CdS and the core part is CdSe; nanoparticles having a core-shell structure in which the shell part is CdS and the core part is ZnSe; nanoparticles of a mixed crystal of CdSe and ZnS; nanoparticles of InP; nanoparticles having a core-shell structure in which the shell part is ZnS and the core part is InP; nanoparticles having a core-shell structure in which the shell part is a mixed crystal of ZnS and ZnSe and the core part is InP; nanoparticles of a mixed crystal of CdSe and CdS; nanoparticles of a mixed crystal of ZnSe and CdS; nanoparticles having a core-shell-shell structure in which the first shell part is ZnSe, the second shell part is ZnS, and the core part is InP; and nanoparticles having a core-shell-shell structure in which the first shell part is a mixed crystal of ZnS and ZnSe, the second shell part is ZnS, and the core part is InP.

Examples of the green semiconductor nanoparticles include nanoparticles of CdSe; nanoparticles of a mixed crystal of CdSe and ZnS; nanoparticles having a core-shell structure in which the shell part is ZnS and the core part is InP; nanoparticles having a core-shell structure in which the shell part is a mixed crystal of ZnS and ZnSe and the core part is InP; nanoparticles having a core-shell-shell structure in which the first shell part is ZnSe, the second shell part is ZnS, and the core part is InP; and nanoparticles having a core-shell-shell structure in which the first shell part is a mixed crystal of ZnS and ZnSe, the second shell part is ZnS, and the core part is InP.

With regard to the semiconductor nanoparticles, the color to be emitted can be changed to red color or to green color by changing the average particle size of the semiconductor nanoparticles themselves while maintaining the same chemical composition.

With regard to the semiconductor nanoparticles, it is preferable to use semiconductor nanoparticles themselves having as little adverse effect as possible on human body and the like. For example, when semiconductor nanoparticles containing cadmium and/or selenium are used as the semiconductor nanoparticles (A), it is preferable that semiconductor nanoparticles that include the above-described element (cadmium and/or selenium) as little as possible are selected and used alone, or the semiconductor nanoparticles are used in combination with other semiconductor nanoparticles such that the above-described element is included as little as possible.

The shape of the semiconductor nanoparticles (A) is not particularly limited, and the shape may be any geometric shape or may be any irregular shape. The shape of the semiconductor nanoparticles may be, for example, a spherical shape, an ellipsoidal shape, a pyramidal shape, a disc shape, a branched shape, a net shape, or a rod shape. However, regarding the semiconductor nanoparticles, it is preferable to use particles having a less directional particle shape (for example, particles having a spherical shape, a regular tetrahedral shape, or the like) from the viewpoint of further increasing the uniformity and fluidity of the semiconductor nanoparticle-containing composition.

The average particle size (volume mean diameter) of the semiconductor nanoparticles (A) may be 1 nm or more, may be 1.5 nm or more, and may be 2 nm or more, from the viewpoint that luminescence of a desired wavelength is likely to be obtained, and from the viewpoint that dispersibility and storage stability are excellent. From the viewpoint that a desired emission wavelength is likely to be obtained, the average particle size may be 40 nm or less, may be 30 nm or less, or may be 20 nm or less. The above-described upper limits and lower limits can be arbitrarily combined. For example, the average particle size may be 1 to 40 nm, may be 1.5 to 30 nm, or may be 2 to 20 nm.

The average particle size (volume mean diameter) of the semiconductor nanoparticles is obtained by making measurement with a transmission electron microscope or a scanning electron microscope and calculating the volume mean diameter.

From the viewpoint of dispersion stability, it is preferable that the semiconductor nanoparticles (A) have an organic ligand on the surface thereof. The organic ligand may be, for example, coordinate-bonded to the surface of the semiconductor nanoparticles (A). In other words, the surface of the semiconductor nanoparticles (A) may be passivated by an organic ligand. Furthermore, when the semiconductor nanoparticle-containing composition further contains a polymer dispersant that will be described later, the semiconductor nanoparticles (A) may have a polymer dispersant on the surface thereof. For example, a polymer dispersant may be bonded to the surface of the semiconductor nanoparticles by removing the organic ligand from the above-mentioned semiconductor nanoparticles (A) having the organic ligand and exchanging the organic ligand with the polymer dispersant. However, from the viewpoint of dispersion stability when produced into an ink for an inkjet method, it is preferable that a polymer dispersant is blended with the semiconductor nanoparticles in a state in which the organic ligand is still coordinated.

It is preferable that the organic ligand is a compound having a functional group for securing an affinity with a polymerizable compound and a solvent (hereinafter, also simply referred to as “affinity group”) and a functional group for securing adsorptivity to semiconductor nanoparticles (hereinafter, also simply referred to as “adsorptive group”).

As the affinity group, an aliphatic hydrocarbon group is preferred. The aliphatic hydrocarbon group may be a linear type or may have a branched structure. Furthermore, the aliphatic hydrocarbon group may have an unsaturated bond or does not have to have an unsaturated bond.

Examples of the adsorptive group include a hydrogen group, an amino group, a carboxyl group, a sulfanyl group, a phosphonooxy group, a phosphono group, a phosphanetriyl group, a phosphoryl group, and an alkoxysilyl.

Examples of the organic ligand include trioctylphosphine (TOP), trioctylphosphine oxide (TOPO), oleic acid, oleylamine, octylamine, trioctylamine, hexadecylamine, octanethiol, dodecanethiol, hexylphosphonic acid (HPA), tetradecylphosphonic acid (TDPA), and octylphosphinic acid (OPA).

Regarding the semiconductor nanoparticles (A), semiconductor nanoparticles dispersed in a colloidal form in a solvent, a polymerizable compound, or the like can be used. It is preferable that the surface of the semiconductor nanoparticles in a state of being dispersed in a solvent is passivated by the above-mentioned organic ligand.

Examples of the solvent include cyclohexane, hexane, heptane, chloroform, toluene, octane, chlorobenzene, tetralin, diphenyl ether, propylene glycol monomethyl ether acetate, butyl carbitol acetate, and mixtures thereof.

A method for producing the semiconductor nanoparticles (A) is not particularly limited; however, the semiconductor nanoparticles (A) can be produced by, for example, the methods described in Published Japanese Translation No. 2015-529698 of the PCT International Publication and Japanese Unexamined Patent Application, First Publication No. 2018-109141.

A commercially available product can also be used as the semiconductor nanoparticles (A). Examples of the commercially available product of semiconductor nanoparticles include indium phosphide-zinc sulfide, D-dots, and CuInS—ZnS from NN-Labs, LLC, and InP—ZnS from Sigma-Aldrich Corporation.

From the viewpoint of having an excellent effect of enhancing the external quantum efficiency, the content proportion of the semiconductor nanoparticles (A) is preferably 1% by mass or more, more preferably 5% by mass or more, even more preferably 10% by mass or more, still more preferably 20% by mass or more, and particularly preferably 30% by mass or more, and from the viewpoint of coatability, particularly from the viewpoint of having more excellent ejection stability from the inkjet head, the content proportion is preferably 60% by mass or less, more preferably 50% by mass or less, and even more preferably 40% by mass or less, all in the total solid content of the semiconductor nanoparticle-containing composition. The above-described upper limits and lower limits can be arbitrarily combined. For example, the content proportion is preferably 1% to 60% by mass, more preferably 5% to 60% by mass, even more preferably 10% to 50% by mass, still more preferably 20% to 50% by mass, and particularly preferably 30% to 40% by mass, in the total solid content of the semiconductor nanoparticle-containing composition.

The semiconductor nanoparticle-containing composition may include two or more kinds of semiconductor nanoparticles as the semiconductor nanoparticles (A). Furthermore, the semiconductor nanoparticle-containing composition may include both red semiconductor nanoparticles and green semiconductor nanoparticles; however, it is preferable that only one of the red semiconductor nanoparticles and the green semiconductor nanoparticles is included.

When the red semiconductor nanoparticles are included as the semiconductor nanoparticles (A), the content proportion of the green semiconductor nanoparticles is preferably 10% by mass or less, and more preferably 0% by mass, in the semiconductor nanoparticles. When the green semiconductor nanoparticles are included as the semiconductor nanoparticles (A), the content proportion of the red semiconductor nanoparticles is preferably 10% by mass or less, and more preferably 0% by mass, in the semiconductor nanoparticles.

[1-2] Coloring Matter (B)

The semiconductor nanoparticle-containing composition of the present invention contains a coloring matter (B) including at least one selected from coloring matters (B1) to (B5).

When a coloring matter is used in combination for the purpose of enhancing the luminous efficiency of the semiconductor nanoparticles (A), since semiconductor nanoparticles have a wide absorption band on the shorter wavelength side than the maximum emission wavelength, it is preferable that the coloring matter to be used in combination is a coloring matter having an emission peak on the longer wavelength side than the wavelength of the excitation light and in a region of short wavelengths as far as possible. For example, when the wavelength of the excitation light is 450 nm, it is considered that when the emission peak of the coloring matter exists in the vicinity of 460 to 630 nm, the luminescence intensity of green semiconductor nanoparticles and red semiconductor nanoparticles can be increased.

It is considered that when the semiconductor nanoparticle-containing composition of the present invention contains semiconductor nanoparticles (A) whose maximum emission wavelength over the wavelength range of 300 to 780 nm is in the range of 500 to 670 nm and a coloring matter (B) including at least one selected from coloring matters (B1) to (B5), the semiconductor nanoparticle-containing composition exhibits a sufficient luminescence intensity when a wavelength conversion layer is formed. This is thought to be because the overlap between the emission spectrum derived from the chemical structure of at least one selected from the coloring matters (B1) to (B5) and the absorption spectrum of the semiconductor nanoparticles (A) having a maximum emission wavelength in the range of 500 to 670 nm is large, the excited energy of at least one selected from the coloring matters (B1) to (B5) moves to semiconductor nanoparticles (A) by Forster-type energy transfer, and the luminescence intensity of the semiconductor nanoparticles (A) is increased.

The content proportion of the coloring matter (B) in the semiconductor nanoparticle-containing composition of the present invention is not particularly limited; however, the content proportion is preferably 0.001% by mass or more, more preferably 0.005% by mass or more, even more preferably 0.01% by mass or more, still more preferably 0.05% by mass or more, even more preferably 0.1% by mass or more, particularly preferably 0.5% by mass or more, and most preferably 1% by mass or more, and the content proportion is preferably 30% by mass or less, more preferably 20% by mass or less, even more preferably 10% by mass or less, and particularly preferably 5% by mass or less, all in the total solid content of the semiconductor nanoparticle-containing composition.

When the content proportion is set to the above-described lower limit value or more, there is a tendency that the coloring matter (B) sufficiently absorbs the emitted light, the amount of energy transfer from the coloring matter (B) to the semiconductor nanoparticles (A) is increased, and the luminescence intensity of the semiconductor nanoparticles (A) is increased. Furthermore, when the content proportion is set to the above-described upper limit value or less, there is a tendency that the concentration quenching of the coloring matter (B) is suppressed, the luminescence intensity of the semiconductor nanoparticles (A) is increased as energy is efficiently transferred from the coloring matter (B) to the semiconductor nanoparticles (A), and a wavelength conversion layer having sufficient hardness is obtained by including components other than the semiconductor nanoparticles (A) and the coloring matter (B).

The above-described upper limits and lower limits can be arbitrarily combined. For example, the content proportion is preferably 0.001% to 30% by mass, more preferably 0.005% to 30% by mass, even more preferably 0.01% to 20% by mass, still more preferably 0.05% to 20% by mass, even more preferably 0.1% to 10% by mass, particularly preferably 0.5% to 10% by mass, and most preferably 1% to 5% by mass.

[1-2-1] Coloring Matter (B1)

The coloring matter (B1) is a coloring matter represented by General Formula

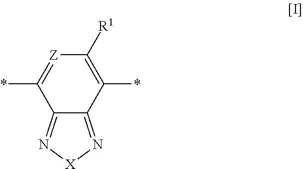

in General Formula [I], X represents an O atom or a S atom,

Z represents CR² or a N atom,

R¹ and R² each independently represent a hydrogen atom or any substituent, and

* represents a linking bond.

It is considered that the coloring matter (B1) and the semiconductor nanoparticles (A) attract each other due to the interaction caused by the lone electron pair on the N atom of the diazole part of the coloring matter (B1), and as the coloring matter (B1) sufficiently approaches the semiconductor nanoparticles (A), the luminescence intensity of the semiconductor nanoparticles is further increased because the efficiency of the excited energy of the coloring matter (B1) transferring to the semiconductor nanoparticles (A) by the Forster-type energy transfer is enhanced.

(X)

In Formula [1], X represents an O atom or a S atom.

Among these, an O atom is preferred from the viewpoint of increasing the luminescence intensity, while on the other hand, a S atom is preferred from the viewpoint of light resistance.

(Z)

In Formula [1], Z represents CR² or a N atom.

Among these, CR² is preferred from the viewpoint of the ease of synthesis.

(R¹ and R²)

R¹ and R² each independently represent a hydrogen atom or any substituent.

The any substituent is not particularly limited as long as it is a substitutable monovalent group, and examples include an alkyl group which may have a substituent, an alkoxy group which may have a substituent, an alkoxycarbonyl group which may have a substituent, an aryl group which may have a substituent, an aryloxy group which may have a substituent, a sulfanyl group, a dialkylphosphino group which may have a substituent, an alkylsulfanyl group which may have a substituent, a hydroxyl group, a carboxyl group, an amino group, a nitro group, a cyano group, and a halogen atom. When Z is CR², R¹ and R² may be linked to form a ring.

Examples of the alkyl group include a linear alkyl group, a branched alkyl group, a cyclic alkyl group, and a combination of these. From the viewpoint of solubility in the composition, a branched alkyl group is preferred.

With regard to the carbon-carbon bonds included in the alkyl group, a portion thereof may be unsaturated bonds. One or more methylene groups (—CH₂—) included in the alkyl group may be substituted by an etheric oxygen atom (—O—), a thioetheric sulfur atom (—S—), an aminic nitrogen atom (—NH— or —N(R^{A})—: here, R^{A} represents a linear or branched alkyl group having 1 to 6 carbon atoms), a carbonyl group (—CO—), an ester bond (—COO—), or an amide bond (—CONH—).

The number of carbon atoms of the alkyl group is not particularly limited; however, the number of carbon atoms is usually 1 or more, preferably 4 or more, and more preferably 8 or more, and is preferably 16 or less, and more preferably 12 or less.

When the number of carbon atoms is set to the above-described lower limit value or more, solubility tends to be enhanced, and when the number of carbon atoms is set to the above-described upper limit value or less, the absorbance of the excitation light tends to increase. The above-described upper limits and lower limits can be arbitrarily combined. For example, the number of carbon atoms is preferably 1 to 16, more preferably 4 to 16, and even more preferably 8 to 12. When one or more of the methylene groups (—CH₂—) in the alkyl group have been substituted by the above-described groups, it is preferable that the number of carbon atoms of the alkyl group before the substitution is included in the above-described range.

Examples of the alkyl group include a methyl group, an ethyl group, an isopropyl group, an isobutyl group, a tert-butyl group, a 2-ethylhexyl group, and a (2-hydroxyethoxy)ethyl group. From the viewpoint of solubility, an isobutyl group and a 2-ethylhexyl group are preferred, and a 2-ethylhexyl group is more preferred.

Examples of the substituent that the alkyl group may have include a hydroxyl group, a carboxyl group, an amino group, a sulfanyl group, a dialkylphosphino group having 2 to 12 carbon atoms, and a halogen atom. From the viewpoint of the efficiency of energy transfer to the semiconductor nanoparticles, an amino group and a sulfanyl group are preferred.

Regarding the alkoxy group, a group in which an O atom is further bonded to the linking bond of the above-described alkyl group may be mentioned. From the viewpoint of solubility, it is preferable that one or more methylene groups (—CH₂—) included in the alkyl group are substituted with etheric oxygen atoms (—O—).

Examples of the alkoxy group include a methoxy group, an ethoxy group, a (2-hydroxyethoxy)ethoxy group, and a 2-[2-(2-hydroxyethoxy)ethoxy]ethoxy group, and a group having a polyether structure, such as a (2-hydroxyethoxy)ethoxy group or a 2-[2-(2-hydroxyethoxy)ethoxy]ethoxy group, is preferred from the viewpoint of enhancing the solubility.

Regarding the alkoxycarbonyl group, a group in which a carbonyl group is bonded to the linking bond of the alkoxy group may be mentioned.

Examples of the alkoxycarbonyl group include a methoxycarbonyl group and an ethoxycarbonyl group.

Regarding the aryl group, a monovalent aromatic hydrocarbon ring group and a monovalent aromatic heterocyclic group may be mentioned.

The number of carbon atoms of the aryl group is not particularly limited; however, the number of carbon atoms is preferably 4 or more, and more preferably 6 or more, and is preferably 12 or less, and more preferably 10 or less. When the number of carbon atoms is set to the above-described lower limit value or more, the efficiency of energy transfer to the semiconductor nanoparticles tends to be enhanced, and when the number of carbon atoms is set to the above-described upper limit value or less, the absorbance of the excitation light tends to increase. The above-described upper limits and lower limits can be arbitrarily combined. For example, the number of carbon atoms is preferably 4 to 12, more preferably 4 to 10, and even more preferably 6 to 10.

When R¹ and/or R² are each independently an aryl group which may have a substituent, it is preferable because there is a tendency that bonded aryl groups are distorted from the diazole plane due to steric hindrance, consequently stacking of the coloring matter (B1) molecules is inhibited, and concentration quenching is less likely to occur.

The aromatic hydrocarbon ring in the aromatic hydrocarbon ring group may be a monocyclic ring or a fused ring.

Examples of the aromatic hydrocarbon ring group include a benzene ring, a naphthalene ring, an anthracene ring, a phenanthrene ring, a perylene ring, a tetracene ring, a pyrene ring, a benzopyrene ring, a chrysene ring, a triphenylene ring, an acenaphthene ring, a fluoranthene ring, and a fluorene ring, each of which has one free valence. From the viewpoints of the solubility in the composition and the absorption wavelength, a benzene ring having one free valence and a naphthalene ring having one free valence are preferred, and a benzene ring having one free valence is more preferred.

The aromatic heterocyclic ring in the aromatic heterocyclic group may be a monocyclic ring or a fused ring.

Examples of the aromatic heterocyclic group include a furan ring, a benzofuran ring, a thiophene ring, a benzothiophene ring, a pyrrole ring, a pyrazole ring, an imidazole ring, an oxadiazole ring, an indole ring, a carbazole ring, a pyrroloimidazole ring, a pyrrolopyrazole ring, a pyrrolopyrrole ring, a thienopyrrole ring, a thienothiophene ring, a furopyrrole ring, a furofuran ring, a thienofuran ring, a benzisoxazole ring, a benzisothiazole ring, a benzimidazole ring, a pyridine ring, a pyrazine ring, a pyridazine ring, a pyrimidine ring, a triazine ring, a quinoline ring, an isoquinoline ring, a cinnoline ring, a quinoxaline ring, a phenanthridine ring, a perimidine ring, a quinazoline ring, a quinazolinone ring, and an azulene ring, each of which has one free valence. From the viewpoint of the efficiency of energy transfer to the semiconductor nanoparticles, a thiophene ring having one free valence and a pyridine ring having one free valence are preferred.

Examples of the substituent that the aryl group may have include an alkyl group having 1 to 6 carbon atoms, an alkoxy group having 1 to 6 carbon atoms, an alkoxycarbonyl group having 2 to 7 carbon atoms, a hydroxyl group, a carboxyl group, an amino group, a sulfanyl group, a dialkylphosphino group having 2 to 12 carbon atoms, and a halogen atom. From the viewpoint of the efficiency of energy transfer to the semiconductor nanoparticles, an amino group and a sulfanyl group are preferred.

Regarding the aryloxy group, a group in which an O atom is further bonded to the linking bond of the aryl group may be mentioned. Specific examples include a phenoxy group and a 2-thienyloxy group.

Regarding the dialkylphosphino group, a group in which two linking bonds of the alkyl groups are each independently bonded to a phosphorus atom may be mentioned. Specific examples include a dibutylphosphino group and a butylethylphosphino group.

Regarding the alkylsulfanyl group, a group in which a sulfur atom is further bonded to the linking bond of the alkyl group may be mentioned. Specific examples include a methylsulfanyl group, an ethylsulfanyl group, a butylsulfanyl group, and a 2-ethylhexylsulfanyl group.

Examples of the halogen atom include a fluorine atom, a chlorine atom, a bromine atom, and an iodine atom. From the viewpoint of molecular durability, a fluorine atom and a chlorine atom are preferred.

Among these, from the viewpoints of the absorption wavelength and the solubility in the composition, R¹ and R² are each independently preferably a hydrogen atom, a 2-ethylhexyl group, a phenyl group, or a 2-[2-(2-hydroxyethoxy)ethoxy]ethoxy group, and more preferably a hydrogen atom.

When Z is CR², R¹ and R² may be linked to form a ring, and specific examples of the case where a ring is formed are, for example, as follows:

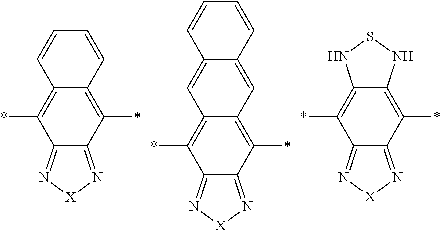

Among the above-described coloring matters (B1), from the viewpoint of increasing the luminescence intensity, a coloring matter represented by General Formula [1-1] is preferred:

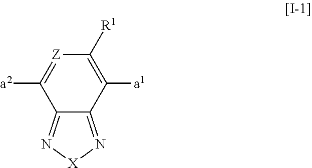

in General Formula [1-1], X represents an O atom or a S atom,

Z represents CR² or a N atom,

R¹ and R² each independently represent a hydrogen atom or any substituent, and

a¹ and a² each independently represent a group represented by General Formula [I-1a]:

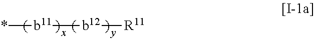

in General Formula [I-1a], b¹¹ represents an arylene group which may have a substituent, a —CH═CH— group which may have a substituent, a —CC— group, a —CH═N— group which may have a substituent, a —N═CH— group which may have a substituent, a —CO— group, or a —N═N— group,

b¹² represents a single bond or a divalent group other than b¹¹,

x represents an integer of 0 to 3, when x is an integer of 2 or more, a plurality of b¹¹'s may be identical or different,

y represents an integer of 1 to 3, when y is an integer of 2 or more, a plurality of b¹²'s may be identical or different,

R¹¹ represents a hydrogen atom or any substituent, and

* represents a linking bond.

When the coloring matter (B1) is a coloring matter represented by the Formula [I-1], there is a tendency that aggregates of the coloring matter molecules are less likely to be formed, and a decrease in the fluorescence intensity (concentration quenching) is less likely to occur.

Regarding X, Z, R′, and R² in Formula [1-1], those mentioned as X, Z, R′, and R² in Formula [I] can be preferably employed.

(a′ and a²)

In Formula [I-1], a¹ and a² are each independently a group represented by General Formula [I-1a].

a¹ and a² may be identical or may be different; however, from the viewpoint of the ease of synthesis, it is preferable that the two are identical.

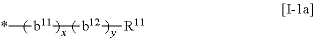

in General Formula [I-1a], b¹¹ represents an arylene group which may have a substituent, a —CH═CH— group which may have a substituent, a —CC— group, a —CH═N— group which may have a substituent, a —N═CH— group which may have a substituent, a —CO— group, or a —N═N— group,

b¹² represents a single bond or a divalent group other than b¹¹,

x represents an integer of 0 to 3, when x is an integer of 2 or more, a plurality of b¹¹'s may be identical or different,

y represents an integer of 1 to 3, when y is an integer of 2 or more, a plurality of b¹¹'s may be identical or different,

R¹¹ represents a hydrogen atom or any substituent, and

* represents a linking bond.

(b¹¹)

In Formula [I-1a], b¹¹ represents an arylene group which may have a substituent, a —CH═CH— group which may have a substituent, a —CC— group, a —CH═N— group which may have a substituent, a —N═CH— group which may have a substituent, —CO—, or a —N═N— group.

Examples of the arylene group include a divalent aromatic hydrocarbon ring group and a divalent aromatic heterocyclic group.

The number of carbon atoms of the arylene group is not particularly limited; however, the number of carbon atoms is preferably 4 or more, and more preferably 6 or more, and is preferably 12 or less, and more preferably 10 or less. When the number of carbon atoms is set to the above-described lower limit value or more, the efficiency of absorption of the excitation light tends to be enhanced, and when the number of carbon atoms is set to the above-described upper limit value or less, solubility tends to be enhanced. The above-described upper limits and lower limits can be arbitrarily combined. For example, the number of carbon atoms is preferably 4 to 12, more preferably 4 to 10, and even more preferably 6 to 10.

When b¹¹ is an arylene group which may have a substituent, it is preferable because there is a tendency that bonded arylene groups are distorted from the diazole plane due to steric hindrance, consequently stacking of the coloring matter (B1) molecules is inhibited, and concentration quenching is less likely to occur.

The aromatic hydrocarbon ring in the aromatic hydrocarbon ring group may be a monocyclic ring or a fused ring.

Examples of the aromatic hydrocarbon ring group include a benzene ring, a naphthalene ring, an anthracene ring, a phenanthrene ring, a perylene ring, a tetracene ring, a pyrene ring, a benzopyrene ring, a chrysene ring, a triphenylene ring, an acenaphthene ring, a fluoranthene ring, and a fluorene ring, each of which has two free valences. From the viewpoints of the solubility and the absorption wavelength, a benzene ring having two free valences and a naphthalene ring having two free valences are preferred, and a benzene ring having two free valences is more preferred.

The aromatic heterocyclic ring in the aromatic heterocyclic group may be a monocyclic ring or a fused ring.

Examples of the aromatic heterocyclic group include a furan ring, a benzofuran ring, a thiophene ring, a benzothiophene ring, a pyrrole ring, a pyrazole ring, an imidazole ring, an oxadiazole ring, an indole ring, a carbazole ring, a pyrroloimidazole ring, a pyrrolopyrazole ring, a pyrrolopyrrole ring, a thienopyrrole ring, a thienothiophene ring, a furopyrrole ring, a furofuran ring, a thienofuran ring, a benzisoxazole ring, a benzisothiazole ring, a benzimidazole ring, a pyridine ring, a pyrazine ring, a pyridazine ring, a pyrimidine ring, a triazine ring, a quinoline ring, an isoquinoline ring, a cinnoline ring, a quinoxaline ring, a phenanthridine ring, a perimidine ring, a quinazoline ring, a quinazolinone ring, and an azulene ring, each of which has two free valences. From the viewpoints of the solubility and the efficiency of energy transfer to the semiconductor nanoparticles, a thiophene ring having two free valences and a pyridine ring having two free valences are preferred.

Examples of the substituent that the arylene group may have include an alkyl group, an alkoxy group, an alkoxycarbonyl group, an aryl group, an aryloxy group, a sulfanyl group, a dialkylphosphino group, an alkylsulfanyl group, a hydroxyl group, a carboxyl group, an amino group, a nitro group, a cyano group, and a halogen atom.

From the viewpoint of the efficiency of energy transfer to the semiconductor nanoparticles, an amino group and a sulfanyl group are preferred. From the viewpoint of solubility, a hydrogen atom, an alkyl group, and an alkoxy group are preferred, and a hydrogen atom, a tert-butyl group, and a 2-propyloxy group are particularly preferred.

Examples of the substituent for the —CH═CH— group which may have a substituent, the —CH═N— group which may have a substituent, or the —N═CH— group which may have a substituent include an alkyl group, an alkoxy group, an acyl group, an alkoxycarbonyl group, an alkylsulfanyl group, an amino group, a cyano group, a sulfanyl group, and a halogen atom. From the viewpoint of the efficiency of energy transfer to the semiconductor nanoparticles, an amino group and a sulfanyl group are preferred. From the viewpoint of solubility, a hydrogen atom, an alkyl group, and an alkoxy group are preferred, and a hydrogen atom, a tert-butyl group, and a 2-propyloxy group are particularly preferred.

Among these, since it is considered that there is a tendency that the planarity of the molecular structure is deteriorated by the steric hindrance between the lone electron pair on the N atom of the diazole moiety and a hydrogen atom or a substituent of the arylene group, the formation of aggregates of the coloring matter (B1) molecules by π-π stacking or the like is suppressed, and the concentration quenching caused by the formation of aggregates can be suppressed, it is preferable that b¹¹ is an arylene group which may have a substituent.

Furthermore, since the coloring matter (B1) itself has only the it-conjugation of the diazole moiety, it is considered that the molecular planarity is low, and the concentration quenching caused by the formation of aggregates tends to be low, it is preferable that b¹′ is a —CH═CH— group which may have a substituent, a —CC— group, a —CH═N— group which may have a substituent, a —N═CH— group which may have a substituent, a —CO— group, or a —N═N— group.

Among these, from the viewpoint of the absorption wavelength, b¹¹ is preferably a divalent benzene ring group or a —CH═CH— group.

(b¹²)

In Formula [I-1a], b¹² represents a single bond or a divalent group other than b¹¹.

The divalent group other than b¹¹ is not particularly limited; however, examples include an alkylene group which may have a substituent, an alkyleneoxy group which may have a substituent, and an alkyleneamino group which may have a substituent.

Examples of the alkylene group include a linear alkylene group, a branched alkylene group, a cyclic alkylene group, and a combination of these. From the viewpoint of the solubility in the composition, a branched alkylene group is preferred.

One or more methylene groups (—CH₂—) included in the alkylene group may be substituted by an etheric oxygen atom (—O—), a thioetheric sulfur atom (—S—), an aminic nitrogen atom (—NH— or —N(R\hat{ })—: here, R\hat{ } represents a linear or branched alkyl group having 1 to 6 carbon atoms), a carbonyl group (—CO—), an ester bond (—COO—), or an amide bond (—CONH—).

The number of carbon atoms of the alkylene group is not particularly limited; however, the number of carbon atoms is usually 1 or more, preferably 4 or more, and more preferably 8 or more, and is preferably 20 or less, more preferably 16 or less, and even more preferably 12 or less. When the number of carbon atoms is set to the above-described lower limit value or more, the solubility in the composition tends to be enhanced, and when the number of carbon atoms is set to the above-described upper limit value or less, the absorbance of the excitation light tends to increase. The above-described upper limits and lower limits can be arbitrarily combined. For example, the number of carbon atoms is preferably 1 to 20, more preferably 4 to 16, and even more preferably 8 to 12.

When one or more of the methylene groups (—CH₂—) in the alkylene group have been substituted by the above-described groups, it is preferable that the number of carbon atoms of the alkylene group before the substitution is included in the above-described range. From the viewpoint of solubility, it is preferable that one or more methylene groups (—CH₂—) in the alkylene group are substituted with etheric oxygen atoms (—O—) within the above-described range of the number of carbon atoms.

Examples of the alkylene group include a methylene group, an ethylene group, a butanediyl group, a heptanediyl group, a decanediyl group, a 2-ethylhexanediyl group, and a —CH₂—CH₂—O—CH₂—CH₂—O—CH₂—CH₂— group. From the viewpoint of the solubility in the composition, a heptanediyl group, a decanediyl group, a 2-ethylhexanediyl group, and a —CH₂—CH₂—O—CH₂—CH₂—O—CH₂—CH₂— group are preferred, and a 2-ethylhexanediyl group is more preferred.

Examples of the substituent that the alkylene group may have include a hydroxyl group, a carboxyl group, an amino group, a sulfanyl group, a dialkylphosphino group having 2 to 12 carbon atoms, and a halogen atom. From the viewpoint of the solubility in the composition, no substitution is preferred. From the viewpoint of the efficiency of energy transfer to the semiconductor nanoparticles, an amino group and a sulfanyl group are preferred.

Examples of the alkyleneoxy group include a group in which an O atom is further bonded to the linking bond to b¹¹ in the above-described alkylene group. Specifically, examples include a —O—(CH₂)₈— group and a —O—CH₂—CH₂—O—CH₂—CH₂—O—CH₂—CH₂— group.

The substituent that the alkyleneoxy group may have is similar to the substituent that the above-described alkylene group may have, and the preferred substituent is also similar.

Regarding the alkyleneamino group, a group in which an aminic nitrogen atom (—NH— or —N(R^{A})—: here, R^{A} represents a linear or branched alkyl group having 1 to 10 carbon atoms) is bonded to the linking bond to b¹¹ in the above-described alkylene group may be mentioned. Specifically, examples include a —NH—(CH₂)₈— group and a —N(2-butyl)-CH₂—CH₂—O—CH₂—CH₂—O—CH₂—CH₂— group.

R^{A} represents a linear or branched alkyl group having 1 to 10 carbon atoms, and the number of carbon atoms is preferably 3 or more and is preferably 8 or less. For example, the number of carbon atoms is preferably 3 to 8. When the number of carbon atoms is set to the above-described lower limit value or more, the solubility in the composition tends to be enhanced, and when the number of carbon atoms is set to the above-described upper limit value or less, the absorbance of the excitation light tends to be enhanced.

Examples of R^{A} include a methyl group, a 2-propyl group, a 2-butyl group, and a 2-ethylhexyl group. From the viewpoint of solubility, a 2-butyl group and a 2-ethylhexyl group are preferred.

The substituent that the alkyleneamino group may have is similar to the substituent that the above-described alkylene group may have, and the preferred substituent is also similar.

Regarding b¹², from the viewpoint of the solubility in the composition, a 2-ethylhexanediyl group and a —O—CH₂—CH₂—O—CH₂—CH₂—O—CH₂—CH₂— group are preferred, and from the viewpoint of enhancing the absorbance of the excitation light, a single bond and a methylene group are preferred.

(x)

In Formula [I-1a], x represents an integer of 0 to 3.

From the viewpoint of the absorption wavelength, x is preferably 1 or 2, and more preferably 1.

It is preferable that either or both x's of x in a¹ and x in a² are integers of 1 to 3, and it is more preferable that both x's of x in a¹ and x in a² are 1. When either or both x's of x in a¹ and x in a² are set to an integer of 1 or more, the efficiency of absorption of the excitation light tends to be enhanced.

When x is an integer of 2 or more, a plurality of b¹¹'s may be identical or different.

(y)

In Formula [I-1a], y represent an integer of 1 to 3.

Among these, from the viewpoints of the solubility in the composition and the absorbance of the excitation light, y is preferably 1 or 2, and particularly, y is more preferably 1.

When y is an integer of 2 or more, a plurality of b¹²'s may be identical or different.

(R¹¹)

In the Formula [I-1a], R¹¹ represents a hydrogen atom or any substituent.

The any substituent is not particularly limited as long as it is a substitutable monovalent group, and examples include an aryl group which may have a substituent, an aryloxy group which may have a substituent, a hydroxyl group, a carboxyl group, a formyl group, a sulfo group, an amino group which may have a substituent, a sulfanyl group, an alkylsulfanyl group which may have a substituent, a dialkylphosphino group which may have a substituent, a nitro group, a cyano group, a trialkylsilyl group which may have a substituent, a dialkylboryl group which may have a substituent, and a halogen atom.

Regarding the aryl group, a monovalent aromatic hydrocarbon ring group and a monovalent aromatic heterocyclic group may be mentioned.

The number of carbon atoms of the aryl group is not particularly limited; however, the number of carbon atoms is preferably 4 or more, and more preferably 6 or more, and is preferably 12 or less, and more preferably 10 or less. When the number of carbon atoms is set to the above-described lower limit value or more, the efficiency of absorption of the excitation light tends to be enhanced, and when the number of carbon atoms is set to the above-described upper limit value or less, solubility tends to be enhanced. The above-described upper limits and lower limits can be arbitrarily combined. For example, the number of carbon atoms is preferably 4 to 12, more preferably 4 to 10, and even more preferably 6 to 10.

The aromatic hydrocarbon ring in the aromatic hydrocarbon ring group may be a monocyclic ring or a fused ring.

Examples of the aromatic hydrocarbon ring group include a benzene ring, a naphthalene ring, an anthracene ring, a phenanthrene ring, a perylene ring, a tetracene ring, a pyrene ring, a benzopyrene ring, a chrysene ring, a triphenylene ring, an acenaphthene ring, a fluoranthene ring, and a fluorene ring, each of which has one free valence. From the viewpoints of the solubility and the absorption wavelength, a benzene ring having one free valence and a naphthalene ring having one free valence are preferred, and a benzene ring having one free valence is more preferred.

The aromatic heterocyclic ring in the aromatic heterocyclic group may be a monocyclic ring or a fused ring.

Examples of the aromatic heterocyclic group include a furan ring, a benzofuran ring, a thiophene ring, a benzothiophene ring, a pyrrole ring, a pyrazole ring, an imidazole ring, an oxadiazole ring, an indole ring, a carbazole ring, a pyrroloimidazole ring, a pyrrolopyrazole ring, a pyrrolopyrrole ring, a thienopyrrole ring, a thienothiophene ring, a furopyrrole ring, a furofuran ring, a thienofuran ring, a benzisoxazole ring, a benzisothiazole ring, a benzimidazole ring, a pyridine ring, a pyrazine ring, a pyridazine ring, a pyrimidine ring, a triazine ring, a quinoline ring, an isoquinoline ring, a cinnoline ring, a quinoxaline ring, a phenanthridine ring, a pyrimidine ring, a quinazoline ring, a quinazolinone ring, and an azulene ring, each of which has one free valence. From the viewpoint of the efficiency of energy transfer to the semiconductor nanoparticles, a thiophene ring having one free valence, a pyridine ring having one free valence, and a triazine ring having one free valence are preferred.

Examples of the substituent that the aryl group may have include an alkyl group, an alkoxy group, an alkoxycarbonyl group, a hydroxyl group, a carboxyl group, an amino group, a sulfanyl group, a dialkylphosphino group, and a halogen atom. From the viewpoint of the efficiency of energy transfer to the semiconductor nanoparticles, an amino group and a sulfanyl group are preferred. From the viewpoint of the solubility in the composition, an alkyl group and an alkoxy group are preferred.

Regarding the aryloxy group, a group in which an O atom is further bonded to the linking bond of the aryl group may be mentioned.

Regarding the amino group which may have a substituent, a group in which two hydrogen atoms or two linking bonds of alkyl groups are each independently bonded to a nitrogen atom, may be mentioned. Specific examples include an amino group, a butylamino group, and a dimethylamino group.

Regarding the alkylsulfanyl group which may have a substituent, a group in which a sulfur atom is further bonded to the linking bond of an alkyl group may be mentioned. Specific examples include a methylsulfanyl group, an ethylsulfanyl group, a butylsulfanyl group, and a 2-ethylhexylsulfanyl group.

Regarding the dialkylphosphino group which may have a substituent, a group in which two linking bonds of alkyl groups are each independently bonded to a phosphorus atom may be mentioned. Specific examples include a dibutylphosphino group and a butylethylphosphino group.

Regarding the trialkylsilyl group, a group in which three alkyl groups are bonded to a Si atom may be mentioned. The three alkyl groups may be each identical or may be different. Specific examples include a trimethylsilyl group and a tert-butyldimethylsilyl group.

Regarding the dialkylboryl group, a group in which two alkyl groups are bonded to a boron atom may be mentioned. The two alkyl groups may be each identical or may be different. Specific examples include a dimethylboryl group and a diethylboryl group.

Examples of the halogen atom include a fluorine atom, a chlorine atom, a bromine atom, and an iodine atom. From the viewpoint of molecular durability, a fluorine atom and a chlorine atom are preferred.

Regarding R¹¹, from the viewpoint of the efficiency of energy transfer to the semiconductor nanoparticles, a carboxyl group, an amino group, a sulfanyl group, and a pyridyl group are preferred. From the viewpoint of solubility, a hydrogen atom and a trialkylsilyl group are preferred.

Specific examples of the coloring matter (B1) are given below.

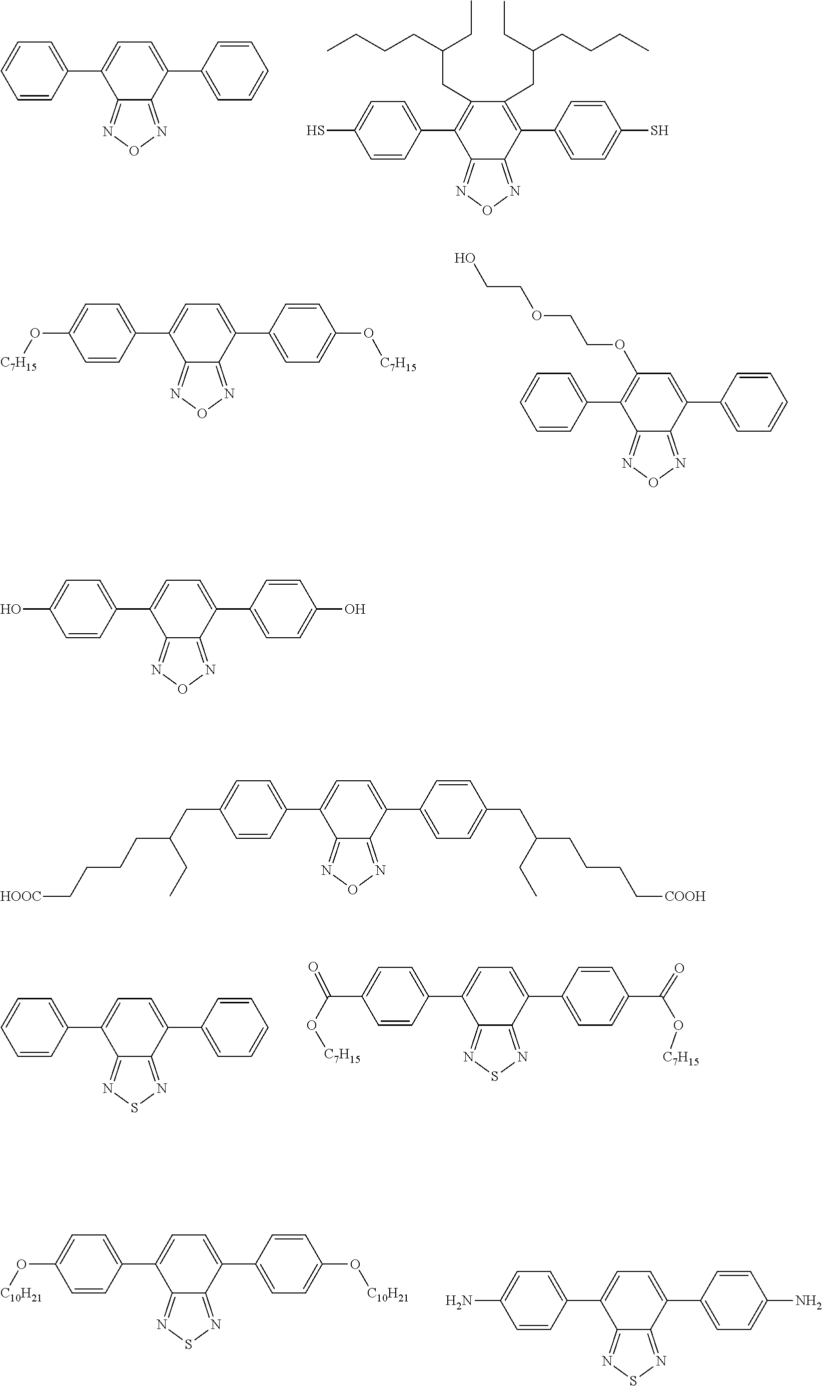

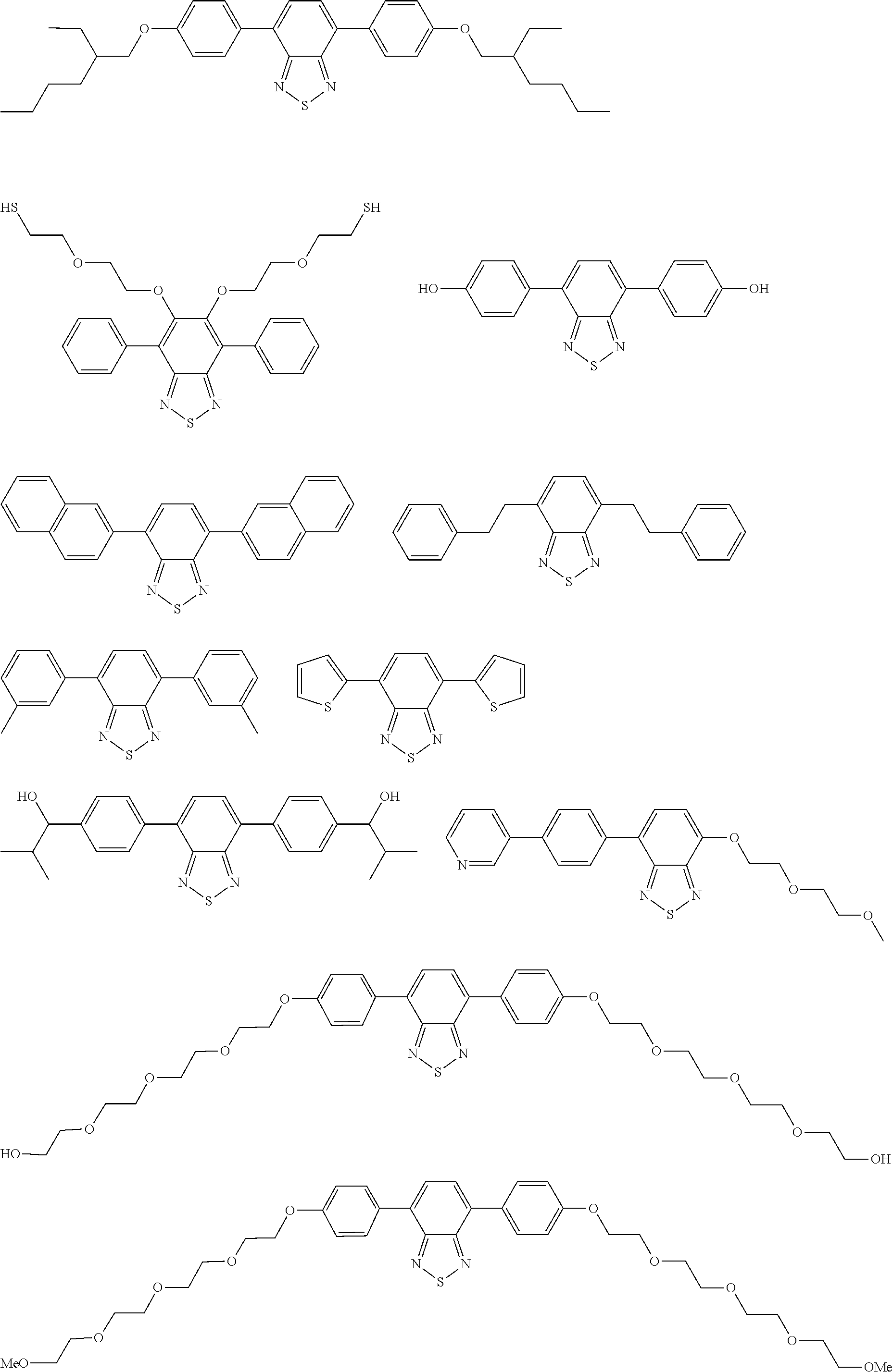

The method for producing the coloring matter (B1) is not particularly limited; however, for example, the coloring matter (B1) can be produced by the methods described in Japanese Unexamined Patent Application, First Publication No. 2003-104976 and Japanese Unexamined Patent Application, First Publication No. 2011-231245.

The maximum emission wavelength of the fluorescence emitted by the coloring matter (B1) is not particularly limited; however, the maximum emission wavelength is preferably 450 nm or more, more preferably 455 nm or more, even more preferably 460 nm or more, and particularly preferably 465 nm or more, and is preferably 600 nm or less, preferably 560 nm or less, more preferably 530 nm or less, and particularly preferably 500 nm or less.

When the maximum emission wavelength is set to the above-described lower limit value or more, semiconductor nanoparticles that could not be excited by blue light of an excitation source can be excited, which tends to lead to an increase in the luminescence intensity of the semiconductor nanoparticles, and when the maximum emission wavelength is set to the above-described upper limit value or less, the emission spectrum of the semiconductor nanoparticles and the emission spectrum of the coloring matter (B1) can be separated, so that the energy transferred from the coloring matter (B1) to the semiconductor nanoparticles becomes large, and when the semiconductor nanoparticle-containing composition is used for displays, there is a tendency that absorption of light emitted from the coloring matter (B1) in an unnecessary wavelength region by a color filter provided separately from the pixel part is facilitated. For example, when the maximum emission wavelength of the fluorescence emitted by the coloring matter (B1) exists in the vicinity of 460 to 510 nm, there is a tendency that the luminescence intensities of both the green semiconductor nanoparticles and the red semiconductor nanoparticles can be increased, which is preferable.

The above-described upper limits and lower limits can be arbitrarily combined. For example, the maximum emission wavelength is preferably 450 to 600 nm, more preferably 455 to 560 nm, even more preferably 460 to 530 nm, and particularly preferably 465 to 500 nm.

The method for measuring the maximum emission wavelength is not particularly limited; however, for example, the maximum emission wavelength may be read from an emission spectrum measured with a spectrofluorophotometer by using a solution of the coloring matter (B1) or a film including the coloring matter (B1), and by using light having a wavelength of 445 nm as an excitation light source.

When the semiconductor nanoparticle-containing composition of the present invention includes the coloring matter (B1), the content proportion of the coloring matter (B1) in the semiconductor nanoparticle-containing composition is not particularly limited; however, the content proportion is preferably 0.001% by mass or more, more preferably 0.005% by mass or more, even more preferably 0.01% by mass or more, still more preferably 0.05% by mass or more, even more preferably 0.1% by mass or more, particularly preferably 0.5% by mass or more, and most preferably 1% by mass or more, and is preferably 30% by mass or less, more preferably 20% by mass or less, even more preferably 10% by mass or less, and particularly preferably 5% by mass or less, all in the total solid content of the semiconductor nanoparticle-containing composition.

When the content proportion is set to the above-described lower limit value or more, there is a tendency that the coloring matter sufficiently absorbs the emitted light, the amount of energy transfer from the coloring matter to the semiconductor nanoparticles is increased, and the luminescence intensity of the semiconductor nanoparticles is increased. Furthermore, when the content proportion is set to the above-described upper limit value or less, there is a tendency that the concentration quenching of the coloring matter is suppressed, the luminescence intensity of the semiconductor nanoparticles is increased as energy is efficiently transferred from the coloring matter to the semiconductor nanoparticles, and a wavelength conversion layer having sufficient hardness is obtained by including components other than the semiconductor nanoparticles and the coloring matter.

The above-described upper limits and lower limits can be arbitrarily combined. For example, the content proportion is preferably 0.001% to 30% by mass, more preferably 0.005% to 30% by mass, even more preferably 0.01% to 20% by mass, still more preferably 0.05% to 20% by mass, even more preferably 0.1% to 10% by mass, particularly preferably 0.5% to 10% by mass, and most preferably 1% to 5% by mass.

[1-2-2] Coloring matter (B2)

The coloring matter (B2) is a coloring matter represented by General Formula [II]:

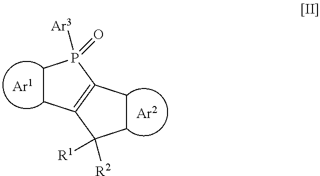

in General Formula [II], Ar¹, Ar², and Ar³ each independently represent an aryl group which may have a substituent, and

R¹ and R² each independently represent an alkyl group which may have a substituent, or an aryl group which may have a substituent.

It is considered that the coloring matter (B2) and the semiconductor nanoparticles (A) attract each other due to the interaction caused by the lone electron pair on the oxygen atom of the phosphole oxide part of the coloring matter (B2), and as the coloring matter (B2) sufficiently approaches the semiconductor nanoparticles (A), the luminescence intensity of the semiconductor nanoparticles (A) is further increased because the efficiency of the excited energy of the coloring matter (B2) transferring to the semiconductor nanoparticles (A) by Forster-type energy transfer is enhanced.

(Ar¹, Ar², and Ar³)

In the Formula [II], Ar¹, Ar², and Ar³ each independently represent an aryl group which may have a substituent.

Regarding the aryl group, for Ar¹ and Ar², a divalent aromatic hydrocarbon ring group (aromatic hydrocarbon ring having two free valences) and a divalent aromatic heterocyclic group (aromatic heterocyclic ring having two free valences) may be mentioned. For Ar³, a monovalent aromatic hydrocarbon ring group (aromatic hydrocarbon ring having one free valence) and a monovalent aromatic heterocyclic group (aromatic heterocyclic ring having one free valence) may be mentioned.

The number of carbon atoms of the aryl group is not particularly limited; however, the number of carbon atoms is preferably 4 or more, and more preferably 6 or more, and is preferably 20 or less, and more preferably 15 or less. When the number of carbon atoms is set to the above-described lower limit value or more, the efficiency of energy transfer to the semiconductor nanoparticles tends to be enhanced, and when the number of carbon atoms is set to the above-described upper limit value or less, the absorbance of the excitation light tends to increase. The above-described upper limits and lower limits can be arbitrarily combined. For example, the number of carbon atoms is preferably 4 to 20, more preferably 4 to 15, and even more preferably 6 to 15.

The aromatic hydrocarbon ring in the aromatic hydrocarbon ring group may be a monocyclic ring or a fused ring.

Examples of the aromatic hydrocarbon ring include a benzene ring, a naphthalene ring, an anthracene ring, a phenanthrene ring, a perylene ring, a tetracene ring, a pyrene ring, a benzopyrene ring, a chrysene ring, a triphenylene ring, an acenaphthene ring, a fluoranthene ring, and a fluorene ring. From the viewpoints of solubility, the absorption wavelength, and the light resistance, a benzene ring and a naphthalene ring are preferred, and a naphthalene ring is more preferred.

The aromatic heterocyclic ring in the aromatic heterocyclic group may be a monocyclic ring or a fused ring.

Examples of the aromatic heterocyclic ring include a furan ring, a benzofuran ring, a thiophene ring, a benzothiophene ring, a pyrrole ring, a pyrazole ring, an imidazole ring, an oxadiazole ring, an indole ring, a carbazole ring, a pyrroloimidazole ring, a pyrrolopyrazole ring, a pyrrolopyrrole ring, a thienopyrrole ring, a thienothiophene ring, a furopyrrole ring, a furofuran ring, a thienofuran ring, a benzisoxazole ring, a benzisothiazole ring, a benzimidazole ring, a pyridine ring, a pyrazine ring, a pyridazine ring, a pyrimidine ring, a triazine ring, a quinoline ring, an isoquinoline ring, a cinnoline ring, a quinoxaline ring, a phenanthridine ring, a perimidine ring, a quinazoline ring, a quinazolinone ring, and an azulene ring. From the viewpoint of the efficiency of energy transfer to the semiconductor nanoparticles, a thiophene ring and a pyridine ring are preferred.

Examples of the substituent that the aryl group may have include an alkyl group having 1 to 20 carbon atoms, an alkoxy group having 1 to 20 carbon atoms, an alkoxycarbonyl group having 2 to 20 carbon atoms, a hydroxyl group, a carboxyl group, an alkyl- or dialkylamino group having 1 to 20 carbon atoms, an aryl- or diarylamino group having 4 to 20 carbon atoms, a sulfanyl group, a dialkylphosphino group having 1 to 6 carbon atoms, and a halogen atom. From the viewpoint of the efficiency of energy transfer to the semiconductor nanoparticles, an amino group and a sulfanyl group are preferred.

From the viewpoint of increasing the luminescence intensity, it is preferable that Ar¹ is a benzene ring having two free valences or a naphthalene ring having two free valences. From the viewpoint of increasing the luminescence intensity, it is preferable that Ar² is a group represented by any of General Formulae [IIa], [IIb], and [IIc]. From the viewpoint of increasing the luminescence intensity, it is preferable that Ar³ is a benzene ring having one free valence.

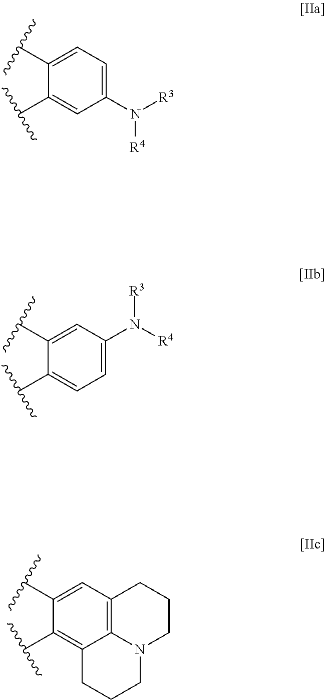

In General Formulae [IIa] and [IIb], R³ and R⁴ each independently represent an alkyl group which may have a substituent, or an aryl group which may have a substituent.

(R³ and R⁴)

In the Formulae [IIa] and [IIb], R³ and R⁴ each independently have an alkyl group which may have a substituent or an aryl group which may have a substituent.

Examples of the alkyl group include a linear alkyl group, a branched alkyl group, a cyclic alkyl group, and a combination of these. From the viewpoint of solubility, a branched alkyl group is preferred.

The number of carbon atoms of the alkyl group is not particularly limited; however, the number of carbon atoms is usually 1 or more, preferably 5 or more, and more preferably 10 or more, and is preferably 30 or less, and more preferably 20 or less. By setting the number of carbon atoms to be within the above-described range, solubility tends to be enhanced. The above-described upper limits and lower limits can be arbitrarily combined. For example, the number of carbon atoms is preferably 1 to 30, more preferably 5 to 30, and even more preferably 10 to 20.

Examples of the alkyl group include a methyl group, an ethyl group, an isopropyl group, an isobutyl group, a tert-butyl group, a 2-ethylhexyl group, and a (2-hydroxyethoxy)ethyl group. From the viewpoint of solubility, an isobutyl group and a 2-ethylhexyl group are preferred, and a 2-ethylhexyl group is more preferred.

Examples of the substituent that the alkyl group may have include a hydroxyl group, a carboxyl group, an amino group, a sulfanyl group, a dialkylphosphino group having 2 to 12 carbon atoms, and a halogen atom. From the viewpoint of the efficiency of energy transfer to the semiconductor nanoparticles, an amino group and a sulfanyl group are preferred.

Regarding the aryl group, a monovalent aromatic hydrocarbon ring group and a monovalent aromatic heterocyclic group may be mentioned.

The number of carbon atoms of the aryl group is not particularly limited; however, the number of carbon atoms is preferably 4 or more, and more preferably 6 or more, and is preferably 12 or less, and more preferably 10 or less. When the number of carbon atoms is set to the above-described lower limit value or more, the efficiency of energy transfer to the semiconductor nanoparticles tends to be enhanced, and when the number of carbon atoms is set to the above-described upper limit value or less, solubility tends to be enhanced. The above-described upper limits and lower limits can be arbitrarily combined. For example, the number of carbon atoms is preferably 4 to 12, more preferably 4 to 10, and even more preferably 6 to 10.

The aromatic hydrocarbon ring in the aromatic hydrocarbon ring group may be a monocyclic ring or a fused ring.

Examples of the aromatic hydrocarbon ring group include a benzene ring, a naphthalene ring, an anthracene ring, a phenanthrene ring, a perylene ring, a tetracene ring, a pyrene ring, a benzopyrene ring, a chrysene ring, a triphenylene ring, an acenaphthene ring, a fluoranthene ring, and a fluorene ring, each of which has one free valence. From the viewpoints of the ease of synthesis, the absorption wavelength, and solubility, a benzene ring having one free valence and a naphthalene ring having one free valence are preferred, and a benzene ring having one free valence is more preferred.

The aromatic heterocyclic ring in the aromatic heterocyclic group may be a monocyclic ring or a fused ring.

Examples of the aromatic heterocyclic group include a furan ring, a benzofuran ring, a thiophene ring, a benzothiophene ring, a pyrrole ring, a pyrazole ring, an imidazole ring, an oxadiazole ring, an indole ring, a carbazole ring, a pyrroloimidazole ring, a pyrrolopyrazole ring, a pyrrolopyrrole ring, a thienopyrrole ring, a thienothiophene ring, a furopyrrole ring, a furofuran ring, a thienofuran ring, a benzisoxazole ring, a benzisothiazole ring, a benzimidazole ring, a pyridine ring, a pyrazine ring, a pyridazine ring, a pyrimidine ring, a triazine ring, a quinoline ring, an isoquinoline ring, a cinnoline ring, a quinoxaline ring, a phenanthridine ring, a perimidine ring, a quinazoline ring, a quinazolinone ring, and an azulene ring, each of which has one free valence. From the viewpoint of the efficiency of energy transfer to the semiconductor nanoparticles, a thiophene ring having one free valence and a pyridine ring having one free valence are preferred.

Examples of the substituent that the aryl group may have include an alkyl group having 1 to 6 carbon atoms, an alkoxy group having 1 to 6 carbon atoms, an alkoxycarbonyl group having 2 to 7 carbon atoms, a hydroxyl group, a carboxyl group, an amino group, a sulfanyl group, a dialkylphosphino group having 2 to 12 carbon atoms, and a halogen atom. From the viewpoint of the efficiency of energy transfer to the semiconductor nanoparticles, an amino group and a sulfanyl group are preferred.

(R¹ and R²)

In the Formula [II], R¹ and R² each independently represent an alkyl group which may have a substituent, or an aryl group which may have a substituent.

Examples of the alkyl group include a linear alkyl group, a branched alkyl group, a cyclic alkyl group, and a combination of these. From the viewpoint of enhancing the light resistance caused by steric hindrance, a branched alkyl group and a cyclic alkyl group are preferred.

The number of carbon atoms of the alkyl group is not particularly limited; however, the number of carbon atoms is usually 1 or more, preferably 3 or more, and more preferably 6 or more, and is preferably 30 or less, and more preferably 20 or less. When the number of carbon atoms is set to the above-described lower limit value or more, the light resistance caused by steric hindrance tends to be enhanced, and when the number of carbon atoms is set to the above-described upper limit value or less, solubility tends to be enhanced. The above-described upper limits and lower limits can be arbitrarily combined. For example, the number of carbon atoms is preferably 1 to 30, more preferably 3 to 30, and even more preferably 6 to 20.

Examples of the alkyl group include a methyl group, an ethyl group, an isopropyl group, an isobutyl group, a tert-butyl group, a 2-ethylhexyl group, a (2-hydroxyethoxy)ethyl group, a cyclopentyl group, and a cyclohexyl group. From the viewpoint of enhancing the light resistance caused by steric hindrance, a tert-butyl group and a cyclohexyl group are preferred, and a tert-butyl group is more preferred.

Examples of the substituent that the alkyl group may have include a hydroxyl group, a carboxyl group, an amino group, a sulfanyl group, a dialkylphosphino group having 2 to 12 carbon atoms, and a halogen atom. From the viewpoint of the efficiency of energy transfer to the semiconductor nanoparticles, an amino group and a sulfanyl group are preferred.

Regarding the aryl group, a monovalent aromatic hydrocarbon ring group and a monovalent aromatic heterocyclic group may be mentioned.

The number of carbon atoms of the aryl group is not particularly limited; however, the number of carbon atoms is preferably 4 or more, and more preferably 6 or more, and is preferably 12 or less, and more preferably 10 or less. When the number of carbon atoms is set to the above-described lower limit value or more, the light resistance caused by steric hindrance tends to be enhanced, and when the number of carbon atoms is set to the above-described upper limit value or less, solubility tends to be enhanced. The above-described upper limits and lower limits can be arbitrarily combined. For example, the number of carbon atoms is preferably 4 to 12, more preferably 4 to 10, and even more preferably 6 to 10.

The aromatic hydrocarbon ring in the aromatic hydrocarbon ring group may be a monocyclic ring or a fused ring.

Examples of the aromatic hydrocarbon ring group include a benzene ring, a naphthalene ring, an anthracene ring, a phenanthrene ring, a perylene ring, a tetracene ring, a pyrene ring, a benzopyrene ring, a chrysene ring, a triphenylene ring, an acenaphthene ring, a fluoranthene ring, and a fluorene ring, each of which has one free valence. From the viewpoint of the ease of synthesis and solubility, a benzene ring having one free valence and a naphthalene ring having one free valence are preferred, and a benzene ring having one free valence is more preferred.

The aromatic heterocyclic ring in the aromatic heterocyclic group may be a monocyclic ring or a fused ring.

Examples of the aromatic heterocyclic group include a furan ring, a benzofuran ring, a thiophene ring, a benzothiophene ring, a pyrrole ring, a pyrazole ring, an imidazole ring, an oxadiazole ring, an indole ring, a carbazole ring, a pyrroloimidazole ring, a pyrrolopyrazole ring, a pyrrolopyrrole ring, a thienopyrrole ring, a thienothiophene ring, a furopyrrole ring, a furofuran ring, a thienofuran ring, a benzisoxazole ring, a benzisothiazole ring, a benzimidazole ring, a pyridine ring, a pyrazine ring, a pyridazine ring, a pyrimidine ring, a triazine ring, a quinoline ring, an isoquinoline ring, a cinnoline ring, a quinoxaline ring, a phenanthridine ring, a perimidine ring, a quinazoline ring, a quinazolinone ring, and an azulene ring, each of which has one free valence. From the viewpoint of the efficiency of energy transfer to the semiconductor nanoparticles, a thiophene ring having one free valence and a pyridine ring having one free valence are preferred.

Examples of the substituent that the aryl group may have include an alkyl group having 1 to 20 carbon atoms, an alkoxy group having 1 to 20 carbon atoms, an alkoxycarbonyl group having 2 to 20 carbon atoms, a hydroxyl group, a carboxyl group, an amino group, a sulfanyl group, a dialkylphosphino group having 2 to 12 carbon atoms, and a halogen atom. From the viewpoint of solubility, an alkoxy group having 2 to 20 carbon atoms is preferred.

Regarding the alkoxy group, a group in which an O atom is further bonded to the linking bond of the above-described alkyl group may be mentioned. Furthermore, from the viewpoint of solubility, it is preferable that one or more methylene groups (—CH₂—) included in the alkyl group are substituted with etheric oxygen atoms (—O—).

Examples of the alkoxy group include a methoxy group, an ethoxy group, a (2-methoxyethoxy)ethoxy group, and a 2-[2-(2-methoxyethoxy)ethoxy] ethoxy group, and a group having a polyether structure, such as a (2-hydroxyethoxy)ethoxy group or a 2-[2-(2-hydroxyethoxy)ethoxy]ethoxy group, is preferred from the viewpoint of enhancing the solubility.

Specific examples of the coloring matter (B2) are given below.

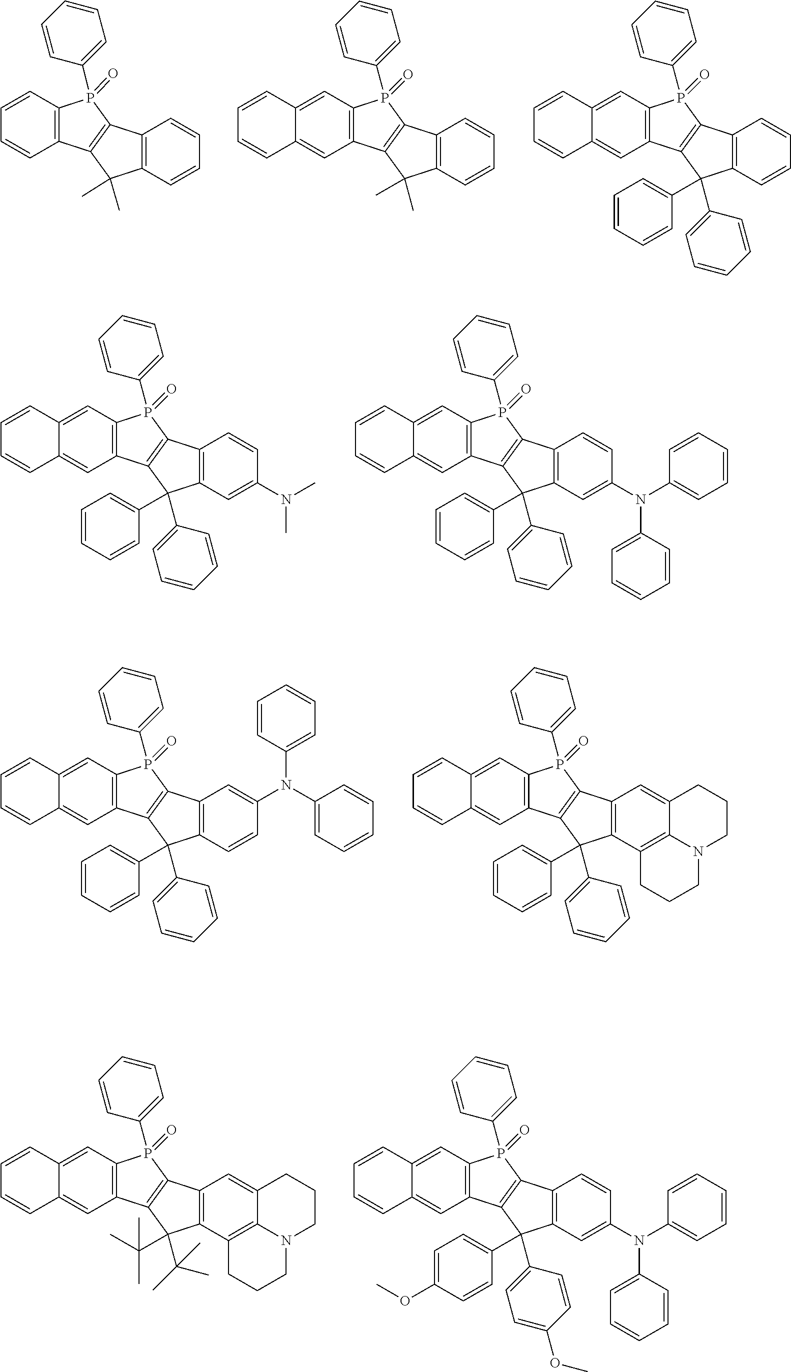

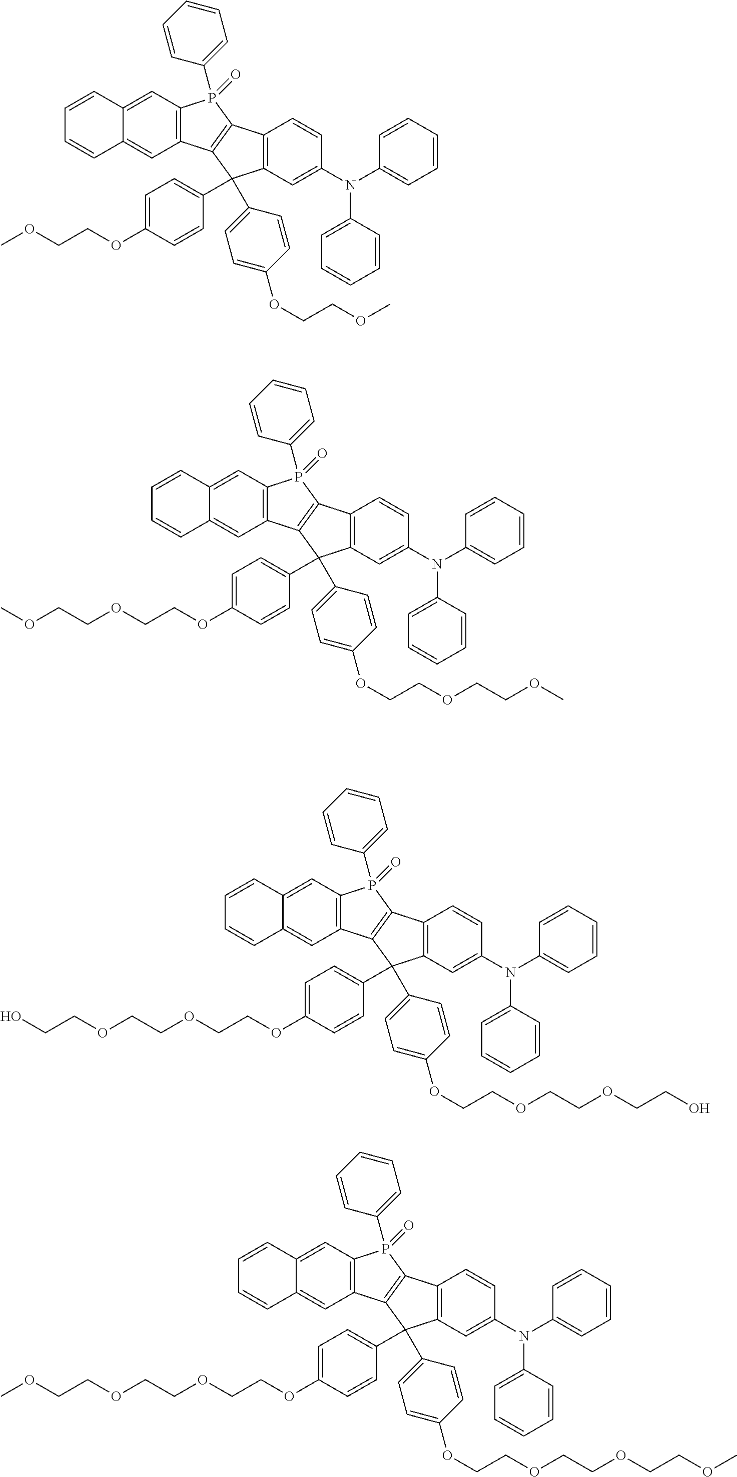

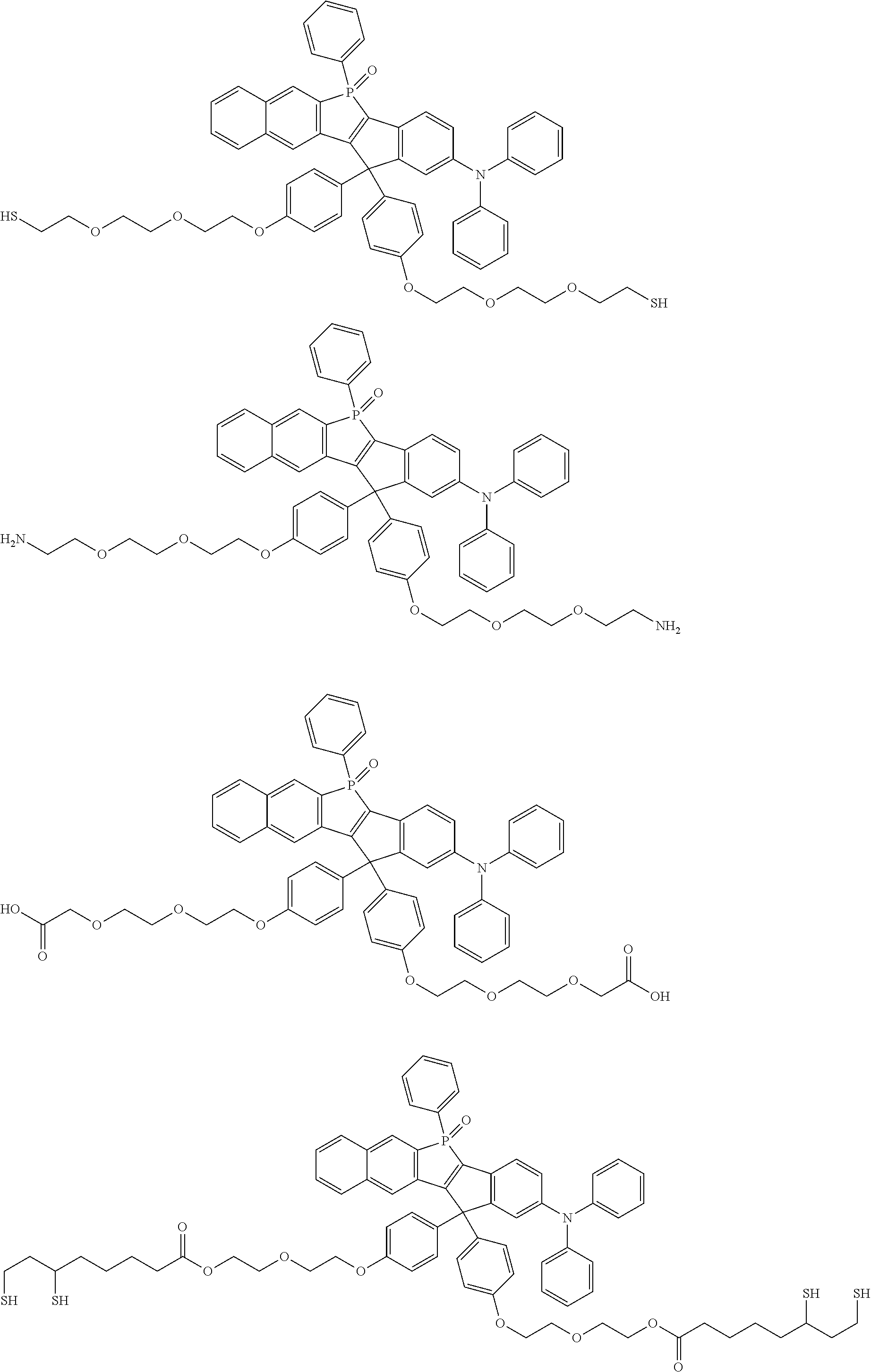 [SMILES: O=P1(c2ccccc2)C2=C(c3cc4ccccc4cc31)C(c1ccc(OCCOCCOCCS)cc1)(c1ccc(OCCOCCOCCS)cc1)c1cc(N(c3ccccc3)c3ccccc3)ccc12 ; NCCOCCOCCOc1ccc(C2(c3ccc(OCCOCCOCCN)cc3)C3=C(c4ccc(N(c5ccccc5)c5ccccc5)cc42)P(=O)(c2ccccc2)c2cc4ccccc4cc23)cc1 ; O=C(O)COCCOCCOc1ccc(C2(c3ccc(OCCOCCOCC(=O)O)cc3)C3=C(c4ccc(N(c5ccccc5)c5ccccc5)cc42)P(=O)(c2ccccc2)c2cc4ccccc4cc23)cc1 ; O=C(CCCCC(S)CCS)OCCOCCOc1ccc(C2(c3ccc(OCCOCCOC(=O)CCCCC(S)CCS)cc3)C3=C(c4ccc(N(c5ccccc5)c5ccccc5)cc42)P(=O)(c2ccccc2)c2cc4ccccc4cc23)cc1]

The method for producing the coloring matter (B2) is not particularly limited; however, the coloring matter (B2) can be produced by, for example, the method described in PCT International Publication No. WO 2015/111647.

The maximum emission wavelength of the fluorescence emitted by the coloring matter (B2) is not particularly limited; however, the maximum emission wavelength is preferably 450 nm or more, more preferably 455 nm or more, even more preferably 460 nm or more, and particularly preferably 465 nm or more, and is preferably 600 nm or less, preferably 560 nm or less, more preferably 540 nm or less, and particularly preferably 500 nm or less.

When the maximum emission wavelength is set to the above-described lower limit value or more, semiconductor nanoparticles that could not be excited by blue light of an excitation source can be excited, which tends to lead to an increase in the luminescence intensity of the semiconductor nanoparticles, and when the maximum emission wavelength is set to the above-described upper limit value or less, the emission spectrum of the semiconductor nanoparticles and the emission spectrum of the coloring matter (B2) can be separated, so that the energy transferred from the coloring matter (B2) to the semiconductor nanoparticles becomes large, and when the semiconductor nanoparticle-containing composition is used for displays, there is a tendency that absorption of light emitted from the coloring matter (B2) in an unnecessary wavelength region by a color filter provided separately from the pixel part is facilitated. For example, when the maximum emission wavelength of the fluorescence emitted by the coloring matter (B2) exists in the vicinity of 460 to 540 nm, there is a tendency that the luminescence intensities of the green light-emitting semiconductor nanoparticles and the red light-emitting semiconductor nanoparticles can be increased, which is preferable.

The above-described upper limits and lower limits can be arbitrarily combined. For example, the maximum emission wavelength is preferably 450 to 600 nm, more preferably 455 to 560 nm, even more preferably 460 to 540 nm, and particularly preferably 465 to 500 nm.

The method for measuring the maximum emission wavelength is not particularly limited; however, for example, the maximum emission wavelength may be read from an emission spectrum measured with a spectrofluorophotometer by using a solution of the coloring matter (B2) or a film including the coloring matter (B2), and by using light having a wavelength of 445 nm as an excitation light source.

When the semiconductor nanoparticle-containing composition of the present invention includes the coloring matter (B2), the content proportion of the coloring matter (B2) in the semiconductor nanoparticle-containing composition is not particularly limited; however, the content proportion is preferably 0.001% by mass or more, more preferably 0.005% by mass or more, even more preferably 0.01% by mass or more, still more preferably 0.05% by mass or more, even more preferably 0.1% by mass or more, particularly preferably 0.5% by mass or more, and most preferably 1% by mass or more, and is preferably 30% by mass or less, more preferably 20% by mass or less, even more preferably 10% by mass or less, and particularly preferably 5% by mass or less, all in the total solid content of the semiconductor nanoparticle-containing composition.

When the content proportion is set to the above-described lower limit value or more, there is a tendency that the coloring matter sufficiently absorbs the emitted light, the amount of energy transfer from the coloring matter to the semiconductor nanoparticles is increased, and the luminescence intensity of the semiconductor nanoparticles is increased. Furthermore, when the content proportion is set to the above-described upper limit value or less, there is a tendency that the concentration quenching of the coloring matter is suppressed, the luminescence intensity of the semiconductor nanoparticles is increased as energy is efficiently transferred from the coloring matter to the semiconductor nanoparticles, and a wavelength conversion layer having sufficient hardness is obtained by including components other than the semiconductor nanoparticles and the coloring matter.

The above-described upper limits and lower limits can be arbitrarily combined. For example, the content proportion is preferably 0.001% to 30% by mass, more preferably 0.005% to 30% by mass, even more preferably 0.01% to 20% by mass, still more preferably 0.05% to 20% by mass, even more preferably 0.1% to 10% by mass, particularly preferably 0.5% to 10% by mass, and most preferably 1% to 5% by mass.

[1-2-3] Coloring Matter (B3)

The coloring matter (B3) is a coloring matter represented by General Formula [III] and having a total degree of branching of 3 or more:

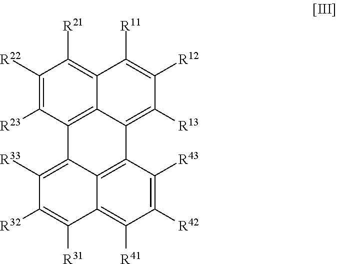

in General Formula [III], R¹¹, R²¹, R³¹, and R⁴¹ each independently represent a hydrogen atom or any substituent, provided that one or more of R¹¹, R¹², R³¹, and R⁴¹ are each a group represented by General Formula [Ina]:

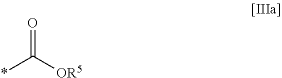

in General Formula [IIIa], R⁵ represents a hydrogen atom or any substituent, and

* represents a linking bond.

R¹², R¹³, R²², R²³, R³², R³³, R⁴², and R⁴³ each independently represent a hydrogen atom or any substituent.

The total degree of branching is defined as a value obtained for the atoms in the coloring matter structure by assigning a degree of branching of 1 to a trisubstituted carbon atom (here, representing a carbon atom to which three substituents and one hydrogen atom are bonded), a trisubstituted nitrogen atom, a phosphorus atom in a trisubstituted phosphanetriyl group, and a phosphorus atom in a trisubstituted phosphoryl group; a degree of branching of 2 to a tetrasubstituted carbon atom, a tetrasubstituted nitrogen atom, and a tetrasubstituted silicon atom; and a value of 0 to the other atoms, and summing the values.

The total degree of branching in the coloring matter (B3) is preferably 3 or more, and more preferably 4 or more, and is preferably 10 or less, and more preferably 8 or less. When the total degree of branching is set to the above-described lower limit or more, the solubility in an ink and the fluorescence quantum yield caused by suppressing concentration quenching tend to be enhanced, and when the total degree of branching is set to the above-described upper limit or less, there is a tendency that the difficulties of industrial purification due to a decrease in the melting point can be suppressed.

The above-described upper limits and lower limits can be arbitrarily combined. For example, the total degree of branching is preferably 3 to 10, more preferably 3 to 8, and even more preferably 4 to 8.

Since the coloring matter (B3) has a perylene skeleton in the mother skeleton, it is considered that the coloring matter (B3) exhibits a high quantum yield and exhibits sufficient luminescence intensity when a wavelength conversion layer is formed. Simultaneously with this, it is considered that durability and light resistance are also high because of the rigid skeleton.

In addition to this, it is considered that the coloring matter (B3) and the semiconductor nanoparticles (A) attract each other due to the interaction caused by the lone electron pair on the oxygen atom of the carbonyl part in the Formula (IIIa) of the coloring matter (B3), and as the coloring matter (B3) sufficiently approaches the semiconductor nanoparticles (A), the efficiency of the excited energy of the coloring matter (B3) transferring to the semiconductor nanoparticles (A) by Forster-type energy transfer is high, while the luminescence intensity of the semiconductor nanoparticles is increased.

(R¹¹, R²¹, R³¹, and R⁴¹)

In Formula [III], R¹¹, R²¹, R³¹ and R⁴¹ each independently represent a hydrogen atom or any substituent. However, one or more of R¹¹, R²¹, R³¹, and R⁴¹ are each a group represented by General Formula [IIIa]:

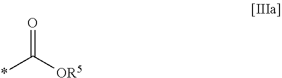

in General Formula [IIIa], R⁵ represents a hydrogen atom or any substituent, and represents a linking bond.

The any substituent in R⁵ is not particularly limited as long as it is a substitutable monovalent group, and examples thereof include a hydrocarbon group which may have a substituent. Some of —CH₂— in the hydrocarbon group may be substituted with —O—, and some of carbon atoms in the hydrocarbon group may be substituted with a heteroatom. Examples of the hydrocarbon group include an alkyl group which may have a substituent, and an aryl group which may have a substituent. R⁵ may be linked to any of R¹¹, R²¹, R³¹, and R⁴¹ to form a ring.

Examples of the alkyl group for R⁵ include a linear alkyl group, a branched alkyl group, a cyclic alkyl group, and a combination of these. From the viewpoint of the solubility in the semiconductor nanoparticle-containing composition and from the viewpoint of enhancing the efficiency of conversion of the excitation light by suppressing concentration quenching, a branched alkyl group is preferred.

The number of carbon atoms of the alkyl group is not particularly limited; however, the number of carbon atoms is usually 1 or more, preferably 3 or more, more preferably 6 or more, and even more preferably 8 or more, and is preferably 20 or less, more preferably 16 or less, and even more preferably 12 or less. When the number of carbon atoms is set to the above-described lower limit value or more, the solubility in the semiconductor nanoparticle-containing composition tends to be enhanced, and when the number of carbon atoms is set to the above-described upper limit value or less, the efficiency of absorption of the excitation light with respect to the mass of the coloring matter (B3) present in the composition tends to be enhanced. The above-described upper limits and lower limits can be arbitrarily combined. For example, the number of carbon atoms is preferably 1 to 20, more preferably 3 to 20, even more preferably 6 to 16, and particularly preferably 8 to 12. When one or more of —CH₂— in the alkyl group is substituted with —O—, it is preferable that the number of carbon atoms of the alkyl group before the substitution is included in the above-described range.

Examples of the alkyl group include a methyl group, an ethyl group, an isopropyl group, an isobutyl group, a tert-butyl group, a 2-ethylhexyl group, and a (2-(2-methoxyethoxy)ethoxy)ethyl group. From the viewpoint of the solubility in the semiconductor nanoparticle-containing composition, an isobutyl group, a tert-butyl group, a 2-ethylhexyl group, and a (2-(2-methoxyethoxy)ethoxy)ethyl group are preferred, and a 2-ethylhexyl group and a (2-(2-methoxyethoxy)ethoxy)ethyl group are more preferred.

Examples of the substituent that the alkyl group may have include a hydroxyl group, a carboxyl group, an amino group, a sulfanyl group, a dialkylphosphino group having 2 to 12 carbon atoms, a dialkylphosphinyl group having 2 to 12 carbon atoms, and a halogen atom. From the viewpoint of enhancing the interaction between the coloring matter (B3) and the semiconductor nanoparticles (A), a sulfanyl group and a dialkylphosphinyl group having 2 to 12 carbon atoms are preferred.

Examples of the aryl group for R⁵ include a monovalent aromatic hydrocarbon ring group and a monovalent aromatic heterocyclic group.

The number of carbon atoms of the aryl group is not particularly limited; however, the number of carbon atoms is preferably 4 or more, and more preferably 6 or more, and is preferably 14 or less, and more preferably 10 or less. When the number of carbon atoms is set to the above-described lower limit value or more, the interaction between the coloring matter (B3) and the semiconductor nanoparticles (A) tends to be enhanced as the interaction between the coloring matter (B3) molecules is suppressed, and when the number of carbon atoms is set to the above-described upper limit value or less, the efficiency of absorption of the excitation light tends to be enhanced. The above-described upper limits and lower limits can be arbitrarily combined. For example, the number of carbon atoms is preferably 4 to 14, more preferably 4 to 10, and even more preferably 6 to 10.

The aromatic hydrocarbon ring in the aromatic hydrocarbon ring group may be a monocyclic ring or a fused ring.

Examples of the aromatic hydrocarbon ring group include a benzene ring, a naphthalene ring, an anthracene ring, a phenanthrene ring, a perylene ring, a tetracene ring, a pyrene ring, a benzopyrene ring, a chrysene ring, a triphenylene ring, an acenaphthene ring, a fluoranthene ring, and a fluorene ring, each of which has one free valence. From the viewpoint of the solubility in the semiconductor nanoparticle-containing composition, a benzene ring having one free valence and a naphthalene ring having one free valence are preferred, and a benzene ring having one free valence is more preferred.

The aromatic heterocyclic ring in the aromatic heterocyclic group may be a monocyclic ring or a fused ring.

Examples of the aromatic heterocyclic group include a furan ring, a benzofuran ring, a thiophene ring, a benzothiophene ring, a pyrrole ring, a pyrazole ring, an imidazole ring, an oxadiazole ring, an indole ring, a carbazole ring, a pyrroloimidazole ring, a pyrrolopyrazole ring, a pyrrolopyrrole ring, a thienopyrrole ring, a thienothiophene ring, a furopyrrole ring, a furofuran ring, a thienofuran ring, a benzisoxazole ring, a benzisothiazole ring, a benzimidazole ring, a pyridine ring, a pyrazine ring, a pyridazine ring, a pyrimidine ring, a triazine ring, a quinoline ring, an isoquinoline ring, a cinnoline ring, a quinoxaline ring, a phenanthridine ring, a perimidine ring, a quinazoline ring, a quinazolinone ring, and an azulene ring, each of which has one free valence. From the viewpoint of increasing the interaction between the coloring matter (B3) and the semiconductor nanoparticles (A), a thiophene ring having one free valence and a pyridine ring having one free valence are preferred.

Examples of the substituent that the aryl group may have include an alkyl group having 1 to 6 carbon atoms, an alkoxy group having 1 to 6 carbon atoms, an alkoxycarbonyl group having 2 to 7 carbon atoms, a hydroxyl group, a carboxyl group, an amino group, a sulfanyl group, a dialkylphosphino group having 2 to 12 carbon atoms, and a halogen atom. From the viewpoint of increasing the interaction between the coloring matter (B3) and the semiconductor nanoparticles (A), an amino group and a sulfanyl group are preferred.

R⁵ may be linked to any of R¹¹, R²¹, R³¹, and R⁴¹ to form a ring. In this case, examples of R⁵ include a carbonyl group (—CO—), a methylene group (—CH₂—), and an alkylidene methylene group (—C(═C(R⁵¹)₂)— (here, R⁵¹'s each independently represent a hydrogen atom or a hydrocarbon group having 2 to 6 carbon atoms)). A carbonyl group (—CO—) is preferred from the viewpoint of the ease of synthesis.

Regarding R⁵, a 2-ethylhexyl group and a (2-(2-sulfanylethoxy)ethoxy)ethyl group are preferred from the viewpoint of enhancing the efficiency of conversion of the excitation light, and a (2-(2-methoxyethoxy)ethoxy)ethyl group is preferred from the viewpoint of the solubility in the semiconductor nanoparticle-containing composition.

One or more of R¹¹, R²¹, R³¹, and R⁴¹ are each a group represented by the above-described General Formula [IIIa]; however, two or more are more preferred, three or more are even more preferred, and all of them are particularly preferred. When the number of the groups is set to the lower limit value or more, the efficiency of absorption of the excitation light tends to be enhanced.

Regarding the any substituent for R¹¹, R²¹, R³¹, and R⁴¹, the group other than the group represented by General Formula [IIIa] is not particularly limited as long as it is a substitutable monovalent group, and examples thereof include an alkyl group which may have a substituent, an aryl group which may have a substituent, an alkylcarbonyl group which may have a substituent, an arylcarbonyl group which may have a substituent, an alkylsulfonyl group which may have a substituent, an amide group which may have a substituent, a cyano group, and a halogen atom. Furthermore, R¹¹ and R²¹ may be linked to form a ring, and R³¹ and R⁴¹ may be linked to form a ring.

Examples of the alkyl group include a linear alkyl group, a branched alkyl group, a cyclic alkyl group, and a combination of these. From the viewpoint of the solubility in the semiconductor nanoparticle-containing composition, a branched alkyl group is preferred. Some of —CH₂— in the alkyl group may be substituted with —O—.

The number of carbon atoms of the alkyl group is not particularly limited; however, the number of carbon atoms is usually 1 or more, preferably 3 or more, and more preferably 6 or more, and is preferably 20 or less, and more preferably 12 or less. When the number of carbon atoms is set to the above-described lower limit value or more, the solubility in the semiconductor nanoparticle-containing composition tends to be enhanced, and when the number of carbon atoms is set to the above-described upper limit value or less, the efficiency of absorption of the excitation light tends to be enhanced. The above-described upper limits and lower limits can be arbitrarily combined. For example, the number of carbon atoms is preferably 1 to 20, more preferably 3 to 20, and even more preferably 6 to 12. When one or more of —CH₂— in the alkyl group is substituted with —O—, it is preferable that the number of carbon atoms of the alkyl group before the substitution is included in the above-described range.

Examples of the alkyl group include a methyl group, an ethyl group, an isopropyl group, an isobutyl group, a tert-butyl group, a 2-ethylhexyl group, and a (2-(2-methoxyethoxy)ethoxy)ethyl group. From the viewpoint of the solubility in the semiconductor nanoparticle-containing composition, an isobutyl group, a tert-butyl group, a 2-ethylhexyl group, and a (2-(2-methoxyethoxy)ethoxy)ethyl group are preferred, and a 2-ethylhexyl group and a (2-(2-methoxyethoxy)ethoxy)ethyl group are more preferred.

Examples of the substituent that the alkyl group may have include a hydroxyl group, a carboxyl group, an amino group, a sulfanyl group, a dialkylphosphino group having 2 to 12 carbon atoms, a dialkylphosphinyl group having 2 to 12 carbon atoms, and a halogen atom. From the viewpoint of enhancing the interaction between the coloring matter (B3) and the semiconductor nanoparticles (A), a sulfanyl group and a dialkylphosphinyl group having 2 to 12 carbon atoms are preferred. From the viewpoint of suppressing particle precipitation by a strong interaction between the coloring matter (B3) and the semiconductor nanoparticles (A), no substitution is preferred.

Regarding the aryl group, a monovalent aromatic hydrocarbon ring group and a monovalent aromatic heterocyclic group may be mentioned.

The number of carbon atoms of the aryl group is not particularly limited; however, the number of carbon atoms is preferably 4 or more, and more preferably 6 or more, and is preferably 14 or less, and more preferably 10 or less. When the number of carbon atoms is set to the above-described lower limit value or more, light resistance tends to be enhanced, and when the number of carbon atoms is set to the above-described upper limit value or less, the solubility in the semiconductor nanoparticle-containing composition tends to be enhanced. The above-described upper limits and lower limits can be arbitrarily combined. For example, the number of carbon atoms is preferably 4 to 14, more preferably 4 to 10, and even more preferably 6 to 10.

The aromatic hydrocarbon ring in the aromatic hydrocarbon ring group may be a monocyclic ring or a fused ring.

Examples of the aromatic hydrocarbon ring group include a benzene ring, a naphthalene ring, an anthracene ring, a phenanthrene ring, a perylene ring, a tetracene ring, a pyrene ring, a benzopyrene ring, a chrysene ring, a triphenylene ring, an acenaphthene ring, a fluoranthene ring, and a fluorene ring, each of which has one free valence. From the viewpoint of the solubility in the semiconductor nanoparticle-containing composition, a benzene ring having one free valence and a naphthalene ring having one free valence are preferred, and a benzene ring having one free valence is more preferred.

The aromatic heterocyclic ring in the aromatic heterocyclic group may be a monocyclic ring or a fused ring.

Examples of the aromatic heterocyclic group include a furan ring, a benzofuran ring, a thiophene ring, a benzothiophene ring, a pyrrole ring, a pyrazole ring, an imidazole ring, an oxadiazole ring, an indole ring, a carbazole ring, a pyrroloimidazole ring, a pyrrolopyrazole ring, a pyrrolopyrrole ring, a thienopyrrole ring, a thienothiophene ring, a furopyrrole ring, a furofuran ring, a thienofuran ring, a benzisoxazole ring, a benzisothiazole ring, a benzimidazole ring, a pyridine ring, a pyrazine ring, a pyridazine ring, a pyrimidine ring, a triazine ring, a quinoline ring, an isoquinoline ring, a cinnoline ring, a quinoxaline ring, a phenanthridine ring, a perimidine ring, a quinazoline ring, a quinazolinone ring, and an azulene ring, each of which has one free valence. From the viewpoint of increasing the interaction between the coloring matter (B3) and the semiconductor nanoparticles (A), a thiophene ring having one free valence and a pyridine ring having one free valence are preferred.

Examples of the substituent that the aryl group may have include an alkyl group having 1 to 6 carbon atoms, an alkoxy group having 1 to 6 carbon atoms, an alkoxycarbonyl group having 2 to 7 carbon atoms, a hydroxyl group, a carboxyl group, an amino group, a sulfanyl group, a dialkylphosphino group having 2 to 12 carbon atoms, a dialkylphosphinyl group having 2 to 12 carbon atoms, and a halogen atom. From the viewpoint of increasing the interaction between the coloring matter and the semiconductor nanoparticles, a sulfanyl group and a dialkylphosphinyl group having 2 to 12 carbon atoms are preferred.

Regarding the alkylcarbonyl group which may have a substituent, a group in which a carbonyl group is further bonded to the linking bond of the above-described alkyl group may be mentioned.

Regarding the arylcarbonyl group which may have a substituent, a group in which a carbonyl group is further bonded to the linking bond of the above-described aryl group may be mentioned.

Regarding the alkylsulfonyl group which may have a substituent, a group in which a sulfonyl group is further bonded to the linking bond of the above-described alkyl group may be mentioned.

Regarding the amide group which may have a substituent, —CO—N(R⁵²)₂ (here, R⁵²'s each independently represent a hydrogen atom or the above-described alkyl group) may be mentioned.

Examples of the halogen atom include a fluorine atom, a chlorine atom, a bromine atom, and an iodine atom. From the viewpoint of the light resistance of the coloring matter, a fluorine atom and a chlorine atom are preferred.

From the viewpoint of enhancing the efficiency of conversion of the excitation light, a 2-ethylhexyl group and a (2-(2-sulfanylethoxy)ethoxy)ethyl group are preferred. From the viewpoint of the solubility in the semiconductor nanoparticle-containing composition, a (2-(2-methoxyethoxy)ethoxy)ethyl group is preferred.

R¹¹ and R²¹ may be linked to form a ring. R³¹ and R⁴¹ may be linked to form a ring. Regarding a group in which R¹¹ and R²¹ are linked and a group in which R³¹ and R⁴¹ are linked in the case of forming a ring, for example, —CO—(NR⁶)—CO— (here, R⁶ represents a hydrogen atom or an alkyl group having 1 to 6 carbon atoms), an ethylene group (—CH₂—CH₂—), a trimethylene group (—CH₂—CH₂—CH₂—), and a phenylene group may be mentioned. From the viewpoint of the efficiency of absorption of the excitation light and the ease of synthesis, —CO—(NR⁶)—CO— is preferred.

(R¹², R¹³, R²², R²³, R³², R³³, R⁴², and R⁴³)

In the Formula [III], R¹², R¹³, R²², R²³, R³², R³³, R⁴² and R⁴³ each independently represent a hydrogen atom or any substituent.

The any substituent for R¹², R¹³, R²², R²³, R³², R³³, R⁴², and R⁴³ is not particularly limited as long as it is a substitutable monovalent group, and examples include an alkyl group which may have a substituent, an alkoxy group which may have a substituent, an alkylcarbonyl group which may have a substituent, an alkoxycarbonyl group which may have a substituent, an aryl group which may have a substituent, an aryloxy group which may have a substituent, an arylcarbonyl group which may have a substituent, an aryloxycarbonyl group which may have a substituent, a cyano group, and a halogen atom.

Examples of the alkyl group include a linear alkyl group, a branched alkyl group, a cyclic alkyl group, and a combination of these. From the viewpoint of the solubility in the semiconductor nanoparticle-containing composition and from the viewpoint of enhancing the efficiency of conversion of the excitation light, a branched alkyl group is preferred. Some of —CH₂— in the alkyl group may be substituted with —O—.

The number of carbon atoms of the alkyl group is not particularly limited; however, the number of carbon atoms is usually 1 or more, preferably 3 or more, and more preferably 6 or more, and is preferably 20 or less, and more preferably 12 or less. When the number of carbon atoms is set to the above-described lower limit value or more, the solubility in the semiconductor nanoparticle-containing composition tends to be enhanced, and when the number of carbon atoms is set to the above-described upper limit value or less, the efficiency of absorption of the excitation light tends to be enhanced. The above-described upper limits and lower limits can be arbitrarily combined. For example, the number of carbon atoms is preferably 1 to 20, more preferably 3 to 20, and even more preferably 6 to 12. When one or more of —CH₂— in the alkyl group is substituted with —O—, it is preferable that the number of carbon atoms of the alkyl group before the substitution is included in the above-described range.

Examples of the alkyl group include a methyl group, an ethyl group, an isopropyl group, an isobutyl group, a tert-butyl group, a 2-ethylhexyl group, and a (2-(2-methoxyethoxy)ethoxy)ethyl group. From the viewpoint of the solubility in the semiconductor nanoparticle-containing composition, a tert-butyl group, a 2-ethylhexyl group, and a (2-(2-methoxyethoxy)ethoxy)ethyl group are preferred, and a 2-ethylhexyl group and a (2-(2-methoxyethoxy)ethoxy)ethyl group are more preferred.

Examples of the substituent that the alkyl group may have include a hydroxyl group, a carboxyl group, an amino group, a sulfanyl group, a dialkylphosphino group having 2 to 12 carbon atoms, a dialkylphosphinyl group having 2 to 12 carbon atoms, and a halogen atom. From the viewpoint of enhancing the interaction between the coloring matter (B3) and the semiconductor nanoparticles (A), a sulfanyl group and a dialkylphosphinyl group having 2 to 12 carbon atoms are preferred. From the viewpoint of suppressing particle precipitation by a strong interaction between the coloring matter (B3) and the semiconductor nanoparticles (A), a hydrogen atom is preferred.

Regarding the alkoxy group, a group in which an O atom is further bonded to the linking bond of the above-described alkyl group may be mentioned.

Regarding the alkylcarbonyl group, a group in which a carbonyl group is further bonded to the linking bond of the above-described alkyl group may be mentioned.

Regarding the alkoxycarbonyl group, a group in which a carbonyl group is further bonded to the linking bond of the above-described alkoxy group may be mentioned.

Regarding the aryl group, a monovalent aromatic hydrocarbon ring group and a monovalent aromatic heterocyclic group may be mentioned.

The number of carbon atoms of the aryl group is not particularly limited; however, the number of carbon atoms is preferably 4 or more, and more preferably 6 or more, and is preferably 14 or less, and more preferably 10 or less. When the number of carbon atoms is set to the above-described lower limit value or more, light resistance tends to be enhanced, and when the number of carbon atoms is set to the above-described upper limit value or less, the solubility in the semiconductor nanoparticle-containing composition tends to be enhanced. The above-described upper limits and lower limits can be arbitrarily combined. For example, the number of carbon atoms is preferably 4 to 14, more preferably 4 to 10, and even more preferably 6 to 10.

The aromatic hydrocarbon ring in the aromatic hydrocarbon ring group may be a monocyclic ring or a fused ring.

Examples of the aromatic hydrocarbon ring group include a benzene ring, a naphthalene ring, an anthracene ring, a phenanthrene ring, a perylene ring, a tetracene ring, a pyrene ring, a benzopyrene ring, a chrysene ring, a triphenylene ring, an acenaphthene ring, a fluoranthene ring, and a fluorene ring, each of which has one free valence. From the viewpoint of the solubility in the semiconductor nanoparticle-containing composition, a benzene ring having one free valence and a naphthalene ring having one free valence are preferred, and a benzene ring having one free valence is more preferred.

The aromatic heterocyclic ring in the aromatic heterocyclic group may be a monocyclic ring or a fused ring.

Examples of the aromatic heterocyclic group include a furan ring, a benzofuran ring, a thiophene ring, a benzothiophene ring, a pyrrole ring, a pyrazole ring, an imidazole ring, an oxadiazole ring, an indole ring, a carbazole ring, a pyrroloimidazole ring, a pyrrolopyrazole ring, a pyrrolopyrrole ring, a thienopyrrole ring, a thienothiophene ring, a furopyrrole ring, a furofuran ring, a thienofuran ring, a benzisoxazole ring, a benzisothiazole ring, a benzimidazole ring, a pyridine ring, a pyrazine ring, a pyridazine ring, a pyrimidine ring, a triazine ring, a quinoline ring, an isoquinoline ring, a cinnoline ring, a quinoxaline ring, a phenanthridine ring, a perimidine ring, a quinazoline ring, a quinazolinone ring, and an azulene ring, each of which has one free valence. From the viewpoint of increasing the interaction between the coloring matter (B3) and the semiconductor nanoparticles (A), a thiophene ring having one free valence and a pyridine ring having one free valence are preferred.

Examples of the substituent that the aryl group may have include an alkyl group having 1 to 6 carbon atoms, an alkoxy group having 1 to 6 carbon atoms, an alkoxycarbonyl group having 2 to 7 carbon atoms, a hydroxyl group, a carboxyl group, an amino group, a sulfanyl group, a dialkylphosphino group having 2 to 12 carbon atoms, a dialkylphosphinyl group having 2 to 12 carbon atoms, and a halogen atom. From the viewpoint of enhancing the interaction between the coloring matter (B3) and the semiconductor nanoparticles (A), a sulfanyl group and a dialkylphosphinyl group having 2 to 12 carbon atoms are preferred.

Regarding the aryloxy group, a group in which an O atom is further bonded to the linking bond of the aryl group may be mentioned.

Regarding the arylcarbonyl group, a group in which a carbonyl group is further bonded to the linking bond of the above-described aryl group may be mentioned.

Regarding the aryloxycarbonyl group, a group in which a carbonyl group is further bonded to the linking bond of the above-described aryloxy group may be mentioned.

Examples of the halogen atom include a fluorine atom, a chlorine atom, a bromine atom, and an iodine atom. From the viewpoint of the light resistance of the coloring matter, a fluorine atom and a chlorine atom are preferred.

Regarding R¹², R¹³, R²², R²³, R³², R³³, R⁴², and R⁴³, from the viewpoint of the solubility in the semiconductor nanoparticle-containing composition, a 2-ethylhexyl group and a (2-(2-methoxyethoxy)ethoxy)ethyl group are preferred. From the viewpoint of the ease of synthesis, a hydrogen atom is preferred.

Specific examples of the coloring matter (B3) are given below.

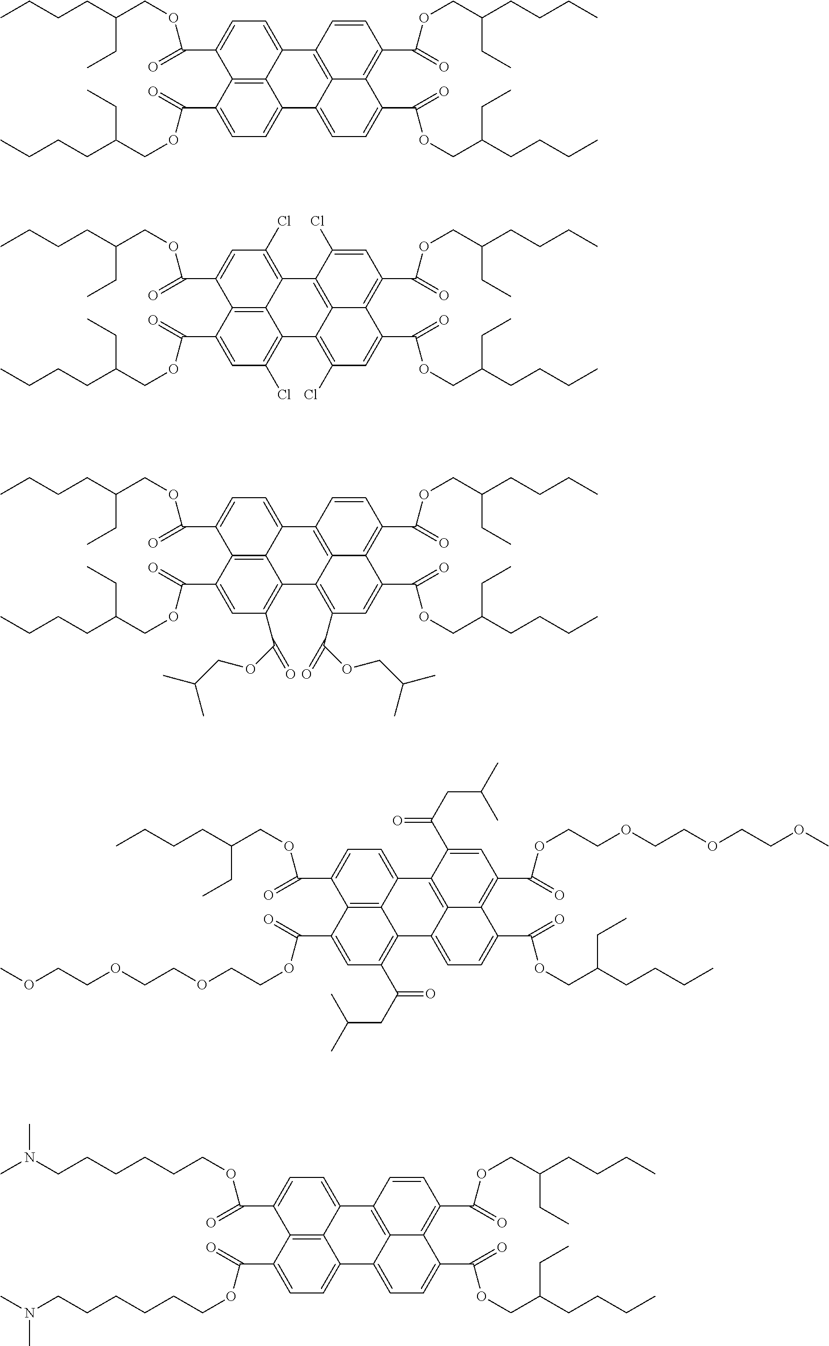

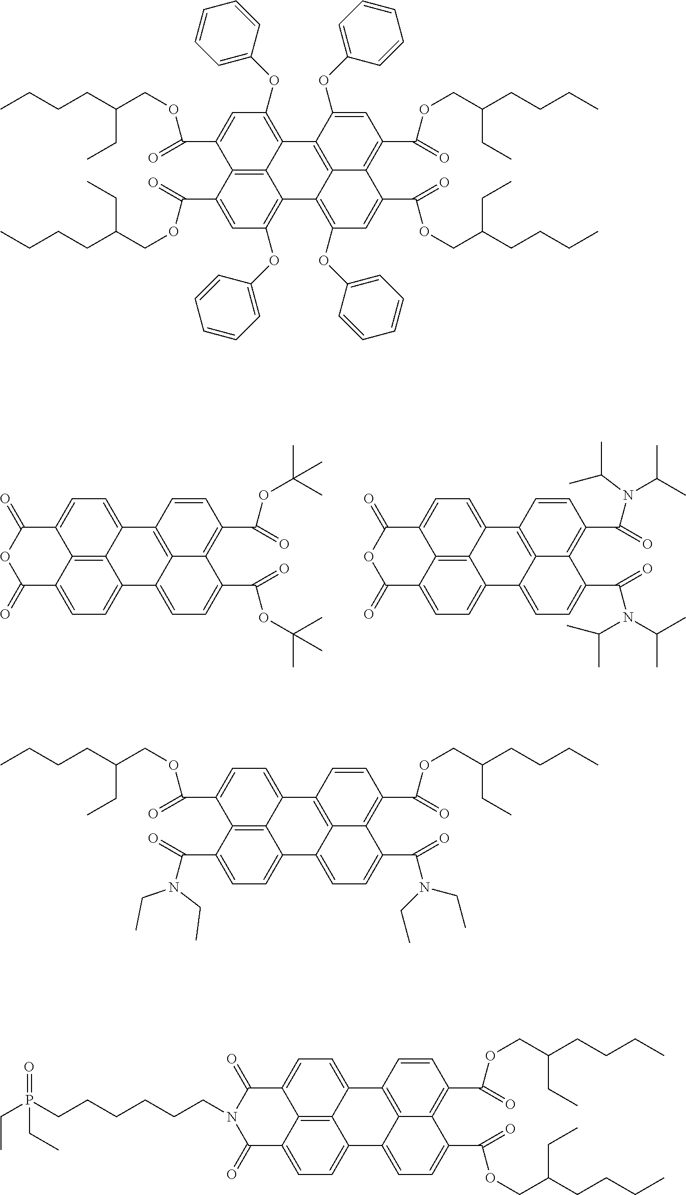

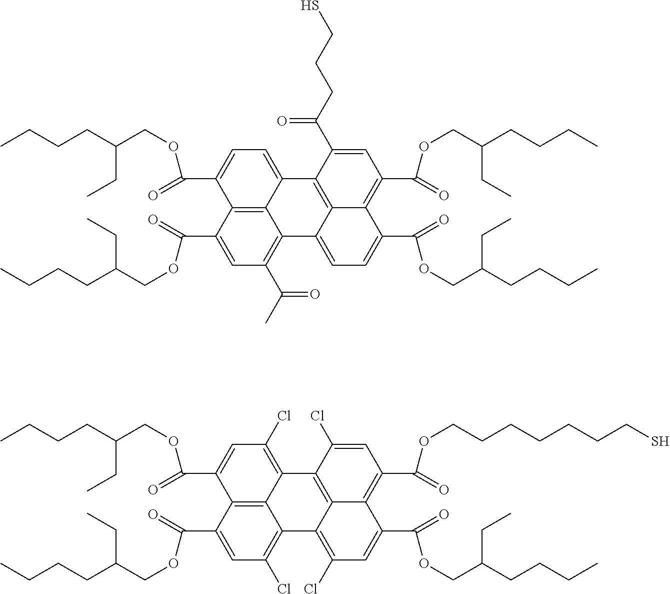

The method for producing the coloring matter (B3) is not particularly limited; however, for example, the coloring matter (B3) can be produced by the method described in Chem. Eur. J., 2007, 13, 1746-1753.

The maximum emission wavelength of the fluorescence emitted by the coloring matter (B3) is not particularly limited; however, the maximum emission wavelength is preferably 450 nm or more, more preferably 455 nm or more, even more preferably 460 nm or more, and particularly preferably 465 nm or more, and is preferably 600 nm or less, preferably 560 nm or less, more preferably 540 nm or less, and particularly preferably 500 nm or less.

When the maximum emission wavelength is set to the above-described lower limit value or more, semiconductor nanoparticles that could not be excited by blue light of an excitation source can be excited, which tends to lead to an increase in the luminescence intensity of the semiconductor nanoparticles, and when the maximum emission wavelength is set to the above-described upper limit value or less, the emission spectrum of the semiconductor nanoparticles and the emission spectrum of the coloring matter (B3) can be separated, so that the energy transferred from the coloring matter (B3) to the semiconductor nanoparticles becomes large, and when the semiconductor nanoparticle-containing composition is used for displays, there is a tendency that absorption of light emitted from the coloring matter (B3) in an unnecessary wavelength region by a color filter provided separately from the pixel part is facilitated. For example, when the maximum emission wavelength of the fluorescence emitted by the coloring matter (B3) exists in the vicinity of 460 to 540 nm, there is a tendency that the luminescence intensities of the green light-emitting semiconductor nanoparticles and the red light-emitting semiconductor nanoparticles can be increased, which is preferable.

The above-described upper limits and lower limits can be arbitrarily combined. For example, the maximum emission wavelength is preferably 450 to 600 nm, more preferably 455 to 560 nm, even more preferably 460 to 540 nm, and particularly preferably 465 to 500 nm.

The method for measuring the maximum emission wavelength is not particularly limited; however, for example, the maximum emission wavelength may be read from an emission spectrum measured with a spectrofluorophotometer by using a solution of the coloring matter (B3) or a film including the coloring matter (B3), and by using light having a wavelength of 445 nm as an excitation light source.

When the semiconductor nanoparticle-containing composition of the present invention includes the coloring matter (B3), the content proportion of the coloring matter (B3) in the semiconductor nanoparticle-containing composition is not particularly limited; however, the content proportion is preferably 0.001% by mass or more, more preferably 0.005% by mass or more, even more preferably 0.01% by mass or more, still more preferably 0.05% by mass or more, even more preferably 0.1% by mass or more, particularly preferably 0.5% by mass or more, and most preferably 1% by mass or more, and is preferably 30% by mass or less, more preferably 20% by mass or less, even more preferably 10% by mass or less, and particularly preferably 5% by mass or less, all in the total solid content of the semiconductor nanoparticle-containing composition.

When the content proportion is set to the above-described lower limit value or more, there is a tendency that the coloring matter sufficiently absorbs the emitted light, the amount of energy transfer from the coloring matter to the semiconductor nanoparticles is increased, and the luminescence intensity of the semiconductor nanoparticles is increased. Furthermore, when the content proportion is set to the above-described upper limit value or less, there is a tendency that the concentration quenching of the coloring matter is suppressed, the luminescence intensity of the semiconductor nanoparticles is increased as energy is efficiently transferred from the coloring matter to the semiconductor nanoparticles, and a wavelength conversion layer having sufficient hardness is obtained by including components other than the semiconductor nanoparticles and the coloring matter.

The above-described upper limits and lower limits can be arbitrarily combined. For example, the content proportion is preferably 0.001% to 30% by mass, more preferably 0.005% to 30% by mass, even more preferably 0.01% to 20% by mass, still more preferably 0.05% to 20% by mass, even more preferably 0.1% to 10% by mass, particularly preferably 0.5% to 10% by mass, and most preferably 1% to 5% by mass.

[1-2-4] Coloring Matter (B4)

The coloring matter (B4) is a coloring matter having a coumarin skeleton and having a total degree of branching of 3 or more.

The total degree of branching is defined as a value obtained for the atoms in the coloring matter structure by assigning a degree of branching of 1 to a trisubstituted carbon atom (here, representing a carbon atom to which three substituents and one hydrogen atom are bonded), a trisubstituted nitrogen atom, a phosphorus atom in a trisubstituted phosphanetriyl group, and a phosphorus atom in a trisubstituted phosphoryl group; a degree of branching of 2 to a tetrasubstituted carbon atom, a tetrasubstituted nitrogen atom, and a tetrasubstituted silicon atom; and a value of 0 to the other atoms, and summing the values.

The total degree of branching in the coloring matter (B4) is preferably 3 or more, and more preferably 4 or more, and is preferably 10 or less, and more preferably 8 or less. When the total degree of branching is set to the above-described lower limit or more, the solubility in an ink and the fluorescence quantum yield caused by suppressing concentration quenching tend to be enhanced, and when the total degree of branching is set to the above-described upper limit or less, there is a tendency that the difficulties of industrial purification due to a decrease in the melting point can be suppressed.

The above-described upper limits and lower limits can be arbitrarily combined. For example, the total degree of branching is preferably 3 to 10, more preferably 3 to 8, and even more preferably 4 to 8.

With regard to the coloring matter (B4), the coloring matter (B4) and the semiconductor nanoparticles (A) attract each other due to the interaction caused by the lone electron pair on the oxygen atom at the 1-position and the lone electron pair on the oxygen atom of the carbonyl group at the 2-position of the 2H-1-benzopyran-2-one skeleton that constitutes the coumarin skeleton, and as the coloring matter (B4) sufficiently approaches the semiconductor nanoparticles (A), the efficiency of the excited energy of the coloring matter (B4) transferring to the semiconductor nanoparticles (A) by Forster-type energy transfer is high, and the luminescence intensity of the semiconductor nanoparticles (A) is increased.

The coloring matter (B4) is not particularly limited as long as it has a total degree of branching of 3 or more and has a coumarin skeleton; however, from the viewpoint of having high solubility in various solvents and in the semiconductor nanoparticle-containing composition, having a high gram absorption coefficient, being less likely to undergo concentration quenching, and having an increased quantum yield of fluorescence, it is preferable that the coloring matter (B4) is a coloring matter represented by General Formula [IV-1]:

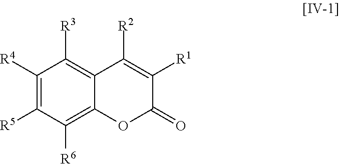

in General Formula [IV-1], R¹, R², R³, R⁴, and R⁶ each independently represent a hydrogen atom or any substituent,

R⁵ represents a hydrogen atom, N(R⁷)₂, or OR⁷, when R⁵ is N(R⁷)₂, R⁷'s may be linked to form a ring,

R⁷ represents a hydrogen atom or any substituent, and

two or more selected from the group consisting of R⁴, R⁵, and R⁶ may be linked to form a ring.

(R¹, R², R³, R⁴, and R⁶)

In Formula [IV-1], R¹, R², R³, R⁴, and R⁶ each independently represent a hydrogen atom or any substituent.

The any substituent for R¹, R², R³, R⁴, and R⁶ are not particularly limited as long as they are substitutable monovalent groups, and examples include an alkyl group which may have a substituent, an alkylcarbonyl group which may have a substituent, an alkoxy group which may have a substituent, an alkoxycarbonyl group which may have a substituent, an alkenyl group which may have a substituent, an aryl group which may have a substituent, an aryloxy group which may have a substituent, a cyano group, a nitro group, a halogen atom, a hydroxyl group, and an amino group.

Examples of the alkyl group for R¹, R², R³, R⁴, and R⁶ include a linear alkyl group, a branched alkyl group, a cyclic alkyl group, and a combination of these. From the viewpoint of suppressing the formation of aggregates caused by steric hindrance, a branched alkyl group is preferred. Some of —CH₂— in the alkyl group may be substituted with —O—.

The number of carbon atoms of the alkyl group for R¹, R², R³, R⁴, and R⁶ is not particularly limited; however, the number of carbon atoms is usually 1 or more, and preferably 2 or more, and is preferably 12 or less, more preferably 8 or less, even more preferably 5 or less, and particularly preferably 3 or less. When the number of carbon atoms is set to the above-described lower limit value or more, the solubility in the semiconductor nanoparticle-containing composition tends to be enhanced, and when the number of carbon atoms is set to the above-described upper limit value or less, the efficiency of absorption of the excitation light with respect to the mass of the coloring matter (B4) present in the semiconductor nanoparticle-containing composition tends to be enhanced. The above-described upper limits and lower limits can be arbitrarily combined. For example, the number of carbon atoms is preferably 1 to 12, more preferably 1 to 8, even more preferably 1 to 5, particularly preferably 1 to 3, and most preferably 2 to 3. When one or more of —CH₂— in the alkyl group is substituted with —O—, it is preferable that the number of carbon atoms of the alkyl group before the substitution is included in the above-described range.

Examples of the alkyl group include a methyl group, an ethyl group, an isopropyl group, an isobutyl group, a tert-butyl group, a 2-ethylhexyl group, and a (2-hydroxyethoxy)ethyl group. From the viewpoint that the efficiency of absorption of the excitation light is high, a methyl group and an ethyl group are preferred, and a methyl group is more preferred.

Examples of the substituent that the alkyl group may have include a hydroxyl group, a carboxyl group, an amino group, a sulfanyl group, a dialkylphosphino group having 2 to 12 carbon atoms, and a halogen atom. From the viewpoint of the efficiency of absorption of the excitation light, a fluorine atom is preferred.

Regarding the alkylcarbonyl group for R¹, R², R³, R⁴, and R⁶, a group in which a carbonyl group is further bonded to the linking bond of the above-described alkyl group may be mentioned.

Regarding the alkoxy group for R¹, R², R³, R⁴, and R⁶, a group in which an O atom is further bonded to the linking bond of the above-described alkyl group may be mentioned.

Examples of the alkoxy group include a methoxy group, an ethoxy group, a (2-hydroxyethoxy)ethoxy group, and a 2-[2-(2-hydroxyethoxy)ethoxy] ethoxy group. From the viewpoint that the efficiency of absorption of the excitation light is high, a methoxy group and an ethoxy group are preferred.

Regarding the alkoxycarbonyl group for R¹, R², R³, R⁴, and R⁶, a group in which a carbonyl group is bonded to the linking bond of the above-described alkoxy group may be mentioned.

Examples of the alkoxycarbonyl group include a methoxycarbonyl group and an ethoxycarbonyl group.

Examples of the alkenyl group for R¹, R², R³, R⁴, and R⁶ include a linear alkenyl group, a branched alkenyl group, a cyclic alkenyl group, and a combination of these.

The number of carbon atoms of the alkenyl group for R¹, R², R³, R⁴, and R⁶ is not particularly limited; however, the number of carbon atoms is usually 2 or more, and preferably 4 or more, and is preferably 12 or less, and more preferably 10 or less. When the number of carbon atoms is set to the above-described lower limit value or more, the solubility in the semiconductor nanoparticle-containing composition tends to be enhanced, and when the number of carbon atoms is set to the above-described upper limit value or less, the efficiency of absorption of the excitation light with respect to the mass of the coloring matter (B1) present in the semiconductor nanoparticle-containing composition tends to be enhanced. The above-described upper limits and lower limits can be arbitrarily combined. For example, the number of carbon atoms is preferably 2 to 12, more preferably 2 to 10, and even more preferably 4 to 10.

Examples of the alkenyl group include an ethenyl group, a 1-propenyl group, a 2-propenyl group, a 1-butenyl group, a 2-pentenyl group, and a 1,3-butadienyl group. From the viewpoint that the efficiency of absorption of the excitation light is high, an ethenyl group and a 1,3-butadienyl group are preferred, and an ethenyl group is more preferred.

Examples of the substituent that the alkenyl group may have include a hydroxyl group, a carboxyl group, a cyano group, an amino group, a sulfanyl group, an alkyl group having 1 to 12 carbon atoms, and a dialkylphosphino group having 2 to 12 carbon atoms, and a halogen atom. From the viewpoint of the efficiency of absorption of the excitation light, a cyano group and a carboxyl group are preferred.

Examples of the aryl group for R¹, R², R³, R⁴, and R⁶ include a monovalent aromatic hydrocarbon ring group and a monovalent aromatic heterocyclic group.

The number of carbon atoms of the aryl group is not particularly limited; however, the number of carbon atoms is preferably 4 or more, and more preferably 6 or more, and is preferably 12 or less, and more preferably 10 or less. When the number of carbon atoms is set to the above-described lower limit value or more, the solubility in the semiconductor nanoparticle-containing composition tends to be enhanced, and when the number of carbon atoms is set to the above-described upper limit value or less, the efficiency of absorption of the excitation light with respect to the mass of the coloring matter (B1) present in the semiconductor nanoparticle-containing composition tends to be enhanced. The above-described upper limits and lower limits can be arbitrarily combined. For example, the number of carbon atoms is preferably 4 to 12, more preferably 4 to 10, and even more preferably 6 to 10.

The aromatic hydrocarbon ring in the aromatic hydrocarbon ring group may be a monocyclic ring or a fused ring.

Examples of the aromatic hydrocarbon ring group include a benzene ring, a naphthalene ring, an anthracene ring, a phenanthrene ring, a perylene ring, a tetracene ring, a pyrene ring, a benzopyrene ring, a chrysene ring, a triphenylene ring, an acenaphthene ring, a fluoranthene ring, and a fluorene ring, each of which has one free valence. From the viewpoint of having high solubility in the semiconductor nanoparticle-containing composition, a benzene ring having one free valence and a naphthalene ring having one free valence are preferred, and a benzene ring having one free valence is more preferred.

The aromatic heterocyclic ring in the aromatic heterocyclic group may be a monocyclic ring or a fused ring.

Examples of the aromatic heterocyclic group include a furan ring, a benzofuran ring, a thiophene ring, a benzothiophene ring, a pyrrole ring, a pyrazole ring, an imidazole ring, an oxadiazole ring, an indole ring, a carbazole ring, a pyrroloimidazole ring, a pyrrolopyrazole ring, a pyrrolopyrrole ring, a thienopyrrole ring, a thienothiophene ring, a furopyrrole ring, a furofuran ring, a thienofuran ring, a benzoxazole ring, a benzothiazole ring, a benzisoxazole ring, a benzisothiazole ring, a benzimidazole ring, a pyridine ring, a pyrazine ring, a pyridazine ring, a pyrimidine ring, a triazine ring, a quinoline ring, an isoquinoline ring, a cinnoline ring, a quinoxaline ring, a phenanthridine ring, a perimidine ring, a quinazoline ring, a quinazolinone ring, and an azulene ring, each of which has one free valence. From the viewpoint of having high solubility in the semiconductor nanoparticle-containing composition, a pyridine ring, a furan ring, and a thiophene ring, each of which has one free valence, are preferred. From the viewpoint that the efficiency of absorption of the excitation light is high, a pyrazole ring, an imidazole ring, a benzothiazole ring, and a benzimidazole ring, each of which has one free valence, are preferred.

Examples of the substituent that the aryl group may have include an alkyl group having 1 to 6 carbon atoms, an alkoxy group having 1 to 6 carbon atoms, an alkoxycarbonyl group having 2 to 7 carbon atoms, a hydroxyl group, a carboxyl group, an amino group, a sulfanyl group, a dialkylphosphino group having 2 to 12 carbon atoms, a nitro group, a cyano group, and a halogen atom. From the viewpoint of the efficiency of absorption of the excitation light, a methyl group, a methoxycarbonyl group, a cyano group, and a carboxyl group are preferred.

Regarding the aryloxy group for R¹, R², R³, R⁴, and R⁶, a group in which an O atom is further bonded to the linking bond of the above-described aryl group may be mentioned. Specific examples include a phenoxy group and a 2-thienyloxy group.

Examples of the halogen atom for R¹, R², R³, R⁴, and R⁶ include a fluorine atom, a chlorine atom, a bromine atom, and an iodine atom. From the viewpoint of durability of the coloring matter (B4), a fluorine atom and a chlorine atom are preferred.

Regarding R², R³, R⁴, and R⁶, from the viewpoint of the efficiency of absorption of the excitation light, a methyl group, a cyano group, a trifluoromethyl group, a nitro group, an amino group, and a carboxyl group are preferred, and a cyano group and a trifluoromethyl group are more preferred.

From the viewpoint that the coloring matter (B4) has a structure exhibiting a strong emission spectrum, it is preferable that R¹ is a group represented by General Formula [IV-1a]:

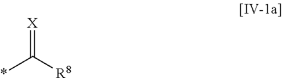

in General Formula [IV-1a], X represents an oxygen atom, a sulfur atom, or NR⁹,

R⁸ represents a hydrogen atom or any substituent,

R⁹ represents a hydrogen atom or an alkyl group,

when X is NR⁹, R⁹ and R⁸ may be linked to form a ring, and

* represents a linking bond.

(X)

In Formula [IV-1a], X represents an oxygen atom, a sulfur atom, or NR⁹. Among these, since there is a tendency that the fluorescence intensity increases when the group represented by the Formula [IV-1a] attracts more electrons from the coumarin skeleton, from the viewpoint of adopting a group including an atom having high electronegativity, an oxygen atom or NR⁹ is preferred.

R⁹ represents a hydrogen atom or an alkyl group.

Examples of the alkyl group for R⁹ include a linear alkyl group, a branched alkyl group, a cyclic alkyl group, and a combination of these. A cyclic alkyl group is preferred from the viewpoint of increasing the durability of the coloring matter (B4). Some of —CH₂— in the alkyl group may be substituted with —O—.

The number of carbon atoms of the alkyl group is not particularly limited; however, the number of carbon atoms is usually 1 or more, and preferably 2 or more, and is preferably 12 or less, and more preferably 8 or less. When the number of carbon atoms is set to the above-described lower limit value or more, the solubility in the semiconductor nanoparticle-containing composition tends to be enhanced, and when the number of carbon atoms is set to the above-described upper limit value or less, the efficiency of absorption of the excitation light with respect to the mass of the coloring matter (B4) present in the semiconductor nanoparticle-containing composition tends to be enhanced. The above-described upper limits and lower limits can be arbitrarily combined. For example, the number of carbon atoms is preferably 1 to 12, more preferably 1 to 8, and even more preferably 2 to 8. When one or more of —CH₂— in the alkyl group is substituted with —O—, it is preferable that the number of carbon atoms of the alkyl group before the substitution is included in the above-described range.

Examples of the alkyl group include a methyl group, an ethyl group, an isopropyl group, an isobutyl group, a tert-butyl group, a 2-ethylhexyl group, and a (2-hydroxyethoxy)ethyl group. From the viewpoint of having high solubility in the semiconductor nanoparticle-containing composition, an isopropyl group, an isobutyl group, and a 2-ethylhexyl group are preferred, and a 2-ethylhexyl group is more preferred.

(R⁸)

In Formula [IV-1a], R⁸ represents a hydrogen atom or any substituent.

The any substituent for R⁸ is not particularly limited as long as it is a substitutable monovalent group, and examples include an alkyl group which may have a substituent, an alkoxy group which may have a substituent, an aryl group which may have a substituent, an aryloxy group which may have a substituent, a sulfanyl group, an alkylsulfanyl group which may have a substituent, an arylsulfanyl group which may have a substituent, a hydroxyl group, and an amino group.

Examples of the alkyl group for R⁸ include a linear alkyl group, a branched alkyl group, a cyclic alkyl group, and a combination of these. Some of —CH₂— in the alkyl group may be substituted with —O—.

The number of carbon atoms of the alkyl group is not particularly limited; however, the number of carbon atoms is usually 1 or more, and preferably 2 or more, and is preferably 12 or less, and more preferably 8 or less. When the number of carbon atoms is set to the above-described lower limit value or more, the solubility in the semiconductor nanoparticle-containing composition tends to be enhanced, and when the number of carbon atoms is set to the above-described upper limit value or less, the efficiency of absorption of the excitation light with respect to the mass of the coloring matter (B4) present in the semiconductor nanoparticle-containing composition tends to be enhanced. The above-described upper limits and lower limits can be arbitrarily combined. For example, the number of carbon atoms is preferably 1 to 12, more preferably 1 to 8, and even more preferably 2 to 8. When one or more of —CH₂— in the alkyl group is substituted with —O—, it is preferable that the number of carbon atoms of the alkyl group before the substitution is included in the above-described range.

Examples of the alkyl group include a methyl group, an ethyl group, an isopropyl group, an isobutyl group, a tert-butyl group, a 2-ethylhexyl group, and a (2-hydroxyethoxy)ethyl group. From the viewpoint that the efficiency of absorption of the excitation light is high, a methyl group and an ethyl group are preferred, and a methyl group is more preferred.

Examples of the substituent that the alkyl group may have include a hydroxyl group, a carboxyl group, an amino group, a sulfanyl group, a dialkylphosphino group having 2 to 12 carbon atoms, and a halogen atom. From the viewpoint of having high solubility in the semiconductor nanoparticle-containing composition, a hydroxyl group and a carboxyl group are preferred.

Regarding the alkoxy group for R⁸, a group in which an O atom is further bonded to the linking bond of the above-described alkyl group may be mentioned.

Examples of the alkoxy group include a methoxy group, an ethoxy group, a (2-hydroxyethoxy)ethoxy group, and a 2-[2-(2-hydroxyethoxy)ethoxy]ethoxy group. From the viewpoint that the efficiency of absorption of the excitation light is high, a methoxy group and an ethoxy group are preferred.

Examples of the aryl group for R⁸ include a monovalent aromatic hydrocarbon ring group and a monovalent aromatic heterocyclic group.

The number of carbon atoms of the aryl group is not particularly limited; however, the number of carbon atoms is preferably 4 or more, and more preferably 6 or more, and is preferably 12 or less, and more preferably 10 or less. When the number of carbon atoms is set to the above-described lower limit value or more, the solubility in the semiconductor nanoparticle-containing composition tends to be enhanced, and when the number of carbon atoms is set to the above-described upper limit value or less, the efficiency of absorption of the excitation light with respect to the mass of the coloring matter (B4) present in the semiconductor nanoparticle-containing composition tends to be enhanced. The above-described upper limits and lower limits can be arbitrarily combined. For example, the number of carbon atoms is preferably 4 to 12, more preferably 4 to 10, and even more preferably 6 to 10.

The aromatic hydrocarbon ring in the aromatic hydrocarbon ring group may be a monocyclic ring or a fused ring.

Examples of the aromatic hydrocarbon ring group include a benzene ring, a naphthalene ring, an anthracene ring, a phenanthrene ring, a perylene ring, a tetracene ring, a pyrene ring, a benzopyrene ring, a chrysene ring, a triphenylene ring, an acenaphthene ring, a fluoranthene ring, and a fluorene ring, each of which has one free valence. From the viewpoint of having high solubility in the semiconductor nanoparticle-containing composition, a benzene ring having one free valence and a naphthalene ring having one free valence are preferred, and a benzene ring having one free valence is more preferred.

The aromatic heterocyclic ring in the aromatic heterocyclic group may be a monocyclic ring or a fused ring.

Examples of the aromatic heterocyclic group include a furan ring, a benzofuran ring, a thiophene ring, a benzothiophene ring, a pyrrole ring, a pyrazole ring, an imidazole ring, an oxadiazole ring, an indole ring, a carbazole ring, a pyrroloimidazole ring, a pyrrolopyrazole ring, a pyrrolopyrrole ring, a thienopyrrole ring, a thienothiophene ring, a furopyrrole ring, a furofuran ring, a thienofuran ring, a benzoxazole ring, a benzothiazole ring, a benzisoxazole ring, a benzisothiazole ring, a benzimidazole ring, a pyridine ring, a pyrazine ring, a pyridazine ring, a pyrimidine ring, a triazine ring, a quinoline ring, an isoquinoline ring, a cinnoline ring, a quinoxaline ring, a phenanthridine ring, a perimidine ring, a quinazoline ring, a quinazolinone ring, and an azulene ring, each of which has one free valence. From the viewpoint of having high solubility in the semiconductor nanoparticle-containing composition, a pyridine ring having one free valence and a thiophene ring having one free valence are preferred.

Examples of the substituent that the aryl group may have include an alkyl group having 1 to 6 carbon atoms, an alkoxy group having 1 to 6 carbon atoms, an alkoxycarbonyl group having 2 to 7 carbon atoms, a hydroxyl group, a carboxyl group, an amino group, a sulfanyl group, a dialkylphosphino group having 2 to 12 carbon atoms, a nitro group, a cyano group, and a halogen atom. From the viewpoint of the efficiency of absorption of the excitation light, a methyl group and a methoxycarbonyl group are preferred.

Regarding the aryloxy group for R⁸, a group in which an O atom is further bonded to the linking bond of the above-described aryl group may be mentioned. Specific examples include a phenoxy group and a 2-thienyloxy group.

Regarding the alkylsulfanyl group for R⁸, a group in which a sulfur atom is further bonded to the linking bond of the above-described alkyl group may be mentioned. Specific examples include a methylsulfanyl group, an ethylsulfanyl group, a butylsulfanyl group, and a 2-ethylhexylsulfanyl group.

Regarding the arylsulfanyl group for R⁸, a group in which a sulfur atom is further bonded to the linking bond of the above-described aryl group may be mentioned. Specific examples include a phenylsulfanyl group, a 2-pyridylsulfanyl group, and a 2-imidazolidyl group.

When X is NR⁹, R⁹ and R⁸ may be linked to form a ring. For example, any substituent as R⁸ and a hydrogen atom as R⁹ can be linked to form a ring, and in this case, R⁹ is a single bond.

The ring obtainable when R⁹ and R⁸ are linked to form a ring may be an aliphatic ring or an aromatic ring; however, from the viewpoint of durability of the coloring matter (B4), it is preferable that the ring is an aromatic ring. Examples of the ring formed by linking R⁹ and R⁸ are shown below.

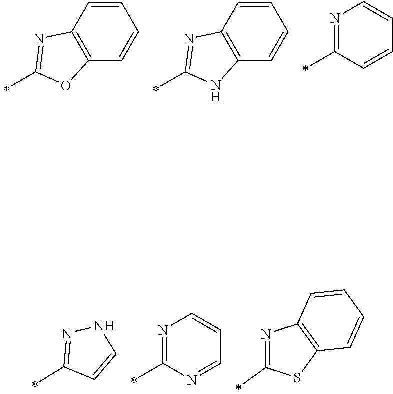

Among these, from the viewpoint of the efficiency of absorption of the excitation light, R⁸ is preferably a methyl group.

(R⁵)

In Formula [IV-1], R⁵ represents a hydrogen atom, N(R⁷)₂, or OR⁷. When R⁵ is N(R⁷)₂, R⁷'s may be linked to form a ring.

Among these, N(R⁷)₂ is preferred from the viewpoint that there is a tendency that the electron-donating property is high and the fluorescence intensity increases.

Here, R⁷ represents a hydrogen atom or any substituent.

Examples of the any substituent for R⁷ include an alkyl group which may have a substituent, an aryl group which may have a substituent, an alkylcarbonyl group which may have a substituent, an arylcarbonyl group which may have a substituent, an alkylsulfonyl group which may have a substituent, and an arylsulfonyl group which may have a substituent.

Examples of the alkyl group for R⁷ include a linear alkyl group, a branched alkyl group, a cyclic alkyl group, and a combination of these. From the viewpoint of the efficiency of absorption of the excitation light, a linear alkyl group is preferred. Some of —CH₂— in the alkyl group may be substituted with —O—.

The number of carbon atoms of the alkyl group is not particularly limited; however, the number of carbon atoms is usually 1 or more, and preferably 2 or more, and is preferably 12 or less, and more preferably 8 or less. When the number of carbon atoms is set to the above-described lower limit value or more, the solubility in the semiconductor nanoparticle-containing composition tends to be enhanced, and when the number of carbon atoms is set to the above-described upper limit value or less, the efficiency of absorption of the excitation light with respect to the mass of the coloring matter (B4) present in the semiconductor nanoparticle-containing composition tends to be enhanced. The above-described upper limits and lower limits can be arbitrarily combined. For example, the number of carbon atoms is preferably 1 to 12, more preferably 1 to 8, and even more preferably 2 to 8. When one or more of —CH₂— in the alkyl group is substituted with —O—, it is preferable that the number of carbon atoms of the alkyl group before the substitution is included in the above-described range.

Examples of the alkyl group include a methyl group, an ethyl group, an isopropyl group, an isobutyl group, a tert-butyl group, a 2-ethylhexyl group, a (2-hydroxyethoxy)ethyl group, and a cyclohexyl group. From the viewpoint of the efficiency of absorption of the excitation light, a methyl group and an ethyl group are preferred, and an ethyl group is more preferred.

Examples of the substituent that the alkyl group may have include a hydroxyl group, a carboxyl group, an amino group, a sulfanyl group, a dialkylphosphino group having 2 to 12 carbon atoms, and a halogen atom. From the viewpoint of having high solubility in the semiconductor nanoparticle-containing composition, a hydroxyl group and a carboxyl group are preferred.

Examples of the aryl group for R⁷ include a monovalent aromatic hydrocarbon ring group and a monovalent aromatic heterocyclic group.

The number of carbon atoms of the aryl group is not particularly limited; however, the number of carbon atoms is preferably 4 or more, and more preferably 6 or more, and is preferably 12 or less, and more preferably 10 or less. When the number of carbon atoms is set to the above-described lower limit value or more, the solubility in the semiconductor nanoparticle-containing composition tends to be enhanced, and when the number of carbon atoms is set to the above-described upper limit value or less, the efficiency of absorption of the excitation light with respect to the mass of the coloring matter (B4) present in the semiconductor nanoparticle-containing composition tends to be enhanced. The above-described upper limits and lower limits can be arbitrarily combined. For example, the number of carbon atoms is preferably 4 to 12, more preferably 4 to 10, and even more preferably 6 to 10.

The aromatic hydrocarbon ring in the aromatic hydrocarbon ring group may be a monocyclic ring or a fused ring.

Examples of the aromatic hydrocarbon ring group include a benzene ring, a naphthalene ring, an anthracene ring, a phenanthrene ring, a perylene ring, a tetracene ring, a pyrene ring, a benzopyrene ring, a chrysene ring, a triphenylene ring, an acenaphthene ring, a fluoranthene ring, and a fluorene ring, each of which has one free valence. From the viewpoint of having high solubility in the semiconductor nanoparticle-containing composition, a benzene ring having one free valence and a naphthalene ring having one free valence are preferred, and a benzene ring having one free valence is more preferred.

The aromatic heterocyclic ring in the aromatic heterocyclic group may be a monocyclic ring or a fused ring.

Examples of the aromatic heterocyclic group include a furan ring, a benzofuran ring, a thiophene ring, a benzothiophene ring, a pyrrole ring, a pyrazole ring, an imidazole ring, an oxadiazole ring, an indole ring, a carbazole ring, a pyrroloimidazole ring, a pyrrolopyrazole ring, a pyrrolopyrrole ring, a thienopyrrole ring, a thienothiophene ring, a furopyrrole ring, a furofuran ring, a thienofuran ring, a benzoxazole ring, a benzothiazole ring, a benzisoxazole ring, a benzisothiazole ring, a benzimidazole ring, a pyridine ring, a pyrazine ring, a pyridazine ring, a pyrimidine ring, a triazine ring, a quinoline ring, an isoquinoline ring, a cinnoline ring, a quinoxaline ring, a phenanthridine ring, a perimidine ring, a quinazoline ring, a quinazolinone ring, and an azulene ring, each of which has one free valence. From the viewpoint of having high solubility in the semiconductor nanoparticle-containing composition, a pyridine ring having one free valence and a triazine ring having one free valence are preferred.

Examples of the substituent that the aryl group may have include an alkyl group having 1 to 6 carbon atoms, an alkoxy group having 1 to 6 carbon atoms, an alkoxycarbonyl group having 2 to 7 carbon atoms, a hydroxyl group, a carboxyl group, an amino group, a sulfanyl group, a dialkylphosphino group having 2 to 12 carbon atoms, a nitro group, a cyano group, and a halogen atom. From the viewpoint of the efficiency of absorption of the excitation light, a methyl group, a methoxy group, a diethylamino group, and a methoxycarbonyl group are preferred.

Regarding the alkylcarbonyl group for R⁷, a group in which a carbonyl group is further bonded to the linking bond of the above-described alkyl group may be mentioned. Specific examples include an acetyl group, an ethylcarbonyl group, a butylcarbonyl group, and a 2-ethylhexylcarbonyl group.

Regarding the arylcarbonyl group for R⁷, a group in which a carbonyl group is further bonded to the linking bond of the above-described aryl group may be mentioned. Specific examples include a benzoyl group, a 4-methylbenzoyl group, and a 2-pyridylcarbonyl group.

Regarding the alkylsulfonyl group for R⁷, a group in which a sulfonyl group is further bonded to the linking bond of the above-described alkyl group may be mentioned. Specific examples include a methylsulfonyl group, an ethylsulfonyl group, a butylsulfonyl group, and a 2-ethylhexylsulfonyl group.

Regarding the arylsulfonyl group for R⁷, a group in which a sulfonyl group is further bonded to the linking bond of the above-described aryl group may be mentioned. Specific examples include a phenylsulfonyl group, a p-tolylsulfonyl group, and a 2-pyridylsulfonyl group.

Two or more selected from the group consisting of R⁴, R⁵, and R⁶ may be linked to form a ring. Examples of Formula [VI-1] when a ring is formed in this way are shown below.

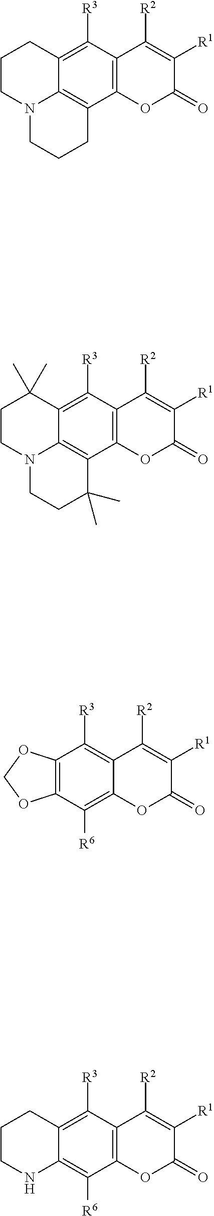

Furthermore, among the coloring matters represented by General Formula [IV-1], a coloring matter represented by General Formula [IV-2] is preferred from the viewpoint of having high solubility in the semiconductor nanoparticle-containing composition:

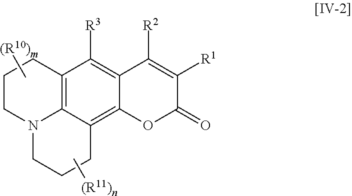

in General Formula [1V-2], R¹ to R³ have the same meanings as those in Formula [IV-1];

R¹⁰ and R¹¹ each independently represent an alkyl group having 1 to 4 carbon atoms; and

m and n each independently represent an integer of 0 to 4.

(R¹⁰ and R¹¹)

In Formula [IV-2], R¹⁰ and R¹¹ each independently represent an alkyl group having 1 to 4 carbon atoms.

The number of carbon atoms of the alkyl group for R¹⁰ and R¹¹ is not particularly limited as long as it is 1 to 4; however, the number of carbon atoms is preferably 1 to 3, and more preferably 1 to 2. When the number of carbon atoms is set to the above-described upper limit value or less, the efficiency of absorption of the excitation light with respect to the mass of the coloring matter (B4) present in the semiconductor nanoparticle-containing composition tends to be enhanced.

Examples of the alkyl group having 1 to 4 carbon atoms include a methyl group, an ethyl group, an isopropyl group, an isobutyl group, and a tert-butyl group. From the viewpoint that the efficiency of absorption of the excitation light is high, a methyl group and an ethyl group are preferred, and a methyl group is more preferred.

(m and n)

In Formula [IV-2], in and n each independently represent an integer of 0 to 4.

m and n are each preferably an integer of 2 or less, from the viewpoint of high solubility in the semiconductor nanoparticle-containing composition and high efficiency of absorption of the excitation light with respect to the mass of the coloring matter (B4) present in the semiconductor nanoparticle-containing composition.

Specific examples of the coloring matter (B4) are given below.

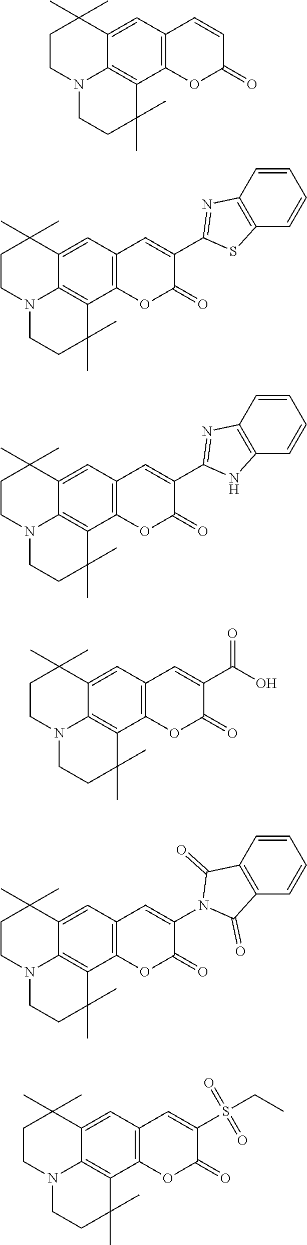 [SMILES: CC1(C)CCN2CCC(C)(C)c3c2c1cc1ccc(=O)oc31 ; CC1(C)CCN2CCC(C)(C)c3c2c1cc1cc(-c2nc4ccccc4s2)c(=O)oc31 ; CC1(C)CCN2CCC(C)(C)c3c2c1cc1cc(-c2nc4ccccc4[nH]2)c(=O)oc31 ; CC1(C)CCN2CCC(C)(C)c3c2c1cc1cc(C(=O)O)c(=O)oc31 ; CC1(C)CCN2CCC(C)(C)c3c2c1cc1cc(N2C(=O)c4ccccc4C2=O)c(=O)oc31 ; CCS(=O)(=O)c1cc2cc3c4c(c2oc1=O)C(C)(C)CCN4CCC3(C)C]

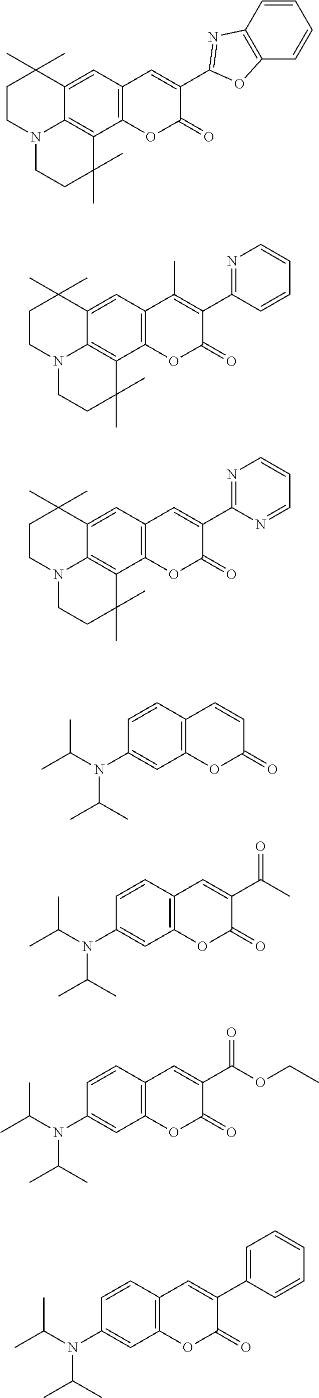

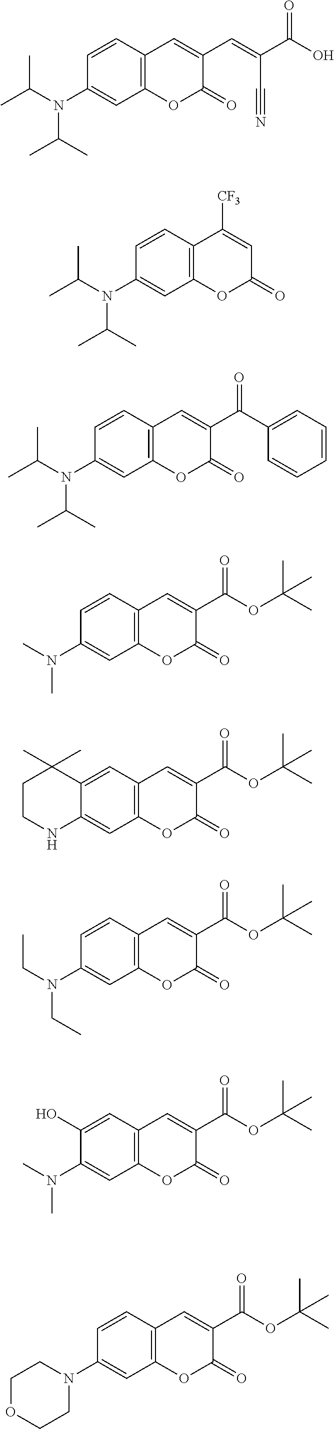

The method for producing the coloring matter (B4) is not particularly limited; however, for example, the coloring matter (B4) can be produced by the method described in Japanese Unexamined Patent Application, First Publication No. 2015-006173.

The maximum emission wavelength of the fluorescence emitted by the coloring matter (B4) is not particularly limited; however, the maximum emission wavelength is preferably 450 nm or more, more preferably 455 nm or more, even more preferably 460 nm or more, and particularly preferably 465 nm or more, and is preferably 600 nm or less, preferably 560 nm or less, more preferably 530 nm or less, and particularly preferably 500 nm or less.

When the maximum emission wavelength is set to the above-described lower limit value or more, semiconductor nanoparticles that could not be excited by blue light of an excitation source can be excited, which tends to lead to an increase in the luminescence intensity of the semiconductor nanoparticles, and when the maximum emission wavelength is set to the above-described upper limit value or less, the emission spectrum of the semiconductor nanoparticles and the emission spectrum of the coloring matter (B4) can be separated, so that the energy transferred from the coloring matter (B4) to the semiconductor nanoparticles becomes large, and when the semiconductor nanoparticle-containing composition is used for displays, absorption of light emitted from the coloring matter (B4) in an unnecessary wavelength region by a color filter provided separately from the pixel part tends to be facilitated. For example, when the maximum emission wavelength of the fluorescence emitted by the coloring matter (B4) exists in the vicinity of 460 to 510 nm, there is a tendency that the luminescence intensities of both the green light-emitting semiconductor nanoparticles and the red light-emitting semiconductor nanoparticles can be increased, which is preferable.

The above-described upper limits and lower limits can be arbitrarily combined. For example, the maximum emission wavelength is preferably 450 to 600 nm, more preferably 455 to 560 nm, even more preferably 460 to 530 nm, and particularly preferably 465 to 500 nm.

The method for measuring the maximum emission wavelength is not particularly limited; however, for example, the maximum emission wavelength may be read from an emission spectrum measured with a spectrofluorophotometer by using a solution of the coloring matter (B4) or a film including the coloring matter (B4), and by using light having a wavelength of 445 nm as an excitation light source.

When the semiconductor nanoparticle-containing composition of the present invention includes the coloring matter (B4), the content proportion of the coloring matter (B4) in the semiconductor nanoparticle-containing composition is not particularly limited; however, the content proportion is preferably 0.001% by mass or more, more preferably 0.005% by mass or more, even more preferably 0.01% by mass or more, still more preferably 0.05% by mass or more, even more preferably 0.1% by mass or more, particularly preferably 0.5% by mass or more, and most preferably 1% by mass or more, and is preferably 30% by mass or less, more preferably 20% by mass or less, even more preferably 10% by mass or less, and particularly preferably 5% by mass or less, all in the total solid content of the semiconductor nanoparticle-containing composition.

When the content proportion is set to the above-described lower limit value or more, there is a tendency that the coloring matter sufficiently absorbs the emitted light, the amount of energy transfer from the coloring matter to the semiconductor nanoparticles is increased, and the luminescence intensity of the semiconductor nanoparticles is increased. Furthermore, when the content proportion is set to the above-described upper limit value or less, there is a tendency that the concentration quenching of the coloring matter is suppressed, the luminescence intensity of the semiconductor nanoparticles is increased as energy is efficiently transferred from the coloring matter to the semiconductor nanoparticles, and a wavelength conversion layer having sufficient hardness is obtained by including components other than the semiconductor nanoparticles and the coloring matter.

The above-described upper limits and lower limits can be arbitrarily combined. For example, the content proportion is preferably 0.001% to 30% by mass, more preferably 0.005% to 30% by mass, even more preferably 0.01% to 20% by mass, still more preferably 0.05% to 20% by mass, even more preferably 0.1% to 10% by mass, particularly preferably 0.5% to 10% by mass, and most preferably 1% to 5% by mass.

[1-2-5] Coloring Matter (B5)

The coloring matter (B5) is a coloring matter represented by General Formula [V]:

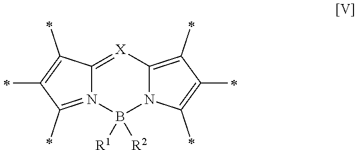

in General Formula [V], X represents C—* or N,

* represents a linking bond, and

R¹ and R² each independently represent a fluorine atom or a cyano group.

Since the coloring matter (B5) has a boron-dipyrromethene skeleton in the mother skeleton, it is considered that the coloring matter (B5) exhibits a high quantum yield and exhibits sufficient luminescence intensity when a wavelength conversion layer is formed. Simultaneously with this, it is considered that durability and light resistance are also high because of the rigid skeleton.

In addition to this, it is considered that the coloring matter (B5) and the semiconductor nanoparticles (A) attract each other due to the interaction caused by the fluorine atom or cyano group bonded to the boron of the coloring matter (B5), and as the coloring matter (B5) sufficiently approaches the semiconductor nanoparticles (A), the efficiency of the excited energy of the coloring matter (B5) transferring to the semiconductor nanoparticles (A) by Forster-type energy transfer is high, while the luminescence intensity of the semiconductor nanoparticles (A) is increased.

(R¹ and R²)

In Formula [V], R¹ and R² each independently represent a fluorine atom or a cyano group.

Between these as R¹ and R², a fluorine atom is preferred from the viewpoint of enhancing the durability of the coloring matter (B5).

(X)

In Formula [V], X represents C—* or N, and * represents a linking bond. From the viewpoint of enhancing the durability of the coloring matter (B5), and from the viewpoint of the stability of the absorption spectrum of the coloring matter (B5) with respect to pH, C—* is preferred, and C—R⁹ is more preferred. Here, R⁹ represents a hydrogen atom or any substituent. Furthermore, for example, when blue excitation light is used, even from the viewpoint of enhancing the absorption efficiency, C—* is preferred, and C—R⁹ is more preferred.

(R⁹)

The any substituent for R⁹ is not particularly limited as long as it is a substitutable monovalent group, and examples thereof include an alkyl group which may have a substituent, an alkylcarbonyl group which may have a substituent, an alkylcarbonyloxy group which may have a substituent, an alkylcarbonylamino group which may have a substituent, an alkylsulfonyl group which may have a substituent, an alkoxy group which may have a substituent, an alkoxycarbonyl group which may have a substituent, an alkenyl group which may have a substituent, an alkynyl group which may have a substituent, an aryl group which may have a substituent, an arylcarbonyl group which may have a substituent, an arylcarbonyloxy group which may have a substituent, an arylcarbonylamino group which may have a substituent, an arylsulfonyl group which may have a substituent, an aryloxy group which may have a substituent, an aryloxycarbonyl group which may have a substituent, an amino group which may have a substituent, a carbamoyl group which may have a substituent, a sulfanyl group which may have a substituent, a sulfonyl group which may have a substituent, a silyl group which may have a substituent, a boryl group which may have a substituent, a phosphinoyl group which may have a substituent, a carboxy group, a formyl group, a sulfo group, a cyano group, a nitro group, a halogen atom, and a hydroxyl group.

Examples of the alkyl group for R⁹ include a linear alkyl group, a branched alkyl group, a cyclic alkyl group, and a combination of these. From the viewpoint of suppressing the formation of aggregates caused by steric hindrance, a branched alkyl group is preferred. Some of —CH₂— in the alkyl group may be substituted with —O—.

The number of carbon atoms of the alkyl group for R⁹ is not particularly limited; however, the number of carbon atoms is usually 1 or more, and preferably 2 or more, and is preferably 12 or less, more preferably 8 or less, even more preferably 5 or less, and particularly preferably 3 or less. When the number of carbon atoms is set to the above-described lower limit value or more, the solubility in the semiconductor nanoparticle-containing composition tends to be enhanced. Furthermore, when the number of carbon atoms is set to the above-described upper limit value or less, the efficiency of absorption of the excitation light with respect to the mass of the coloring matter (B5) present in the semiconductor nanoparticle-containing composition tends to be enhanced. The above-described upper limits and lower limits can be arbitrarily combined. For example, the number of carbon atoms is preferably 1 to 12, more preferably 1 to 8, even more preferably 1 to 5, particularly preferably 1 to 3, and most preferably 2 to 3. When one or more of —CH₂— in the alkyl group is substituted with —O—, it is preferable that the number of carbon atoms of the alkyl group before the substitution is included in the above-described range.

Examples of the alkyl group include a methyl group, an ethyl group, an isopropyl group, an isobutyl group, a tert-butyl group, a 2-ethylhexyl group, a cyclohexyl group, and a (2-hydroxyethoxy)ethyl group. From the viewpoint of enhancing the solubility in the semiconductor nanoparticle-containing composition, a tert-butyl group, a 2-ethylhexyl group, and a (2-hydroxyethoxy)ethyl group are preferred, and a 2-ethylhexyl group is more preferred.

Examples of the substituent that the alkyl group may have include a hydroxyl group, a carboxy group, a sulfanyl group, an amino group, a dialkylamino group having 2 to 12 carbon atoms, a dialkylphosphanyl group having 2 to 12 carbon atoms, a dialkylphosphinoyl group having 2 to 12 carbon atoms, a heteroaryl group, and a halogen atom. Furthermore, the alkyl group may have a polyethylene glycol chain, and among these, from the viewpoint of enhancing the interaction between the coloring matter (B5) and the semiconductor nanoparticles (A), a sulfanyl group and a dialkylphosphinoyl group having 2 to 12 carbon atoms are preferred, and from the viewpoint of suppressing particle precipitation due to a strong interaction between the coloring matter (B5) and the semiconductor nanoparticles (A), a hydrogen atom is preferred.

Regarding the alkylcarbonyl group which may have a substituent for R⁹, a group in which a carbonyl group is bonded to the linking bond of an alkyl group may be mentioned.

Regarding the alkylcarbonyloxy group which may have a substituent for R⁹, a group in which a carbonyloxy group is bonded to the linking bond of an alkyl group may be mentioned.

Regarding the alkylcarbonylamino group which may have a substituent for R⁹, a group in which a carbonylamino group is bonded to the linking bond of an alkyl group may be mentioned.

Regarding the alkylsulfonyl group which may have a substituent for R⁹, a group in which a sulfonyl group is bonded to the linking bond of an alkyl group may be mentioned.

Regarding the alkoxy group for R⁹, a group in which an O atom is bonded to the linking bond of an alkyl group may be mentioned.

Examples of the alkoxy group include a methoxy group, an ethoxy group, a tert-butoxy group, a (2-hydroxyethoxy)ethoxy group, and a 2-[2-(2-hydroxyethoxy)ethoxy]ethoxy group. From the viewpoint of enhancing the solubility in the semiconductor nanoparticle-containing composition, a tert-butoxy group, a (2-hydroxyethoxy)ethoxy group, and a 2-[2-(2-hydroxyethoxy)ethoxy]ethoxy group are preferred, and a 2-[2-(2-hydroxyethoxy)ethoxy]ethoxy group is more preferred.

Examples of the substituent that the alkoxy group may have include a hydroxyl group, a carboxy group, a sulfanyl group, an amino group, a dialkylamino group having 2 to 12 carbon atoms, a dialkylphosphanyl group having 2 to 12 carbon atoms, a dialkylphosphinoyl group having 2 to 12 carbon atoms, and a heteroaryl group. The alkoxy group may have a polyethylene glycol chain. From the viewpoint of enhancing the interaction between the coloring matter (B5) and the semiconductor nanoparticles (A), a sulfanyl group and a dialkylphosphinoyl group having 2 to 12 carbon atoms are preferred. From the viewpoint of suppressing particle precipitation by a strong interaction between the coloring matter (B5) and the semiconductor nanoparticles (A), a hydrogen atom is preferred.

Regarding the alkoxycarbonyl group which may have a substituent for R⁹, a group in which an oxycarbonyl group is bonded to the linking bond of an alkyl group may be mentioned.

Examples of the alkenyl group for R⁹ include a linear alkenyl group, a branched alkenyl group, a cyclic alkenyl group, and a combination of these.

The number of carbon atoms of the alkenyl group for R⁹ is not particularly limited; however, the number of carbon atoms is usually 2 or more, and preferably 4 or more, and is preferably 12 or less, and more preferably 10 or less. When the number of carbon atoms is set to the above-described lower limit value or more, the solubility in the semiconductor nanoparticle-containing composition tends to be enhanced. Furthermore, when the number of carbon atoms is set to the above-described upper limit value or less, the efficiency of absorption of the excitation light with respect to the mass of the coloring matter (B5) present in the semiconductor nanoparticle-containing composition tends to be enhanced. The above-described upper limits and lower limits can be arbitrarily combined. For example, the number of carbon atoms is preferably 2 to 12, more preferably 2 to 10, and even more preferably 4 to 10.

Examples of the alkenyl group include an ethenyl group, a 1-propenyl group, a 2-propenyl group, a 1-butenyl group, a 2-pentenyl group, and a 1,3-butadienyl group. From the viewpoint of enhancing the solubility in the semiconductor nanoparticle-containing composition, a 1-butenyl group and a 2-pentenyl group are preferred.

Examples of the substituent that the alkenyl group may have include a hydroxyl group, a carboxyl group, a cyano group, an amino group, a sulfanyl group, an alkyl group having 1 to 12 carbon atoms, an aryl group, a dialkylphosphanyl group having 2 to 12 carbon atoms, a dialkylphosphinoyl group having 2 to 12 carbon atoms, and a halogen atom.

Examples of the aryl group for R⁹ include a monovalent aromatic hydrocarbon ring group and a monovalent aromatic heterocyclic group.

The number of carbon atoms of the aryl group is not particularly limited; however, the number of carbon atoms is preferably 4 or more, and more preferably 6 or more, and is preferably 12 or less, and more preferably 10 or less. When the number of carbon atoms is set to the above-described lower limit value or more, the solubility in the semiconductor nanoparticle-containing composition tends to be enhanced. Furthermore, when the number of carbon atoms is set to the above-described upper limit value or less, the efficiency of absorption of the excitation light with respect to the mass of the coloring matter (B5) present in the semiconductor nanoparticle-containing composition tends to be enhanced. The above-described upper limits and lower limits can be arbitrarily combined. For example, the number of carbon atoms is preferably 4 to 12, more preferably 4 to 10, and even more preferably 6 to 10.

The aromatic hydrocarbon ring in the aromatic hydrocarbon ring group may be a monocyclic ring or a fused ring.

Examples of the aromatic hydrocarbon ring group include a benzene ring, a naphthalene ring, an anthracene ring, a phenanthrene ring, a perylene ring, a tetracene ring, a pyrene ring, a benzopyrene ring, a chrysene ring, a triphenylene ring, an acenaphthene ring, a fluoranthene ring, and a fluorene ring, each of which has one free valence. From the viewpoint of having high solubility in the semiconductor nanoparticle-containing composition, a benzene ring having one free valence and a naphthalene ring having one free valence are preferred, and a benzene ring having one free valence is more preferred.

The aromatic heterocyclic ring in the aromatic heterocyclic group may be a monocyclic ring or a fused ring.

Examples of the aromatic heterocyclic group include a furan ring, a benzofuran ring, a thiophene ring, a benzothiophene ring, a pyrrole ring, a pyrazole ring, an imidazole ring, an oxadiazole ring, an indole ring, a carbazole ring, a pyrroloimidazole ring, a pyrrolopyrazole ring, a pyrrolopyrrole ring, a thienopyrrole ring, a thienothiophene ring, a furopyrrole ring, a furofuran ring, a thienofuran ring, a benzoxazole ring, a benzothiazole ring, a benzisoxazole ring, a benzisothiazole ring, a benzimidazole ring, a pyridine ring, a pyrazine ring, a pyridazine ring, a pyrimidine ring, a triazine ring, a quinoline ring, an isoquinoline ring, a cinnoline ring, a quinoxaline ring, a phenanthridine ring, a perimidine ring, a quinazoline ring, a quinazolinone ring, and an azulene ring, each of which has one free valence. From the viewpoint of having high solubility in the semiconductor nanoparticle-containing composition, and from the viewpoint of enhancing the interaction between the coloring matter (B5) and the semiconductor nanoparticles (A), a pyridine ring, a furan ring, and a thiophene ring, all having one free valence, are preferred.

Examples of the substituent that the aryl group may have include an alkyl group having 1 to 6 carbon atoms, an alkoxy group having 1 to 6 carbon atoms, an alkoxycarbonyl group having 2 to 7 carbon atoms, a hydroxyl group, a carboxyl group, a dialkylamino group having 2 to 12 carbon atoms, a sulfanyl group, a dialkylphosphanyl group having 2 to 12 carbon atoms, a dialkylphosphinoyl group having 2 to 12 carbon atoms, a nitro group, a cyano group, and a halogen atom. From the viewpoint of enhancing the interaction between the coloring matter (B5) and the semiconductor nanoparticles (A), a sulfanyl group and a dialkylphosphinoyl group having 2 to 12 carbon atoms are preferred. From the viewpoint of suppressing particle precipitation by a strong interaction between the coloring matter (B5) and the semiconductor nanoparticles (A), a hydrogen atom is preferred.

Regarding the arylcarbonyl group which may have a substituent for R⁹, a group in which a carbonyl group is bonded to the linking bond of an aryl group may be mentioned.

Regarding the arylcarbonyloxy group which may have a substituent for R⁹, a group in which a carbonyloxy group is bonded to the linking bond of an aryl group may be mentioned.

Regarding the arylcarbonylamino group which may have a substituent for R⁹, a group in which a carbonylamino group is bonded to the linking bond of an aryl group may be mentioned.

Regarding the arylsulfonyl group which may have a substituent for R⁹, a group in which a sulfonyl group is bonded to the linking bond of an aryl group may be mentioned.

Regarding the aryloxy group which may have a substituent for R⁹, a group in which an O atom is bonded to the linking bond of an aryl group may be mentioned. Specific examples include a phenoxy group and a 2-thienyloxy group.

Regarding the aryloxycarbonyl group which may have a substituent for R⁹, a group in which a carbonyloxy group is bonded to the linking bond of an aryl group may be mentioned.

Regarding the alkynyl group which may have a substituent for R⁹, a group in which an ethynylene group is bonded to the linking bond of the above-mentioned alkyl group or aryl group may be mentioned.

The number of carbon atoms of the alkynyl group for R⁹ is not particularly limited; however, the number of carbon atoms is usually 2 or more, and preferably 3 or more, and is preferably 12 or less, and more preferably 8 or less. When the number of carbon atoms is set to the above-described lower limit value or more, the solubility in the semiconductor nanoparticle-containing composition tends to be enhanced. Furthermore, when the number of carbon atoms is set to the above-described upper limit value or less, the efficiency of absorption of the excitation light with respect to the mass of the coloring matter (B5) present in the semiconductor nanoparticle-containing composition tends to be enhanced. The above-described upper limits and lower limits can be arbitrarily combined. For example, the number of carbon atoms is preferably 2 to 12, more preferably 2 to 8, and even more preferably 3 to 8.

Specific examples include a propynyl group, a butynyl group, a phenylethynyl group, and a 2-thienylethynyl group.

Regarding the amino group which may have a substituent for R⁹, in addition to an amino group represented by —NH₂, an amino group having the above-described alkyl group or the above-described aryl group as a substituent may be mentioned. Specific examples include a dimethylamino group, a diethylamino group, a (2-ethylhexyl)amino group, and a phenylamino group.

Regarding the carbamoyl group which may have a substituent for R⁹, a group in which a carbonyl group is bonded to the linking bond of an amino group may be mentioned.

Regarding the sulfanyl group which may have a substituent for R⁹, in addition to a sulfanyl group represented by —SH, a sulfanyl group having an alkyl group or an aryl group as a substituent may be mentioned.

Regarding the silyl group which may have a substituent for R⁹, in addition to a silyl group represented by —SiH₃, a silyl group having an alkyl group or an aryl group as a substituent may be mentioned.

Regarding the boryl group which may have a substituent for R⁹, a boryl group having an alkyl group or an aryl group as a substituent may be mentioned.

Regarding the phosphinoyl group which may have a substituent for R⁹, in addition to a phosphinoyl group represented by —P(O)H₂, a phosphinoyl group represented by —P(O)(R¹⁰)₂ may be mentioned. Here, regarding R¹⁰, an alkyl group which may have a substituent and an aryl group which may have a substituent as described above may be mentioned.

Examples of the halogen atom for R⁹ include a fluorine atom, a chlorine atom, a bromine atom, and an iodine atom, and from the viewpoint of enhancing the durability of the coloring matter (B5), a fluorine atom and a chlorine atom are preferred.

Regarding R⁹, for example, when blue light is used as the excitation light, from the viewpoint of enhancing the efficiency of absorption of the excitation light, it is preferable that R⁹ is an alkoxy group or an amino group (particularly an alkylamino group).

From the viewpoint of enhancing the solubility in the semiconductor nanoparticle-containing composition and enhancing the durability of the coloring matter (B5), an alkyl group, an aryl group, an alkoxy group, and an amino group are preferred; a methyl group, a 2-ethylhexyl group, a phenyl group, a 2-[2-(2-hydroxyethoxy)ethoxy]ethoxy group, a phenoxy group, and a 2-ethylhexylamino group are more preferred; and a methyl group, a phenyl group, and a 2-[2-(2-hydroxyethoxy)ethoxy]ethoxy group are particularly preferred.

The coloring matter (B5) is not particularly limited as long as it is represented by General Formula [V]; however, from the viewpoint of having high solubility in various solvents and in the semiconductor nanoparticle-containing composition, having a high gram absorption coefficient, being less likely to undergo concentration quenching, and having an increased quantum yield of fluorescence, it is preferable that the coloring matter (B5) is a coloring matter represented by General Formula [V-1]:

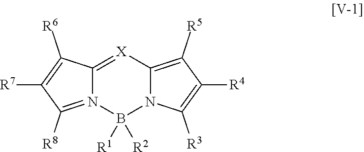

in General Formula [V-1], X represents C—R⁹ or N,

R³ to R⁹ each independently represent a hydrogen atom or any substituent,

R⁴ and R³ or R⁵ may be linked to form a ring,

R⁷ and R⁶ or R⁸ may be linked to form a ring, and

R¹ and R² each independently represent a fluorine atom or a cyano group.

(R¹ and R²)

In Formula [V-1], R¹ and R² each independently represent a fluorine atom or a cyano group.

Between these as R¹ and R², a fluorine atom is preferred from the viewpoint of enhancing the durability of the coloring matter (B5).

(X and R⁹)

In Formula [V-1], X represents C—R⁹ or N, and from the viewpoint of enhancing the durability of the coloring matter (B5), C—R⁹ is preferred. Here, R⁹ represents a hydrogen atom or any substituent, and examples of the any substituent for R⁹ include those described for Formula [V], while preferred substituents are also similar to those described for Formula [V].

(R³ to R⁸)

In Formula [V-1], R³ to R⁸ each independently represent a hydrogen atom or any substituent, and examples of the any substituent for R³ to R⁸ include those described as the any substituent for R⁹ in Formula [V].

From the viewpoint of enhancing the solubility in the semiconductor nanoparticle-containing composition and enhancing the durability of the coloring matter (B5), R³ to R⁸ are each preferably an alkyl group, an aryl group, an alkoxycarbonyl group, or an aryloxycarbonyl group; more preferably a methyl group, a 2-ethylhexyl group, a phenyl group, a 2-[2-(2-hydroxyethoxy)ethoxy]ethoxycarbonyl group, or a phenoxycarbonyl group; and particularly preferably a methyl group, a 2-ethylhexyl group, or a 2-[2-(2-hydroxyethoxy)ethoxy]ethoxycarbonyl group.

R⁴ and R³ or R⁵ may be linked to form a ring. R⁷ and R⁶ or R⁸ may be linked to forma ring.

Examples of General Formula [V-1] when a ring is formed in this way are shown below.

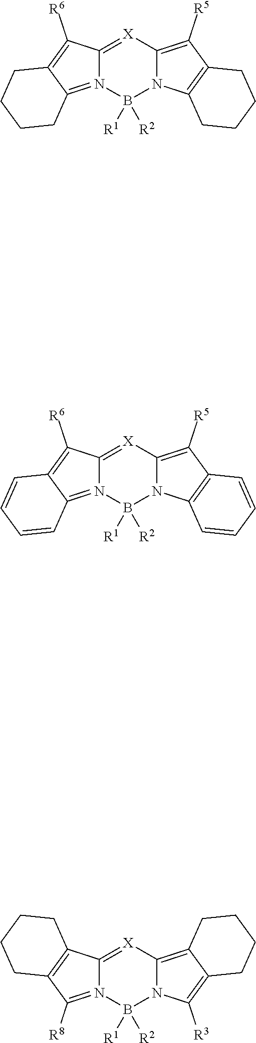

Among the coloring matters represented by General Formula [V-1], from the viewpoint of enhancing the durability of the coloring matter (B5), it is preferable that in General Formula [V-1], R¹ and R² are each a fluorine atom; X is C—R⁹; and R⁹ is a hydrogen atom or any substituent.

From the viewpoint of enhancing the solubility in the semiconductor nanoparticle-containing composition and enhancing the durability of the coloring matter (B5), regarding a preferred structure of the coloring matter (B5), it is preferable that in General Formula [V-1], R¹ and R² are each a fluorine atom; X is C—R⁹; R⁹ is an alkyl group, an aryl group, an alkoxy group, or an amino group; and R³ to R⁸ are each an alkyl group, an aryl group, an alkoxycarbonyl group, or an aryloxycarbonyl group.

For example, when blue excitation light is used, from the viewpoint of enhancing the efficiency of absorption, regarding a preferred structure of the coloring matter (B5), it is preferable that in General Formula [V-1], X is C—R⁹; and R⁹ is an alkoxy group or an amino group (particularly an alkylamino group).

Specific examples of the coloring matter (B5) are given below.

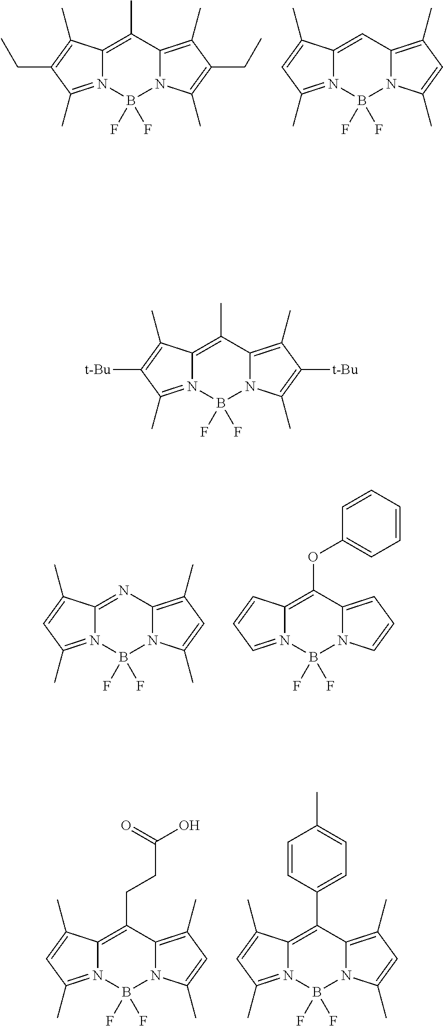

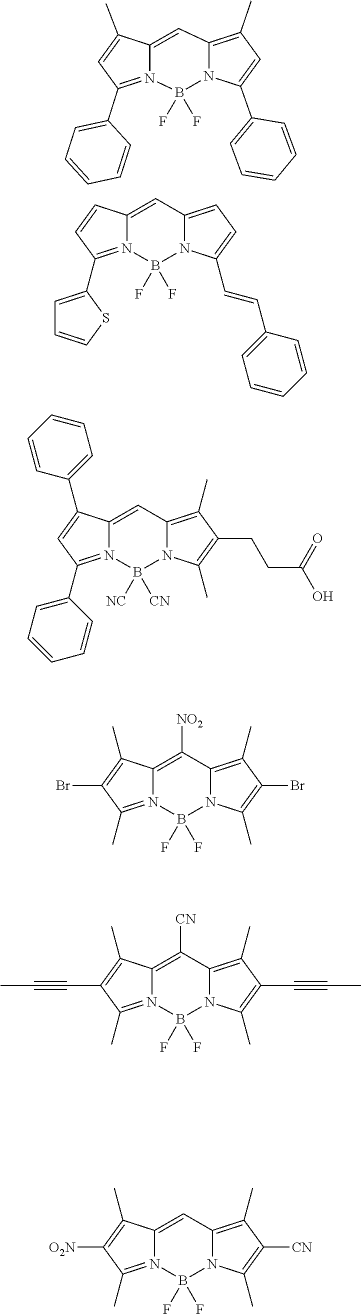

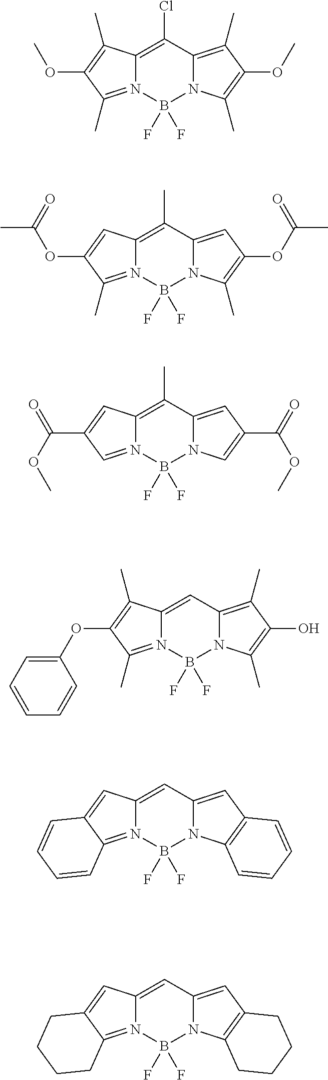

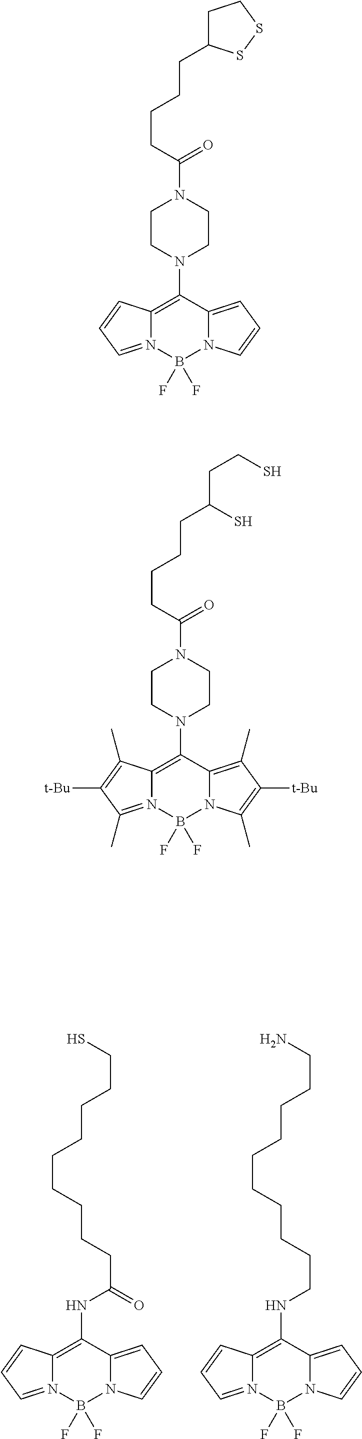

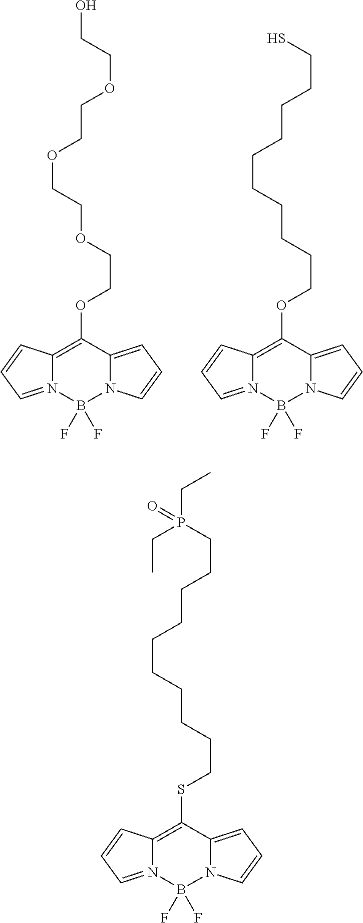

The method for producing the coloring matter (B5) is not particularly limited; however, for example, the coloring matter (B5) can be produced by the method described in Chem. Rev., 107, p. 4891-4932, 2007.

The maximum emission wavelength of the fluorescence emitted by the coloring matter (B5) is not particularly limited; however, the maximum emission wavelength is preferably 450 nm or more, more preferably 455 nm or more, even more preferably 460 nm or more, and particularly preferably 465 nm or more, and is preferably 640 nm or less, preferably 635 nm or less, more preferably 630 nm or less, and particularly preferably 625 nm or less.

When the maximum emission wavelength is set to the above-described lower limit value or more, semiconductor nanoparticles that could not be excited when blue light was used as the excitation light source can be excited, and this tends to lead to an increase in the luminescence intensity of the semiconductor nanoparticles. Furthermore, when the maximum emission wavelength is set to the upper limit value or less, the emission spectrum of the semiconductor nanoparticles and the emission spectrum of the coloring matter (B5) can be separated, so that the energy transferred from the coloring matter (B5) to the semiconductor nanoparticles becomes large, and when the semiconductor nanoparticle-containing composition is used for displays, absorption of light emitted from the coloring matter (B5) in an unnecessary wavelength region by a color filter provided separately from the pixel part tends to be facilitated. For example, when the maximum emission wavelength of the fluorescence emitted by the coloring matter (B5) exists in the vicinity of 460 to 630 nm, there is a tendency that the luminescence intensities of both the green semiconductor nanoparticles and the red semiconductor nanoparticles can be increased, which is preferable.

The above-described upper limits and lower limits can be arbitrarily combined. For example, the maximum emission wavelength is preferably 450 to 640 nm, more preferably 455 to 635 nm, even more preferably 460 to 630 nm, and particularly preferably 465 to 625 nm.

The method for measuring the maximum emission wavelength is not particularly limited; however, for example, the maximum emission wavelength may be read from an emission spectrum measured with a spectrofluorophotometer by using a solution of the coloring matter (B5) or a film including the coloring matter (B5), and by using light having a wavelength of 445 nm as an excitation light source.

When the semiconductor nanoparticle-containing composition of the present invention includes the coloring matter (B5), the content proportion of the coloring matter (B5) in the semiconductor nanoparticle-containing composition is not particularly limited; however, the content proportion is preferably 0.001% by mass or more, more preferably 0.005% by mass or more, even more preferably 0.01% by mass or more, still more preferably 0.05% by mass or more, even more preferably 0.1% by mass or more, particularly preferably 0.5% by mass or more, and most preferably 1% by mass or more, and is preferably 30% by mass or less, more preferably 20% by mass or less, even more preferably 10% by mass or less, and particularly preferably 5% by mass or less, all in the total solid content of the semiconductor nanoparticle-containing composition.

When the content proportion is set to the above-described lower limit value or more, there is a tendency that the coloring matter sufficiently absorbs the emitted light, the amount of energy transfer from the coloring matter to the semiconductor nanoparticles is increased, and the luminescence intensity of the semiconductor nanoparticles is increased. Furthermore, when the content proportion is set to the above-described upper limit value or less, there is a tendency that the concentration quenching of the coloring matter is suppressed, the luminescence intensity of the semiconductor nanoparticles is increased as energy is efficiently transferred from the coloring matter to the semiconductor nanoparticles, and a wavelength conversion layer having sufficient hardness is obtained by including components other than the semiconductor nanoparticles and the coloring matter.

The above-described upper limits and lower limits can be arbitrarily combined. For example, the content proportion is preferably 0.001% to 30% by mass, more preferably 0.005% to 30% by mass, even more preferably 0.01% to 20% by mass, still more preferably 0.05% to 20% by mass, even more preferably 0.1% to 10% by mass, particularly preferably 0.5% to 10% by mass, and most preferably 1% to 5% by mass.

The coloring matter (B) in the semiconductor nanoparticle-containing composition of the present invention contains at least one selected from the coloring matters (B1) to (B5); however, the coloring matter (B) may include one of the coloring matters (B1) to (B5) alone (for example, only the coloring matter (B1)) or may include two or more kinds thereof (for example, the coloring matters (B1) and (B2)). Furthermore, each of the coloring matters (B1) to (B5) may include one kind alone (for example, one kind of the coloring matter (B1)) or may include two or more kinds (for example, two kinds of the coloring matter (B1)).

The coloring matter (B) may further include a coloring matter other than the coloring matters (B1) to (B5) (hereinafter, may be referred to as “coloring matter (BB)”).

Examples of the coloring matter (BB) include coloring matters other than the coloring matters (B1) to (B5), which have a coumarin skeleton, a perylene skeleton, a naphthalimide skeleton, a dipyrromethene skeleton, a xanthene skeleton, and a benzothiadiazole skeleton, and have a maximum emission wavelength at 450 to 650 nm.

With regard to a coloring matter having a coumarin skeleton, it is preferable that the content of the coloring matter having a coumarin skeleton with a total degree of branching of 3 or more is 50% by mass or more with respect to the total content of the coloring matter having a coumarin skeleton. This also applies to coloring matters having a perylene skeleton.

For example, when the coloring matter (B4) and a coloring matter having a coumarin skeleton and having a total degree of branching of 1 as the coloring matter (BB) are used at the same time, it is preferable that the content of the coloring matter (B4) is 50% by mass or more of the total amount of the coloring matter (B4) and a coloring matter having a coumarin skeleton and having a total degree of branching of 1 as the coloring matter (BB).

[1-3] Polymerizable Compound (C)

The semiconductor nanoparticle-containing composition of the present invention of a certain aspect contains a polymerizable compound (C). The semiconductor nanoparticle-containing composition of the present invention of another aspect may further contain a polymerizable compound (C).

When the semiconductor nanoparticle-containing composition contains the polymerizable compound (C), there is a tendency that a wavelength conversion layer, particularly a color filter pixel part when the semiconductor nanoparticle-containing composition of the present invention is used for a color filter pixel part, can be cured.

Examples of the polymerizable compound include a photopolymerizable compound (C1) and a thermopolymerizable compound (C2).

[1-3-1] Photopolymerizable Compound (C1)

The photopolymerizable compound (C1) is a polymerizable component that is polymerized by being irradiated with light.

Examples of the photopolymerizable compound (CO include a photoradical polymerizable compound and a photocationic polymerizable compound, all of which may be photopolymerizable monomers or oligomers. These are usually used together with photopolymerization initiators. That is, a photoradical polymerizable compound is usually used together with a photoradical polymerization initiator, and a photocationic polymerizable compound is usually used together with a photocationic polymerization initiator. In other words, the semiconductor nanoparticle-containing composition may contain a photopolymerizable component that includes a photopolymerizable compound and a photopolymerization initiator, and for example, the semiconductor nanoparticle-containing composition may contain a photoradical polymerizable component that includes a photoradical polymerizable compound and a photoradical polymerization initiator, or may contain a photocationic polymerizable component that includes a photocationic polymerizable compound and a photocationic polymerization initiator. A photoradical polymerizable compound and a photocationic polymerizable compound may be used in combination, a compound having photoradical polymerizability and photocationic polymerizability may be used, or a photoradical polymerization initiator and a photocationic polymerization initiator may be used in combination. Regarding the photopolymerizable compound (C1), one kind thereof may be used alone, or two or more kinds thereof may be used in combination.

Regarding the photoradical polymerizable compound, a (meth)acrylate-based compound may be mentioned. The (meth)acrylate-based compound may be a monofunctional (meth)acrylate having one (meth)acryloyl group or may be a polyfunctional (meth)acrylate having a plurality of (meth)acryloyl groups. From the viewpoint of having excellent fluidity when produced into an ink, from the viewpoint of having more excellent ejection stability, and from the viewpoint of being capable of suppressing the deterioration of smoothness caused by curing shrinkage during color filter production, it is preferable to use a monofunctional (meth)acrylate and a polyfunctional (meth)acrylate in combination.

Examples of the monofunctional (meth)acrylate include methyl (meth)acrylate, ethyl (meth)acrylate, propyl (meth)acrylate, butyl (meth)acrylate, amyl (meth)acrylate, 2-ethylhexyl (meth)acrylate, octyl (meth)acrylate, nonyl (meth)acrylate, dodecyl (meth)acrylate, hexadecyl (meth)acrylate, octadecyl (meth)acrylate, cyclohexyl (meth)acrylate, methoxyethyl (meth)acrylate, butoxyethyl (meth)acrylate, phenoxyethyl (meth)acrylate, nonylphenoxyethyl (meth)acrylate, glycidyl (meth)acrylate, dimethylaminoethyl (meth)acrylate, diethylaminoethyl (meth)acrylate, isobornyl (meth)acrylate, dicyclopentanyl (meth)acrylate, dicyclopentenyl (meth)acrylate, dicyclopentenyloxyethyl (meth)acrylate, 2-hydroxy-3-phenoxypropyl (meth)acrylate, tetrahydrofurfuryl (meth)acrylate, 2-hydroxyethyl (meth)acrylate, benzyl (meth)acrylate, phenylbenzyl (meth)acrylate, mono(2-acryloyloxyethyl) succinate, N-[2-(acryloyloxy)ethyl]phthalimide, and N-[2-(acryloyloxy)ethyl]tetrahydrophthalimide.

The polyfunctional (meth)acrylate may be, for example, a bifunctional (meth)acrylate, a trifunctional (meth)acrylate, a tetrafunctional (meth)acrylate, a pentafunctional (meth)acrylate, or a hexafunctional (meth)acrylate. For example, the polyfunctional (meth)acrylate may be a di(meth)acrylate obtained by substituting two hydroxyl groups of a diol compound with (meth)acryloyloxy groups, or a di- or tri(meth)acrylate obtained by substituting two or three hydroxyl groups of a triol compound with (meth)acryloyloxy groups.

Examples of the bifunctional (meth)acrylate include 1,3-butylene glycol di(meth)acrylate, 1,4-butanediol di(meth)acrylate, 1,5-pentanediol di(meth)acrylate, and 3-methyl-1,5-pentanediol di(meth)acrylate, 1,6-hexanediol di(meth)acrylate, neopentyl glycol di(meth)acrylate, 1,8-octanediol di(meth)acrylate, 1,9-nonanediol di(meth)acrylate, tricyclodecanedimethanol di(meth)acrylate, ethylene glycol di(meth)acrylate, polyethylene glycol di(meth)acrylate, propylene glycol di(meth)acrylate, dipropylene glycol di(meth)acrylate, tripropylene glycol di(meth)acrylate, polypropylene glycol di(meth)acrylate, neopentyl glycol hydroxypivalic acid ester diacrylate; a di(meth)acrylate obtained by substituting two hydroxyl groups of tris(2-hydroxyethyl) isocyanurate with (meth)acryloyloxy groups; a di(meth)acrylate obtained by substituting two hydroxyl groups of a diol, which is obtained by adding 4 mol or more of ethylene oxide or propylene oxide to 1 mol of neopentyl glycol, with (meth)acryloyloxy groups; a di(meth)acrylate obtained by substituting two hydroxyl groups of a diol, which is obtained by adding 2 mol of ethylene oxide or propylene oxide to 1 mol of bisphenol A, with (meth)acryloyloxy groups; a di(meth)acrylate obtained by substituting two hydroxyl groups of a triol, which is obtained by adding 3 mol or more of ethylene oxide or propylene oxide to 1 mol of trimethylolpropane, with (meth)acryloyloxy groups; and a di(meth)acrylate obtained by substituting two hydroxyl groups of a diol, which is obtained by adding 4 mol or more of ethylene oxide or propylene oxide to 1 mol of bisphenol A, with (meth)acryloyloxy groups.

Examples of the trifunctional (meth)acrylate include trimethylolpropane tri(meth)acrylate, glycerin triacrylate, pentaerythritol tri(meth)acrylate, and a tri(meth)acrylate obtained by substituting three hydroxyl groups of a triol, which is obtained by adding 3 mol or more of ethylene oxide or propylene oxide to 1 mol of trimethylolpropane, with (meth)acryloyloxy groups.

Examples of the tetrafunctional (meth)acrylate include pentaerythritol tetra(meth)acrylate.

Examples of the pentafunctional (meth)acrylate include dipentaerythritol penta(meth)acrylate.

Examples of the hexafunctional (meth)acrylate include dipentaerythritol hexa(meth)acrylate.

The polyfunctional (meth)acrylate may be, for example, a poly(meth)acrylate in which a plurality of hydroxyl groups of dipentaerythritol of dipentaerythritol hexa(meth)acrylate are substituted with (meth)acryloyloxy groups.

The (meth)acrylate compound may be a (meth)acrylate having a phosphoric acid group, for example, an ethylene oxide-modified phosphoric acid (meth)acrylate or an ethylene oxide-modified alkyl phosphate (meth)acrylate.

Examples of the photocationic polymerizable compound include an epoxy compound, an oxetane compound, and a vinyl ether compound.

Examples of the epoxy compound include aliphatic epoxy compounds such as a bisphenol A type epoxy compound, a bisphenol F type epoxy compound, a phenol novolac type epoxy compound, trimethylolpropane polyglycidyl ether, and neopentyl glycol diglycidyl ether; and alicyclic epoxy compounds such as 1,2-epoxy-4-vinylcyclohexane and 1-methyl-4-(2-methyloxiranyl)-7-oxabicyclo[4.1.0]heptane.

It is also possible to use a commercially available product as the epoxy compound. Regarding the commercially available product of the epoxy compound, for example, “CELLOXIDE (registered trademark; hereinafter, the same) 2000”, “CELLOXIDE 3000”, and “CELLOXIDE 4000” manufactured by Daicel Corporation can be used.

Examples of the cationic polymerizable oxetane compound include 2-ethylhexyloxetane, 3-hydroxymethyl-3-methyloxetane, 3-hydroxymethyl-3-ethyloxetane, 3-hydroxymethyl-3-propyloxetane, 3-hydroxymethyl-3-normal butyloxetane, 3-hydroxymethyl-3-phenyloxetane, 3-hydroxymethyl-3-benzyloxetane, 3-hydroxyethyl-3-methyloxetane, 3-hydroxyethyl-3-ethyloxetane, 3-hydroxyethyl-3-propyloxetane, 3-hydroxyethyl-3-phenyloxetane, 3-hydroxypropyl-3-methyloxetane, 3-hydroxypropyl-3-ethyloxetane, 3-hydroxypropyl-3-propyloxetane, 3-hydroxypropyl-3-phenyloxetane, and 3-hydroxybutyl-3-methyloxetane.

It is also possible to use a commercially available product as the oxetane compound. Regarding the commercially available oxetane compound, for example, ARON OXETANE Series (“OXT-101”, “OXT-212”, “OXT-121”, “OXT-221”, and the like) manufactured by Toagosei Co., Ltd.; “CELLOXIDE 2021”, “CELLOXIDE 2021A”, “CELLOXIDE 2021P”, “CELLOXIDE 2080”, “CELLOXIDE 2081”, “CELLOXIDE 2083”, “CELLOXIDE 2085”, “EPOLEAD (registered trademark; hereinafter, the same) GT300”, “EPOLEAD GT301”, “EPOLEAD GT302”, “EPOLEAD GT400”, “EPOLEAD GT401”, and “EPOLEAD GT403” manufactured by Daicel Corporation; “CYRACURE UVR-6105”, “CYRACURE UVR-6107”, “CYRACURE UVR-6110”, “CYRACURE UVR-6128”, “ERL4289”, and “ERL4299” manufactured by Dow Chemical Japan, Ltd., can be used. Known oxetane compounds (for example, the oxetane compounds described in Japanese Unexamined Patent Application, First Publication No. 2009-40830) can also be used.

Examples of the vinyl ether compound include 2-hydroxyethyl vinyl ether, triethylene glycol vinyl monoether, tetraethylene glycol divinyl ether, and trimethylolpropane trivinyl ether.

As the photopolymerizable compound (C1), the photopolymerizable compounds described in paragraphs [0042] to [0049] of Japanese Unexamined Patent Application, First Publication No. 2013-182215 can also be used.

With regard to the semiconductor nanoparticle-containing composition, when the curable component is composed only of a photopolymerizable compound or configured to include the photopolymerizable compound as a main component, regarding the photopolymerizable compound (C1) such as described above, it is more preferable to use a polyfunctional photopolymerizable compound of bifunctionality or higher-functionality having two or more polymerizable functional groups in one molecule, as an essential component, from the viewpoint that the durability (strength, heat resistance, and the like) of a cured product can be further enhanced.

The photopolymerizable compound (C1) may be alkali-insoluble from the viewpoint that a color filter pixel part having excellent reliability is likely to be obtained. In the present specification, when it is said that the photopolymerizable compound is alkali-insoluble, it is implied that the amount of the photopolymerizable compound dissolved in a 1% by mass aqueous solution of potassium hydroxide at 25° C. is 30% by mass or less based on the total mass of the photopolymerizable compound. The amount of the photopolymerizable compound dissolved is preferably 10% by mass or less, and more preferably 3% by mass or less.

When the semiconductor nanoparticle-containing composition of the present invention contains the photopolymerizable compound (C1), from the viewpoint that a viscosity appropriate for a process such as coating as for an ink for a wavelength conversion layer is easily obtained, particularly from the viewpoint that a viscosity appropriate as for an ink for inkjet methods is easily obtained, from the viewpoint that the curability of the semiconductor nanoparticle-containing composition is favorable, and from the viewpoint that the solvent resistance and abrasion resistance of the pixel part (cured product of the semiconductor nanoparticle-containing composition) are enhanced, the content proportion of the photopolymerizable compound (C1) is preferably 10% by mass or more, more preferably 15% by mass or more, and even more preferably 20% by mass or more, in the total solid content of the semiconductor nanoparticle-containing composition, and from the viewpoint that a viscosity appropriate for a process such as coating as for an ink for a wavelength conversion layer is easily obtained, particularly from the viewpoint that a viscosity appropriate as for an ink for inkjet methods is easily obtained, and from the viewpoint that more excellent optical characteristics are obtained, the content proportion is preferably 90% by mass or less, more preferably 80% by mass or less, even more preferably 70% by mass or less, still more preferably 60% by mass or less, and particularly preferably 50% by mass or less. The above-described upper limits and lower limits can be arbitrarily combined. For example, the content proportion is preferably 10% to 90% by mass, more preferably 10% to 80% by mass, even more preferably 15% to 70% by mass, still more preferably 15% to 60% by mass, and particularly preferably 20% to 50% by mass.

[1-3-2] Thermopolymerizable Compound (C2)

The thermopolymerizable compound (C2) is a compound (resin) that is crosslinked and cured by heat. The thermopolymerizable compound (C2) has a thermosetting group. Examples of the thermosetting group include an epoxy group, an oxetane group, an isocyanate group, an amino group, a carboxyl group, and a methylol group. From the viewpoint that the heat resistance and storage stability of a cured product of the semiconductor nanoparticle-containing composition are excellent, and from the viewpoint that the adhesiveness to a light-shielding part (for example, black matrix) and a base material is excellent, an epoxy group is preferred. The thermopolymerizable compound (C2) may have one kind of thermosetting group or may have two or more kinds of thermosetting groups.

The thermopolymerizable compound (C2) may be a polymer of a single monomer (homopolymer) or may be a copolymer of a plurality of kinds of monomers (copolymer). Furthermore, the thermopolymerizable compound may be any of a random copolymer, a block copolymer, or a graft copolymer.

Regarding the thermopolymerizable compound (C2), a compound having two or more thermosetting groups in one molecule is used, and this compound is usually used in combination with a curing agent. When a thermopolymerizable compound is used, a catalyst (curing catalyst) capable of promoting a thermosetting reaction may be further added. In other words, the semiconductor nanoparticle-containing composition may contain a thermosetting component including a thermopolymerizable compound (C2) as well as a curing agent and a curing catalyst that are used as needed. Furthermore, in addition to these, a polymer that does not have polymerization reactivity per se may be further used.

As the compound having two or more thermosetting groups in one molecule, for example, an epoxy resin having two or more epoxy groups in one molecule (hereinafter, also referred to as “polyfunctional epoxy resin”) may be used. The “epoxy resin” includes both a monomeric epoxy resin and a polymeric epoxy resin. The number of epoxy groups present in one molecule of the polyfunctional epoxy resin is preferably 2 to 50, and more preferably 2 to 20. The epoxy group may have any structure as long as it has an oxirane ring structure and may be, for example, a glycidyl group, an oxyethylene group, or an epoxycyclohexyl group. Examples of the epoxy resin include known polyvalent epoxy resins that can be cured by a carboxylic acid. Such epoxy resins are widely disclosed in, for example, Masaki Shinbo, ed., “Epoxy Resin Handbook”, Nikkan Kogyo Shimbun (1987), and these can be used.

Examples of the thermopolymerizable compound having an epoxy group (including a polyfunctional epoxy resin) include a polymer of a monomer having an oxirane ring structure, and a copolymer of a monomer having an oxirane ring structure and another monomer. Examples of the polyfunctional epoxy resin include polyglycidyl methacrylate, a methyl methacrylate-glycidyl methacrylate copolymer, a benzyl methacrylate-glycidyl methacrylate copolymer, an n-butyl methacrylate-glycidyl methacrylate copolymer, a 2-hydroxyethyl methacrylate-glycidyl methacrylate copolymer, a (3-ethyl-3-oxetanyl)methyl methacrylate-glycidyl methacrylate copolymer, and styrene-glycidyl methacrylate. Furthermore, as the thermopolymerizable compound (C2), the compounds described in paragraphs [0044] to [0066] of Japanese Unexamined Patent Application, First Publication No. 2014-56248 can also be used.

Examples of the polyfunctional epoxy resin include a bisphenol A type epoxy resin, a bisphenol F type epoxy resin, a brominated bisphenol A type epoxy resin, a bisphenol S type epoxy resin, a diphenyl ether type epoxy resin, a hydroquinone type epoxy resin, a naphthalene type epoxy resin, a biphenyl type epoxy resin, a fluorene type epoxy resin, a phenol novolac type epoxy resin, an ortho-cresol novolac type epoxy resin, a trishydroxyphenylmethane type epoxy resin, a trifunctional type epoxy resin, a tetraphenylolethane type epoxy resin, a dicyclopentadiene phenol type epoxy resin, a hydrogenated bisphenol A type epoxy resin, a bisphenol A nucleated polyol type epoxy resin, a polypropylene glycol type epoxy resin, a glycidyl ester type epoxy resin, a glycidylamine type epoxy resin, a glyoxal type epoxy resin, an alicyclic epoxy resin, and a heterocyclic epoxy resin may be mentioned.

More specifically, a bisphenol A type epoxy resin such as trade name “EPIKOTE (registered trademark; hereinafter, the same) 828” (manufactured by Mitsubishi Chemical Corporation); a bisphenol F type epoxy resin such as trade name “YDF-170” (manufactured by Nippon Steel Chemical & Material Co., Ltd.); a brominated bisphenol A type epoxy resin such as trade name “SR-T5000” (manufactured by Sakamoto Yakuhin Kogyo Co., Ltd.); a bisphenol S type epoxy resin such as trade name “EPICLON (registered trademark; hereinafter, the same) EXA1514” (manufactured by DIC Corporation); a hydroquinone type epoxy resin such as trade name “YDC-1312” (manufactured by Nippon Steel Chemical & Material Co., Ltd.); a naphthalene type epoxy resin such as trade name “EPICLON EXA4032”, “HP-4770”, “HP-4700”, or “HP-5000” (manufactured by DIC Corporation); a biphenyl type epoxy resin such as trade name “EPIKOTE YX4000H” (manufactured by Mitsubishi Chemical Corporation); a bisphenol A type novolac-based epoxy resin such as trade name “EPIKOTE 157S70” (manufactured by Mitsubishi Chemical Corporation); a phenol novolac type epoxy resin such as trade name “EPIKOTE 154” (manufactured by Mitsubishi Chemical Corporation) or trade name “YDPN-638” (manufactured by Nippon Steel Chemical & Material Co., Ltd.); a cresol novolac type epoxy resin such as trade name “EPICLON N-660” (manufactured by DIC Corporation); a dicyclopentadiene phenol type epoxy resin such as trade name “EPICLON HP-7200” or “HP-7200H” (manufactured by DIC Corporation); a trishydroxyphenylmethane type epoxy resin such as trade name “EPIKOTE 1032H60” (manufactured by Mitsubishi Chemical Corporation); a trifunctional type epoxy resin such as trade name “ADEKA GLYCIROL (registered trademark; hereinafter, the same) ED-505” (manufactured by ADEKA Corporation); a tetraphenylolethane type epoxy resin such as “EPIKOTE 1031S” (manufactured by Mitsubishi Chemical Corporation); a tetrafunctional type epoxy resin such as trade name “DENACOL (registered trademark; hereinafter, the same) EX-411” (manufactured by Nagase ChemteX Corporation); a hydrogenated bisphenol A type epoxy resin such as trade name “ST-3000” (manufactured by Nippon Steel Chemical & Material Co., Ltd.); a glycidyl ester type epoxy resin such as trade name “EPIKOTE 190P” (manufactured by Mitsubishi Chemical Corporation); a glycidylamine type epoxy resin such as trade name “YH-434” (manufactured by Nippon Steel Chemical & Material Co., Ltd.); a glyoxal type epoxy resin such as trade name “YDG-414” (Tohto Chemical Industry Co., Ltd.); an alicyclic polyfunctional epoxy compound such as trade name “EPOLEAD GT-401” (manufactured by Daicel Corporation); and a heterocyclic epoxy resin such as triglycidyl isocyanate (TGIC) may be mentioned. Furthermore, if necessary, for example, trade name “NEOTOHTO S” (manufactured by Nippon Steel Chemical & Material Co., Ltd.) can be mixed as an epoxy reactive diluent.

As the polyfunctional epoxy resin, for example, “FINEDIC (registered trademark; hereinafter, the same) A-2475”, “FINEDIC A-254”, “FINEDIC A-253”, “FINEDIC A-229-30A”, “FINEDIC A-261”, “FINEDIC A-249”, “FINEDIC A-266”, “FINEDIC A-241”, “FINEDIC M-8020”, “EPICLON N-740”, “EPICLON N-770”, “EPICLON N-865” (trade names) can be used.

When a polyfunctional epoxy resin having a relatively small molecular weight is used as the thermopolymerizable compound, epoxy groups in the semiconductor nanoparticle-containing composition are supplemented so that the reaction point concentration of epoxy becomes a high concentration, and the crosslink density can be increased.

Among the polyfunctional epoxy resins, it is preferable to use an epoxy resin having four or more epoxy groups in one molecule (polyfunctional epoxy resin of tetrafunctionality or higher-functionality), from the viewpoint of increasing the crosslink density. Particularly, when a thermopolymerizable compound having a weight average molecular weight of 10000 or less is used in order to enhance the ejection stability from the ejection head in an inkjet method, since the strength and hardness of the pixel part (cured product of the semiconductor nanoparticle-containing composition) are likely to decrease, it is preferable to blend a polyfunctional epoxy resin of tetrafunctionality or higher-functionality into the semiconductor nanoparticle-containing composition from the viewpoint of sufficiently increasing the crosslink density.

The thermopolymerizable compound (C2) may be alkali-insoluble from the viewpoint that a wavelength conversion layer, particularly a color filter pixel part, having excellent reliability is easily obtained. When it is said that the thermopolymerizable compound is alkali-insoluble, it is implied that the amount of the thermopolymerizable compound dissolved in a 1% by mass aqueous solution of potassium hydroxide at 25° C. is 30% by mass or less based on the total mass of the thermopolymerizable compound. The amount of the thermopolymerizable compound dissolved is preferably 10% by mass or less, more preferably 3% by mass or less.

From the viewpoint that a viscosity appropriate for a process such as coating as for an ink for a wavelength conversion layer is easily obtained, particularly from the viewpoint that a viscosity appropriate as for an ink for inkjet methods is easily obtained, from the viewpoint that the curability of the semiconductor nanoparticle-containing composition is favorable, and from the viewpoint that the solvent resistance and abrasion resistance of the pixel part (cured product of the semiconductor nanoparticle-containing composition) are enhanced, the weight average molecular weight of the thermopolymerizable compound (C2) is preferably 750 or more, more preferably 1000 or more, and even more preferably 2000 or more. From the viewpoint of obtaining a viscosity appropriate as for an inkjet ink, the weight average molecular weight is preferably 500000 or less, more preferably 300000 or less, and even more preferably 200000 or less. The above-described upper limits and lower limits can be arbitrarily combined. For example, the weight average molecular weight is preferably 750 to 500000, more preferably 1000 to 300000, and even more preferably 2000 to 200000. However, this limitation does not apply to the molecular weight after crosslinking

When the semiconductor nanoparticle-containing composition of the present invention contains the thermopolymerizable compound (C2), from the viewpoint that a viscosity appropriate for a process such as coating as for an ink for a wavelength conversion layer is easily obtained, particularly from the viewpoint that a viscosity appropriate as for an ink for inkjet methods is easily obtained, from the viewpoint that the curability of the semiconductor nanoparticle-containing composition is favorable, and from the viewpoint that the solvent resistance and abrasion resistance of the pixel part (cured product of the semiconductor nanoparticle-containing composition) are enhanced, the content proportion of the thermopolymerizable compound (C2) is preferably 10% by mass or more, more preferably 15% by mass or more, and even more preferably 20% by mass or more, in the total solid content of the semiconductor nanoparticle-containing composition. Furthermore, from the viewpoint that the viscosity of an ink for inkjet methods is not too high and that the thickness of the pixel part is not too thick for the light conversion function, the content proportion is preferably 90% by mass or less, more preferably 80% by mass or less, even more preferably 70% by mass or less, still more preferably 60% by mass or less, and particularly preferably 50% by mass or less, in the total solid content of the semiconductor nanoparticle-containing composition. The above-described upper limits and lower limits can be arbitrarily combined. For example, the content proportion is preferably 10% to 90% by mass, more preferably 10% to 80% by mass, even more preferably 15% to 70% by mass, still more preferably 15% to 60% by mass, and particularly preferably 20% to 50% by mass.

[1-4] Polymerization Initiator (D)

The semiconductor nanoparticle-containing composition of the present invention may further contain a polymerization initiator (D). When the semiconductor nanoparticle-containing composition contains the polymerization initiator (D), the polymerizable compound (C) tends to be easily polymerized.

Examples of the polymerization initiator (D) include a photoradical polymerization initiator (D1), a photocationic polymerization initiator (D2), and a thermopolymerization initiator (D3).

[1-4-1] Photoradical Polymerization Initiator (D1)

Regarding the photoradical polymerization initiator (D1), a molecular cleavage type or hydrogen abstraction type photoradical polymerization initiator is suitable.

Examples of the molecular cleavage type photoradical polymerization initiator include benzoin isobutyl ether, 2,4-diethylthioxanthone, 2-isopropylthioxanthone, 2,4,6-trimethylbenzoyldiphenylphosphine oxide, 2-benzyl-2-dimethylamino-1-(4-morpholinophenyl)-butan-1-one, bis(2,6-dimethoxybenzoyl)-2,4,4-trimethylpentylphosphine oxide, and (2,4,6-trimethylbenzoyl)ethoxyphenylphosphine oxide. Regarding molecular cleavage type photoradical polymerization initiators other than these, for example, 1-hydroxycyclohexyl phenyl ketone, benzoinethyl ether, benzyl dimethyl ketal, 2-hydroxy-2-methyl-1-phenylpropan-1-one, 1-(4-isopropylphenyl)-2-hydroxy-2-methylpropan-1-one, and 2-methyl-1-(4-methylthiophenyl)-2-morpholinopropan-1-one may be used in combination.

Examples of the hydrogen abstraction type photoradical polymerization initiator include benzophenone, 4-phenylbenzophenone, isophthalphenone, and 4-benzoyl-4′-methyl-diphenyl sulfide. A molecular cleavage type photoradical polymerization initiator and a hydrogen abstraction type photoradical polymerization initiator may be used in combination.

A commercially available product can also be used as the photoradical polymerization initiator. Examples of the commercially available product include acylphosphine oxide compounds such as “Omnirad (registered trademark; hereinafter, the same) TPO-H”, “Omnirad TPO-L”, and “Omnirad 819”; alkylphenone compounds such as “Omnirad 651”, “Omnirad 184”, “Omnirad 1173”, “Omnirad 2959”, “Omnirad 127”, “Omnirad 907”, “Omnirad 369”, “Omnirad 369E”, and “Omnirad 379EG” manufactured by IGM Resins B.V.; intramolecular hydrogen abstraction type compounds such as “Omnirad MBF” and “Omnirad 754”; and oxime ester-based compounds such as “Irgacure (registered trademark; hereinafter, the same) OXE01”, “Irgacure OXE02”, “Irgacure OXE03”, and “Irgacure OXE04” manufactured by BASF Japan, Ltd., “TR-PBG-304” and “TR-PBG-305” manufactured by Changzhou Tronly New Electronic Materials Co., Ltd., “NCI-831” and “NCI-930” manufactured by ADEKA Corporation.

In addition to these, examples of other oxime ester-based compounds include oxime ester compounds such as the compounds described in Published Japanese Translation No. 2004-534797 of the PCT International Publication, the compounds described in Japanese Unexamined Patent Application, First Publication No. 2000-80068, the compounds described in PCT International Publication No. WO 2012/45736, the compounds described in PCT International Publication No. WO 2015/36910, the compounds described in Japanese Unexamined Patent Application, First Publication No. 2006-36750, the compounds described in Japanese Unexamined Patent Application, First Publication No. 2008-179611, the compounds described in PCT International Publication No. WO 2009/131189, the compounds described in Published Japanese Translation No. 2012-526185 of the PCT International Publication, the compounds described in Published Japanese Translation No. 2012-519191 of the PCT International Publication, the compounds described in PCT International Publication No. WO 2006/18973, the compounds described in PCT International Publication No. WO 2008/78678, and the compounds described in Japanese Unexamined Patent Application, First Publication No. 2011-132215. From the viewpoint of sensitivity, N-acetoxy-N-{4-acetoxyimino-4-[9-ethyl-6-(o-toluoyl)-9H-carbazol-3-yl]butan-2-yl}acetamide, N-acetoxy-N-{3-(acetoxyimino)-3-[9-ethyl-6-(1-naphthoyl)-9H-carbazol-3-yl]-1-methylpropyl}acetamide, and methyl 4-acetoxyimino-5-[9-ethyl-6-(2-methylbenzoyl)-9H-carbazol-3-yl]-5-oxopentanoate are preferred.

When the semiconductor nanoparticle-containing composition of the present invention contains a photoradical polymerization initiator (D1), from the viewpoint of the curability of the semiconductor nanoparticle-containing composition, the content proportion of the photoradical polymerization initiator (D1) is preferably 0.1 parts by mass or more, more preferably 0.5 parts by mass or more, and even more preferably 1 part by mass or more, with respect to 100 parts by mass of the photopolymerizable compound. Furthermore, from the viewpoint of the stability over time of the pixel part (cured product of the semiconductor nanoparticle-containing composition), the content proportion is preferably 40 parts by mass or less, more preferably 30 parts by mass or less, and even more preferably 20 parts by mass or less, with respect to 100 parts by mass of the photopolymerizable compound. The above-described upper limits and lower limits can be arbitrarily combined. For example, the content proportion is preferably 0.1 to 40 parts by mass, more preferably 0.5 to 30 parts by mass, and even more preferably 1 to 20 parts by mass, with respect to 100 parts by mass of the photopolymerizable compound.

[1-4-2] Photocationic Polymerization Initiator (D2)

Examples of the photocationic polymerization initiator (D2) include polyarylsulfonium salts such as triphenylsulfonium hexafluoroantimonate and triphenylsulfonium hexafluorophosphate; and polyaryliodonium salts such as diphenyliodonium hexafluoroantimonate and P-nonylphenyliodonium hexafluoroantimonate.

A commercially available product can also be used as the photocationic polymerization initiator (D2). Examples of the commercially available product include sulfonium salt-based photocationic polymerization initiators such as “CPI-100P” manufactured by San-Apro, Ltd., “Omnicat (registered trademark; hereinafter, the same) 270” manufactured by IGM Resins B.V., “Irgacure 290” manufactured by BASF Japan, Ltd.; and iodonium salt-based photocationic polymerization initiators such as “Omnicat 250” manufactured by IGM Resins B.V.

When the semiconductor nanoparticle-containing composition of the present invention contains a photocationic polymerization initiator (D2), from the viewpoint of the curability of the semiconductor nanoparticle-containing composition, the content proportion of the photocationic polymerization initiator (D2) is preferably 0.1 parts by mass or more, more preferably 0.5 parts by mass or more, and even more preferably 1 part by mass or more, with respect to 100 parts by mass of the photopolymerizable compound. From the viewpoint of the stability over time of the pixel part (cured product of the semiconductor nanoparticle-containing composition), the content proportion of the photopolymerization initiator is preferably 40 parts by mass or less, more preferably 30 parts by mass or less, and even more preferably 20 parts by mass or less, with respect to 100 parts by mass of the photopolymerizable compound. The above-described upper limits and lower limits can be arbitrarily combined. For example, the content proportion is preferably 0.1 to 40 parts by mass, more preferably 0.5 to 30 parts by mass, and even more preferably 1 to 20 parts by mass, with respect to 100 parts by mass of the photopolymerizable compound.

[1-4-3] Thermopolymerization Initiator (D3)

Examples of the thermopolymerization initiator (D3) that is used for curing a thermopolymerizable compound include 4-methylhexahydrophthalic anhydride, triethylenetetramine, diaminodiphenylmethane, a phenol novolac resin, tris(dimethylaminomethyl)phenol, N,N-dimethylbenzylamine, 2-ethyl-4-methylimidazole, triphenylphosphine, and 3-phenyl-1,1-dimethylurea.

When the semiconductor nanoparticle-containing composition of the present invention contains a thermopolymerization initiator (D3), from the viewpoint of the curability of the semiconductor nanoparticle-containing composition, the content proportion of the thermopolymerization initiator (D3) is preferably 0.1 parts by mass or more, more preferably 0.5 parts by mass or more, and even more preferably 1 part by mass or more, with respect to 100 parts by mass of the thermopolymerizable compound. Furthermore, from the viewpoint of the stability over time of the pixel part (cured product of the semiconductor nanoparticle-containing composition), the content proportion is preferably 40 parts by mass or less, more preferably 30 parts by mass or less, and even more preferably 20 parts by mass or less, with respect to 100 parts by mass of the thermopolymerizable compound. The above-described upper limits and lower limits can be arbitrarily combined. For example, the content proportion is preferably 0.1 to 40 parts by mass, more preferably 0.5 to 30 parts by mass, and even more preferably 1 to 20 parts by mass, with respect to 100 parts by mass of the photopolymerizable compound.

[1-5] Light-Scattering Particles

The semiconductor nanoparticle-containing composition of the present invention of a certain aspect contains light-scattering particles. The semiconductor nanoparticle-containing composition of the present invention of another aspect may further include light-scattering particles.

The light-scattering particles are, for example, optically inert inorganic microparticles. The light-scattering particles can scatter the light from a light source irradiated on the color filter pixel part, and the light emitted by the semiconductor nanoparticles or the coloring matter.

Examples of a material constituting the light-scattering particles include simple metals such as tungsten, zirconium, titanium, platinum, bismuth, rhodium, palladium, silver, tin, and gold; silica, barium sulfate, barium carbonate, calcium carbonate, talc, clay, kaolin, barium sulfate, barium carbonate, calcium carbonate, metal oxides such as alumina white, titanium oxide, magnesium oxide, barium oxide, aluminum oxide, bismuth oxide, zirconium oxide, and zinc oxide; metal carbonates such as magnesium carbonate, barium carbonate, bismuth subcarbonate, and calcium carbonate; metal hydroxides such as aluminum hydroxide; and composite oxides such as barium zirconate, calcium zirconate, calcium titanate, barium titanate, and strontium titanate, and metal salts such as bismuth subnitrate. From the viewpoint of having excellent ejection stability, and from the viewpoint of having a more excellent effect of enhancing the external quantum efficiency, it is preferable that the light-scattering particles include at least one selected from the group consisting of titanium oxide, alumina, zirconium oxide, zinc oxide, calcium carbonate, barium sulfate, and barium titanate, and it is more preferable that the light-scattering particles include at least one selected from the group consisting of titanium oxide, zirconium oxide, zinc oxide, and barium titanate.

The shape of the light-scattering particles may be, for example, a spherical shape, a filamentous shape, or an irregular shape. However, regarding the light-scattering particles, it is preferable to use particles having a particle shape with less directionality (for example, spherical-shaped particles and regular tetrahedral-shaped particles), from the viewpoint that the uniformity, fluidity, and light scattering properties of the semiconductor nanoparticle-containing composition can be further increased and excellent ejection stability can be obtained.

The average particle size (volume mean diameter) of the light-scattering particles in the semiconductor nanoparticle-containing composition is preferably 0.05 μm or more, more preferably 0.2 μm or more, and even more preferably 0.3 μm or more, from the viewpoint of having excellent ejection stability and from the viewpoint of having a more excellent effect of enhancing the external quantum efficiency. Furthermore, the average particle size (volume mean diameter) of the light-scattering particles in the semiconductor nanoparticle-containing composition is preferably 1.0 μm or less, more preferably 0.6 μm or less, and even more preferably 0.4 μm or less, from the viewpoint of having excellent ejection stability. The above-described upper limits and lower limits can be arbitrarily combined. For example, the average particle size is preferably 0.05 to 1.0 μm, more preferably 0.2 to 0.6 μm, and even more preferably 0.3 to 0.4

The average particle size (volume mean diameter) of the light-scattering particles in the semiconductor nanoparticle-containing composition is obtained by making measurement with a dynamic light-scattering Nanotrac particle size distribution meter and calculating the volume mean diameter. Furthermore, when the particle size of the light-scattering particles is measured in the form of a powder, the average particle size (volume mean diameter) of the light-scattering particles used is obtained by, for example, measuring the particle size of each particle using a transmission electron microscope or a scanning electron microscope and calculating the volume mean diameter.

When the semiconductor nanoparticle-containing composition of the present invention includes light-scattering particles, the content of the light-scattering particles is preferably 0.1% by mass or more, more preferably 1% by mass or more, even more preferably 5% by mass or more, still more preferably 7% by mass or more, particularly preferably 10% by mass or more, and most preferably 12% by mass or more, in the total solid content of the semiconductor nanoparticle-containing composition, from the viewpoint of having a more excellent effect of enhancing the external quantum efficiency. Furthermore, from the viewpoint of having excellent ejection stability and from the viewpoint of having a more excellent effect of enhancing the external quantum efficiency, the content is preferably 60% by mass or less, more preferably 50% by mass or less, even more preferably 40% by mass or less, still more preferably 30% by mass or less, particularly preferably 25% by mass or less, and most preferably 20% by mass or less, in the total solid content of the semiconductor nanoparticle-containing composition. The above-described upper limits and lower limits can be arbitrarily combined, and the content is preferably 0.1% to 60% by mass, more preferably 1% to 50% by mass, still more preferably 5% to 40% by mass, still more preferably 7% to 30% by mass, particularly preferably 10% to 25% by mass, and most preferably 12% to 20% by mass.

From the viewpoint of having an excellent effect of enhancing the external quantum efficiency, the mass ratio of the content proportion of the light-scattering particles with respect to the content proportion of the semiconductor nanoparticles (light-scattering particles/semiconductor nanoparticles) may be 0.1 or more, may be 0.2 or more, or may be 0.5 or more. Furthermore, from the viewpoint of having a more excellent effect of enhancing the external quantum efficiency and having excellent suitability for known coating methods and particularly having excellent continuous ejection property (ejection stability) at the time of inkjet printing, the mass ratio may be 5.0 or less, may be 2.0 or less, or may be 1.5 or less. The above-described upper limits and lower limits can be arbitrarily combined. For example, the mass ratio may be 0.1 to 5.0, may be 0.2 to 2.0, or may be 0.5 to 1.5.

The enhancement of the external quantum efficiency by the light-scattering particles is considered to be based on the following mechanism. When the light-scattering particles are not present, it is considered that the light of the backlight merely travels almost straight through the pixel part and has little chance of being absorbed by the semiconductor nanoparticles. On the other hand, when the light-scattering particles are incorporated in the same pixel part with the semiconductor nanoparticles, the light of the backlight is scattered in all directions within the pixel part, the semiconductor nanoparticles can receive the scattered light, and therefore, it is considered that even when the same backlight is used, the amount of light absorption in the pixel part increases. As a result, it is considered that it is possible to prevent leaked light (light from the light source leaking through the pixel part without being absorbed by the semiconductor nanoparticles) by such a mechanism, and the external quantum efficiency can be enhanced.

[1-6] Other Components

The semiconductor nanoparticle-containing composition of the present invention may further contain components other than the semiconductor nanoparticles (A), the coloring matter (B), the polymerizable compound (C), the polymerization initiator (D), and the light-scattering particles. Examples of the other components include a polymer dispersant, a sensitizer, and a solvent.

[Polymer Dispersant]

According to the present invention, a polymer dispersant is a polymer compound having a weight average molecular weight of 750 or more and having a functional group having an adsorption ability toward light-scattering particles, and the polymer dispersant has a function of dispersing light-scattering particles. The polymer dispersant is adsorbed to the light-scattering particles via the functional group having an adsorption ability toward the light-scattering particles, and the light-scattering particles are dispersed in the semiconductor nanoparticle-containing composition by electrostatic repulsion and/or steric repulsion between the polymer dispersant molecules. It is preferable that the polymer dispersant is adsorbed to the light-scattering particles by binding to the surface of the light-scattering particles; however, the polymer dispersant may be adsorbed to the semiconductor nanoparticles by binding to the surface of the semiconductor nanoparticles or may be freely present in the semiconductor nanoparticle-containing composition.

Examples of the functional group having an adsorption ability toward light-scattering particles include an acidic functional group, a basic functional group, and a nonionic functional group. The acidic functional group has a dissociative proton and may be neutralized by a base such as an amine or hydroxide ion, and the basic functional group may be neutralized by an acid such as an organic acid or an inorganic acid.

Examples of the acidic functional group include a carboxyl group (—COOH), a sulfo group (—SO₃H), a sulfate group (—OSO₃H), a phosphono group (—PO(OH)₂), a phosphonooxy group (—OPO(OH)₂), a hydroxyphosphoryl group (—PO(OH)—), and a sulfanyl group (—SH).

Examples of the basic functional group include primary, secondary, and tertiary amino groups, an ammonium group, an imino group, and nitrogen-containing heterocyclic groups such as pyridine, pyrimidine, pyrazine, imidazole, and triazole.

Examples of the nonionic functional group include a hydroxy group, an ether group, a thioether group, a sulfinyl group (—SO—), a sulfonyl group (—SO₂—), a carbonyl group, a formyl group, an ester group, a carbonic acid ester group, an amide group, a carbamoyl group, a ureido group, a thioamide group, a thioureido group, a sulfamoyl group, a cyano group, an alkenyl group, an alkynyl group, a phosphine oxide group, and a phosphine sulfide group.

From the viewpoint of the dispersion stability of the light-scattering particles, from the viewpoint that side effects such as sedimentation of semiconductor nanoparticles are less likely to occur, from the viewpoint of the ease of synthesis of the polymer dispersant, and from the viewpoint of the stability of the functional group, a carboxyl group, a sulfo group, a phosphonic acid group, and a phosphoric acid group are preferably used as the acidic functional group, and an amino group is preferably used as the basic functional group. Among these, a carboxyl group, a phosphonic acid group, and an amino group are more preferably used, and most preferably, an amino group is used.

When the polymer dispersant has an acidic functional group, the acid value of the polymer dispersant is preferably 1 to 150 mg KOH/g. When the acid value is the above-described lower limit value or higher, sufficient dispersibility of the light-scattering particles can be easily obtained, and when the acid value is the above-described upper limit value or lower, the storage stability of the pixel part (cured product of the semiconductor nanoparticle-containing composition) is less likely to be deteriorated.

When the polymer dispersant has a basic functional group, the amine value of the polymer dispersant is preferably 1 to 200 mg KOH/g. When the amine value is the above-described lower limit value or higher, sufficient dispersibility of the light-scattering particles can be easily obtained, and when the amine value is the above-described upper limit value or lower, the storage stability of the pixel part (cured product of the semiconductor nanoparticle-containing composition) is less likely to be deteriorated.

The polymer dispersant may be a polymer of a single monomer (homopolymer) or may be a copolymer of a plurality of kinds of monomers (copolymer). Furthermore, the polymer dispersant may be any of a random copolymer, a block copolymer, or a graft copolymer. When the polymer dispersant is a graft copolymer, it may be a comb-shaped graft copolymer or may be a star-shaped graft copolymer. Examples of the polymer dispersant include an acrylic resin, a polyester resin, a polyurethane resin, a polyamide resin, a polyether, a phenol resin, a silicone resin, a polyurea resin, an amino resin, polyamines such as polyethyleneimine and polyallylamine, an epoxy resin, and a polyimide.

A commercially available product can be used as the polymer dispersant, and as the commercially available product, AJISPER PB series manufactured by Ajinomoto Fine-Techno Co., Inc., DISPERBYK series and BYK-series manufactured by BYK Chemie GmbH, Efka series manufactured by BASF SE, and the like can be used.

As the commercial product, for example, “DISPERBYK (registered trademark; hereinafter, the same)-130”, “DISPERBYK-161”, “DISPERBYK-162”, “DISPERBYK-163”, “DISPERBYK-164”, “DISPERBYK-166”, “DISPERBYK-167”, “DISPERBYK-168”, “DISPERBYK-170”, “DISPERBYK-171”, “DISPERBYK-174”, “DISPERBYK-180”, “DISPERBYK-182”, “DISPERBYK-183”, “DISPERBYK-184”, “DISPERBYK-185”, “DISPERBYK-2000”, “DISPERBYK-2001”, “DISPERBYK-2008”, “DISPERBYK-2009”, “DISPERBYK-2020”, “DISPERBYK-2022”, “DISPERBYK-2025”, “DISPERBYK-2050”, “DISPERBYK-2070”, “DISPERBYK-2096”, “DISPERBYK-2150”, “DISPERBYK-2155”, “DISPERBYK-2163”, “DISPERBYK-2164”, “BYK-LPN21116”, and “BYK-LPN6919” manufactured by BYK Chemie GmbH; “EFKA (registered trademark; hereinafter, the same) 4010”, “EFKA 4015”, “EFKA 4046”, “EFKA 4047”, “EFKA 4061”, “EFKA 4080”, “EFKA 4300”, “EFKA 4310”, “EFKA 4320”, “EFKA 4330”, “EFKA 4340”, “EFKA 4560”, “EFKA 4585”, “EFKA 5207”, “EFKA 1501”, “EFKA 1502”, “EFKA 1503”, and “EFKA PX-4701” manufactured by BASF SE; “SOLSPERSE (registered trademark; hereinafter, the same) 3000”, “SOLSPERSE 9000”, “SOLSPERSE 13240”, “SOLSPERSE 13650”, “SOLSPERSE 13940”, “SOLSPERSE 11200”, “SOLSPERSE 13940”, “SOLSPERSE 16000”, “SOLSPERSE 17000”, “SOLSPERSE 18000”, “SOLSPERSE 20000”, “SOLSPERSE 21000”, “SOLSPERSE 24000”, “SOLSPERSE 26000”, “SOLSPERSE 27000”, “SOLSPERSE 28000”, “SOLSPERSE 32000”, “SOLSPERSE 32500”, “SOLSPERSE 32550”, “SOLSPERSE 32600”, “SOLSPERSE 33000”, “SOLSPERSE 34750”, “SOLSPERSE 35100”, “SOLSPERSE 35200”, “SOLSPERSE 36000”, “SOLSPERSE 37500”, “SOLSPERSE 38500”, “SOLSPERSE 39000”, “SOLSPERSE 41000”, “SOLSPERSE 54000”, “SOLSPERSE 71000”, and “SOLSPERSE 76500” manufactured by Lubrizol Corporation; “AJISPER (registered trademark; hereinafter, the same) PB821”, “AJISPER PB822”, “AJISPER PB881”, “PN411”, and “PA111” manufactured by Ajinomoto Fine-Techno Co., Inc.; “TEGO (registered trademark; hereinafter, the same) Dispers650”, “TEGO Dispers660C”, “TEGO Dispers662C”, “TEGO Dispers670”, “TEGO Dispers685”, “TEGO Dispers700”, “TEGO Dispers710”, and “TEGO Dispers760W” manufactured by Evonik Industries, AG; and “DISPARLON (registered trademark; hereinafter, the same) DA-703-50”, “DA-705”, and “DA-725” manufactured by Kusumoto Chemicals, Ltd. can be used.

Regarding the polymer dispersant, in addition to commercially available products such as described above, for example, a polymer dispersant synthesized by copolymerizing a cationic monomer containing a basic group and/or an anionic monomer having an acidic group, a monomer having a hydrophobic group, and as necessary, another monomer (a nonionic monomer, a monomer having a hydrophilic group, or the like) can be used. Regarding the details of the cationic monomer, the anionic monomer, the monomer having a hydrophobic group, and the other monomer, for example, the monomers described in paragraphs [0034] to [0036] of Japanese Unexamined Patent Application, First Publication No. 2004-250502 can be mentioned.

Regarding the polymer dispersant, for example, a compound obtained by reacting a polyalkyleneimine with a polyester compound as described in Japanese Unexamined Patent Application, First Publication No. S54-37082 and Japanese Unexamined Patent Application, First Publication No. S61-174939; a compound in which an amino group in a side chain of polyallylamine is modified with a polyester as described in Japanese Unexamined Patent Application, First Publication No. H09-169821; a graft polymer having a polyester type macromonomer as a copolymerization component as described in Japanese Unexamined Patent Application, First Publication No. H09-171253; and a polyester polyol-added polyurethane as described in Japanese Unexamined Patent Application, First Publication No. S60-166318, may be suitably mentioned.

From the viewpoint of being capable of favorably dispersing light-scattering particles and further enhancing the effect of enhancing the external quantum efficiency, the weight average molecular weight of the polymer dispersant is preferably 750 or more, more preferably 1000 or more, even more preferably 2000 or more, and particularly preferably 3000 or more. Furthermore, from the viewpoint of being capable of favorably dispersing light-scattering particles and further enhancing the effect of enhancing the external quantum efficiency, and obtaining a viscosity appropriate for known coating methods, particularly adjusting the viscosity of an ink for inkjet methods to a viscosity that is ejectable and appropriate for stable ejection, the weight average molecular weight is preferably 100000 or less, more preferably 50000 or less, and even more preferably 30000 or less. The above-described upper limits and lower limits can be arbitrarily combined. For example, the weight average molecular weight is preferably 750 to 100000, more preferably 1000 to 100000, even more preferably 2000 to 50000, and particularly preferably 3000 to 30000.

When the semiconductor nanoparticle-containing composition of the present invention contains a polymer dispersant, from the viewpoint of the dispersibility of the light-scattering particles, the content proportion of the polymer dispersant is preferably 0.5 parts by mass or more, more preferably 2 parts by mass or more, and even more preferably 5 parts by mass or more, with respect to 100 parts by mass of the light-scattering particles. Furthermore, from the viewpoint of the moist heat stability of the pixel part (cured product of the semiconductor nanoparticle-containing composition), the content proportion is preferably 50 parts by mass or less, more preferably 30 parts by mass or less, and even more preferably 10 parts by mass or less, with respect to 100 parts by mass of the light-scattering particles. The above-described upper limits and lower limits can be arbitrarily combined. For example, the content proportion is preferably 0.5 to 50 parts by mass, more preferably 2 to 30 parts by mass, and even more preferably 5 to 10 parts by mass, with respect to 100 parts by mass of the light-scattering particles.

[Sensitizer]

The sensitizer means a component capable of initiating a polymerization reaction by absorbing light having a wavelength longer than the light absorbed by a photopolymerization initiator and transferring the absorbed energy to the photopolymerization initiator. When the semiconductor nanoparticle-containing composition contains a sensitizer, for example, there is a tendency that the composition can utilize h-rays, which are relatively less absorbed by semiconductor nanoparticles, as the wavelength at the time of curing.

As the sensitizer, an amine that does not cause an addition reaction with the photopolymerizable compound can be used. Examples of the sensitizer include trimethylamine, methyldimethanolamine, triethanolamine, p-diethylaminoacetophenone, ethyl p-dimethylaminobenzoate, isoamyl p-dimethylaminobenzoate, N, N-dimethylbenzylamine, and 4,4′-bis(diethylamino)benzophenone.

[Solvent]

The semiconductor nanoparticle-containing composition of the present invention may include a solvent from the viewpoints of coatability and handleability.

Examples of the solvent include ethylene glycol monobutyl ether acetate, diethylene glycol monobutyl ether acetate, diethylene glycol monoethyl ether acetate, diethylene glycol dibutyl ether, diethyl adipate, dibutyl oxalate, dimethyl malonate, diethyl malonate, dimethyl succinate, diethyl succinate, 1,4-butanediol diacetate, and glyceryl triacetate.

The boiling point of the solvent is preferably 50° C. or higher from the viewpoint of suitability for known coating methods, and particularly preferably 180° C. or higher from the viewpoint of continuous ejection stability of an ink for an inkjet method. Furthermore, at the time of forming the pixel part, since it is necessary to remove the solvent from the semiconductor nanoparticle-containing composition before curing of the semiconductor nanoparticle-containing composition, from the viewpoint of easily removing the solvent, it is preferable that the boiling point of the solvent is 300° C. or lower. The above-described upper limits and lower limits can be arbitrarily combined. For example, the boiling point is preferably 50° C. to 300° C., and more preferably 180° C. to 300° C.

When the semiconductor nanoparticle-containing composition of the present invention includes a solvent, the content proportion thereof is not particularly limited; however, the content proportion is preferably 0.001% by mass or more, more preferably 0.01% by mass or more, even more preferably 0.1% by mass or more, still more preferably 1% by mass or more, even more preferably 10% by mass or more, still more preferably 20% by mass or more, particularly preferably 30% by mass or more, and is preferably 90% by mass or less, more preferably 80% by mass or less, and even more preferably 70% by mass or less, in the semiconductor nanoparticle-containing composition. When the content proportion is set to the above-described lower limit value or more, there is a tendency that the viscosity of the composition tends to be reduced, and the suitability for known coating methods, particularly inkjet ejection, is facilitated. Furthermore, when the content proportion is set to the above-described upper limit value or less, there is a tendency that the suitability for known coating methods, particularly the thickness of the film after ejection and removal of the solvent becomes thicker, a film including more semiconductor nanoparticles can be formed, and thereby a pixel part having high luminescence intensity can be obtained. The above-described upper limits and lower limits can be arbitrarily combined. For example, the content proportion is preferably 0.001% to 90% by mass, more preferably 0.1% to 80% by mass, and even more preferably 1% to 70% by mass.

In the semiconductor nanoparticle-containing composition of the present invention, it is also possible to disperse light-scattering particles and semiconductor nanoparticles without a solvent, by using a polymerizable compound that functions as a dispersion medium. In this case, there is an advantage that the step of removing the solvent by drying when forming the pixel part, is unnecessary.

[2] Physical Properties of Semiconductor Nanoparticle-Containing Composition

The viscosity at 40° C. of the semiconductor nanoparticle-containing composition of the present invention is not particularly limited; however, for example, from the viewpoint of the suitability for known coating methods, particularly ejection stability during inkjet printing, the viscosity is preferably 2 mPa·s or higher, more preferably 5 mPa·s or higher, and even more preferably 7 mPa s or higher, and is preferably 20 mPa·s or less, more preferably 15 mPa s or less, and even more preferably 12 mPa·s or less. The viscosity of the semiconductor nanoparticle-containing composition is measured by using an E type viscometer. The above-described upper limits and lower limits can be arbitrarily combined. For example, the viscosity is preferably 2 to 20 mPa·s, more preferably 5 to 15 mPa·s, and even more preferably 7 to 12 mPa·s.

The viscosity at 23° C. of the semiconductor nanoparticle-containing composition of the present invention is not particularly limited; however, for example, from the viewpoint of the suitability for known coating methods, particularly ejection stability during inkjet printing, the viscosity is preferably 5 mPa s or higher, more preferably 10 mPa·s or higher, and even more preferably 15 mPa s or higher, and is preferably 40 mPa·s or less, more preferably 35 mPa·s or less, even more preferably 30 mPa·s or less, and particularly preferably 25 mPa·s or less. The above-described upper limits and lower limits can be arbitrarily combined. For example, the viscosity is preferably 5 to 40 mPa·s, more preferably 5 to 35 mPa·s, even more preferably 10 to 30 mPa·s, and particularly preferably 15 to 25 mPa·s.

The surface tension of the semiconductor nanoparticle-containing composition of the present invention is not particularly limited; however, it is preferable that the surface tension is a surface tension appropriate for the suitability for known coating methods, particularly an inkjet method, and specifically, the surface tension is preferably in the range of 20 to 40 mN/m, and more preferably in the range of 25 to 35 mN/m. By adjusting the surface tension to be within the above-described range, the occurrence of flight bending can be suppressed. Flight bending means that when the semiconductor nanoparticle-containing composition is ejected through ink ejection holes, the landing position of the semiconductor nanoparticle-containing composition deviates from the target position by 30 μm or more.

[3] Method for Producing Semiconductor Nanoparticle-Containing Composition

The semiconductor nanoparticle-containing composition can be produced by, for example, a method including a step of mixing semiconductor nanoparticles (A) and a coloring matter (B), as well as optionally a polymerizable compound (C) and a polymerization initiator (D), such that the content of the semiconductor nanoparticles (A) is 5% to 50% by mass in the total solid content of the semiconductor nanoparticle-containing composition. For example, a semiconductor nanoparticle-containing composition is obtained by mixing the above-mentioned constituent components of the semiconductor nanoparticle-containing composition.

When the semiconductor nanoparticle-containing composition includes light-scattering particles, the semiconductor nanoparticle-containing composition can be produced by, for example, a method including a step of preparing a semiconductor nanoparticle dispersion including semiconductor nanoparticles (A) and a coloring matter (B) as well as optionally a polymerizable compound (C); a step of preparing a light-scattering particle dispersion including light-scattering particles and optionally a polymerizable compound (C); and a step of mixing the semiconductor nanoparticle dispersion with the light-scattering particle dispersion. When a polymerization initiator (D) is used for this production method, the polymerization initiator (D) may be blended so as to be included in a mixture obtainable by mixing the semiconductor nanoparticle dispersion and the light-scattering particle dispersion. Therefore, the polymerization initiator (D) may be included in either or both of the semiconductor nanoparticle dispersion and the light-scattering particle dispersion, and when the semiconductor nanoparticle dispersion, the light-scattering particle dispersion, and the polymerization initiator (D) are mixed, the polymerization initiator (D) does not have to be included in either the semiconductor nanoparticle dispersion or the light-scattering particle dispersion.

When the polymerizable compound (C) is used, according to this production method, since the semiconductor nanoparticles (A) and the light-scattering particles are dispersed in the polymerizable compound (C) before being mixed with each other, the semiconductor nanoparticles (A) and the light-scattering particles can be sufficiently dispersed, and there is a tendency that excellent ejection stability and excellent external quantum efficiency can be easily obtained.

In the step of preparing the semiconductor nanoparticle dispersion, the semiconductor nanoparticle dispersion may be prepared by mixing the semiconductor nanoparticles (A) and the coloring matter (B) with the polymerizable compound (C). Regarding the semiconductor nanoparticles (A), semiconductor nanoparticles having an organic ligand on the surface thereof may be used. The mixing treatment may be performed by using an apparatus such as a paint conditioner, a planetary stirrer, a stirrer, an ultrasonic dispersing apparatus, or a mix rotor. From the viewpoint that the dispersibility of the semiconductor nanoparticles (A) and the coloring matter (B) is favorable and high optical characteristics are obtained, it is preferable to use a stirrer, an ultrasonic dispersing apparatus, and a mix rotor.

In the step of preparing the light-scattering particle dispersion, the light-scattering particle dispersion may be prepared by mixing the light-scattering particles and the polymerizable compound (C) and performing a dispersing treatment. The mixing and dispersing treatment may be performed by using the same apparatus as that used in the step of preparing the semiconductor nanoparticle dispersion. From the viewpoint that the dispersibility of the light-scattering particles is favorable and the average particle size of the light-scattering particles is easily adjusted to a desired range, it is preferable to use a bead mill or a paint conditioner.

In the step of preparing the light-scattering particle dispersion, a polymer dispersant may be further mixed. That is, the light-scattering particle dispersion may further include a polymer dispersant. By mixing the light-scattering particles and the polymer dispersant before mixing the semiconductor nanoparticles (A) and the light-scattering particles, the light-scattering particles can be more sufficiently dispersed. Therefore, excellent ejection stability and excellent external quantum efficiency can be obtained more easily.

In this production method, components (for example, a sensitizer and a solvent) other than the semiconductor nanoparticles (A), the coloring matter (B), the light-scattering particles, as well as the polymerizable compound (C), the polymerization initiator (D), and the polymer dispersant used as needed may be further used. In this case, the other components may be contained in the semiconductor nanoparticle dispersion or may be contained in the light-scattering particle dispersion. Furthermore, the other components may also be mixed into a composition obtained by mixing a semiconductor nanoparticle dispersion and a light-scattering particle dispersion.

[4] Wavelength Conversion Layer

The wavelength conversion layer of the present invention is a layer obtainable by curing the semiconductor nanoparticle-containing composition of the present invention and is a layer that contains at least the semiconductor nanoparticles (A) and the coloring matter (B) and converts the wavelength of light from an excitation source. The form of the wavelength conversion layer is not particularly limited and may be, for example, a sheet shape or any shape such as a patterned bar shape as is the case of a pixel part of a color filter that will be described later.

[5] Light Conversion Layer and Color Filter

The color filter of the present invention has a pixel part obtained by curing the semiconductor nanoparticle-containing composition of the present invention. The details of the color filter of the present invention will be described with reference to the drawings. In the following description, an identical reference numeral will be used for identical or equivalent elements, and duplicate description will not be repeated.

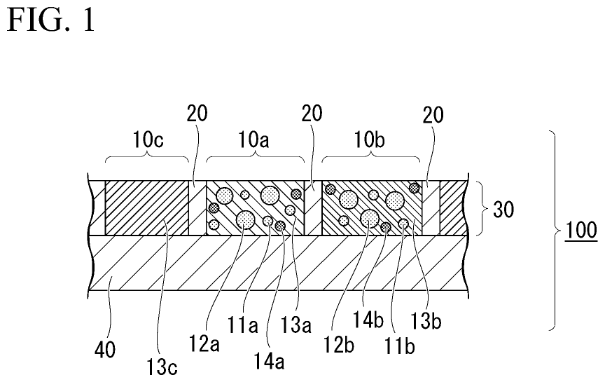

FIG. 1 is a schematic cross-sectional view of a color filter of an embodiment. As shown in FIG. 1, the color filter 100 includes a base material 40 and a light conversion layer 30 provided on the base material 40. The light conversion layer 30 includes a plurality of pixel parts 10 (first pixel part 10a, second pixel part 10b, and third pixel part 10c) and a light-shielding part 20.

The light conversion layer 30 has a first pixel part 10a, a second pixel part 10b, and a third pixel part 10c as the pixel part 10. The first pixel part 10a, the second pixel part 10b, and the third pixel part 10c are arranged in a grid pattern such that the pixel parts are repeated in this order. The light-shielding part 20 is located between adjoining pixel parts, that is, between the first pixel part 10a and the second pixel part 10b, between the second pixel part 10b and the third pixel part 10c, and between the third pixel part 10c and the first pixel part 10a. In other words, these adjoining pixel parts are separated from each other by the light-shielding part 20.

The first pixel part 10a and the second pixel part 10b each include a cured product of the above-mentioned semiconductor nanoparticle-containing composition of the present invention. The cured product contains semiconductor nanoparticles, a coloring matter, light-scattering particles, and a cured component. The cured component is a cured product of a polymerizable compound and is specifically a cured product obtained by polymerizing a polymerizable compound. That is, the first pixel part 10a includes a first cured component 13a; and first semiconductor nanoparticles 11a, first light-scattering particles 12a, and a first coloring matter 14a, each dispersed in the first cured component 13a. Similarly, the second pixel part 10b includes a second cured component 13b; and second semiconductor nanoparticles 11b, second light-scattering particles 12b, and a second coloring matter 14b, each dispersed in the second cured component 13b. In the first pixel part 10a and the second pixel part 10b, the first cured component 13a and the second cured component 13b may be identical or different, the first light-scattering particles 12a and the second light-scattering particles 12b may be identical or different, and the first coloring matter 14a and the second coloring matter 14b may be identical or different.

The first semiconductor nanoparticles 11a are red light-emitting semiconductor nanoparticles that absorb light having a wavelength in the range of 420 to 480 nm and emit light having an emission peak wavelength in the range of 605 to 665 nm. That is, the first pixel part 10a may be paraphrased as a red pixel part for converting blue light into red light. Furthermore, the second semiconductor nanoparticles 11b are green light-emitting semiconductor nanoparticles that absorb light having a wavelength in the range of 420 to 480 nm and emit light having an emission peak wavelength in the range of 500 to 560 nm. That is, the second pixel part 10b may be paraphrased as a green pixel part for converting blue light into green light.

The third pixel part 10c has a transmittance of 30% or higher to light having a wavelength in the range of 420 to 480 nm. Therefore, the third pixel part 10c functions as a blue pixel part when a light source that emits light having a wavelength in the range of 420 to 480 nm is used. The third pixel part 10c includes, for example, a cured product of the composition containing the above-mentioned polymerizable compound. The cured product contains a third cured component 13c. The third cured component 13c is a cured product of the polymerizable compound and is specifically a cured product obtained by polymerizing the polymerizable compound. That is, the third pixel part 10c includes the third cured component 13c. When the third pixel part 10c includes the above-mentioned cured product, the composition containing the polymerizable compound may further contain components other than the polymerizable compound among the above-mentioned components contained in the semiconductor nanoparticle-containing composition, as long as the transmittance to light having a wavelength in the range of 420 to 480 nm is 30% or higher. The transmittance of the third pixel part 10c can be measured by a microspectroscopic apparatus.

The thickness of the pixel parts (first pixel part 10a, second pixel part 10b, and third pixel part 10c) is not particularly limited; however, for example, the thickness is preferably 1 μm or more, more preferably 2 μm or more, and even more preferably 3 μm or more. The thickness of the pixel parts (first pixel part 10a, second pixel part 10b, and third pixel part 10c) is, for example, preferably 30 μm or less, more preferably 20 μm or less, and even more preferably 15 μm or less. The above-described upper limits and lower limits can be arbitrarily combined. For example, the thickness is preferably 1 to 30 μm, more preferably 2 to 20 μm, and even more preferably 3 to 15 mm.

The light-shielding part 20 is a so-called black matrix provided for the purpose of separating adjoining pixel parts to prevent color mixing and for the purpose of preventing light leakage from the light source. The material constituting the light-shielding part 20 is not particularly limited, and in addition to a metal such as chromium, a cured product of a resin composition obtained by incorporating light-shielding particles such as carbon microparticles, a metal oxide, an inorganic pigment, or an organic pigment in a binder polymer, or the like can be used. Here, regarding the binder polymer, for example, one kind or a mixture of two or more kinds of resins such as a polyimide resin, an acrylic resin, an epoxy resin, a polyacrylamide, a polyvinyl alcohol, gelatin, casein, and cellulose, a photosensitive resin, and an 01W emulsion type resin composition (for example, an emulsion of reactive silicone) can be used. The thickness of the light-shielding part 20 is preferably, for example, 0.5 μm to 10 μm or less.

The base material 40 is a transparent base material having optical transparency, and for example, transparent glass substrates such as quartz glass, PYREX (registered trademark) glass, and a synthetic quartz plate; and transparent flexible base materials such as a transparent resin film and an optical resin film can be used. Among these, it is preferable to use a glass substrate made of an alkali-free glass that does not include any alkali component in glass. Specifically, examples include “7059 Glass”, “1737 Glass”, “Eagle 200”, and “Eagle XG” manufactured by Corning, Inc.; “AN100” manufactured by AGC, Inc.; and “OA-10G” and “OA-11” manufactured by Nippon Electric Glass Co., Ltd. These are materials having small thermal expansion coefficients and are excellent in view of dimensional stability and workability in high-temperature heat treatment.

The color filter 100 provided with the above-described light conversion layer 30 is suitably used when an excitation light source that emits light having a wavelength in the range of 420 to 480 nm is used.

The wavelength region of the light emitted by the excitation light source is not limited to the above-described range. In the light conversion layer of the present invention, since it is considered that the excited energy of the coloring matter (B1) is transferred to the semiconductor nanoparticles (A) by Forster-type energy transfer, and the luminescence intensity of the semiconductor nanoparticles (A) is increased, there is a possibility for any light in the wavelength region that can be absorbed by the coloring matter (B1), to be used as the excitation light.

The color filter 100 can be produced by, for example, a method of forming a light-shielding part 20 in a patterned form on the base material 40, selectively attaching the above-mentioned semiconductor nanoparticle-containing composition by an inkjet method to a pixel part-forming region partitioned by the light-shielding part 20 on the base material 40, and curing the semiconductor nanoparticle-containing composition by irradiation with active energy rays.

As a method for forming the light-shielding part 20, for example, a method of forming a metal thin film such as chromium or a thin film of a resin composition containing light-shielding particles in a region serving as a boundary between a plurality of pixel parts on one surface side of the base material 40, and patterning this thin film, may be mentioned. The metal thin film can be formed by, for example, a sputtering method or a vacuum vapor deposition method, and the thin film of the resin composition containing the light-shielding particles can be formed by, for example, coating or printing. Regarding the method for performing patterning, for example, a photolithography method may be mentioned.

Examples of the inkjet method include a BUBBLEJET (registered trademark) method of using an electro-thermal converter as an energy generating element, and a piezojet method of using a piezoelectric element.

When curing of the semiconductor nanoparticle-containing composition is cured by irradiation with active energy rays (for example, ultraviolet radiation), for example, a mercury lamp, a metal halide lamp, a xenon lamp, or an LED may be used. The wavelength of the light to be irradiated may be, for example, 200 nm or more and may be 440 nm or less. The amount of exposure is preferably, for example, 10 to 4000 mJ/cm².

When the semiconductor nanoparticle-containing composition includes a solvent, a drying treatment is performed in order to volatilize the solvent. Examples of the drying treatment include vacuum drying and heat drying. When heat drying is performed, the drying temperature for volatilizing the solvent may be, for example, 50° C. to 150° C., and the drying time may be, for example, 3 to 30 minutes.

[6] Image Display Device

An image display device of the present invention has the color filter of the present invention.

Examples of the image display device include a liquid crystal display device and an image display device including an organic electroluminescent element.

Regarding the liquid crystal display device, for example, a light source provided with a blue LED and a liquid crystal layer including electrodes for controlling blue light emitted from the light source in each and every pixel part, may be mentioned.

Regarding the image display device including the organic electroluminescent element, for example, an image display device in which an organic electroluminescent element that emits blue light is disposed at a position corresponding to each pixel part of the color filter, may be mentioned.

### EXAMPLES

Hereinafter, the present invention will be specifically described by way of Examples; however, the present invention is not limited to the following Examples as long as the gist thereof is maintained.

1. Experiment A

The light-scattering particle dispersion was prepared as follows.

3.20 parts by mass of PT-401M (manufactured by Ishihara Sangyo Kaisha, Ltd.) as titanium oxide, 0.76 parts by mass of an acrylic block-based dispersant (amine value 29 mg KOH/g, a propylene glycol monomethyl ether acetate solution having a solid content concentration of 40% by mass), 6.04 parts by mass of toluene as a solvent, and 20 parts by mass of zirconia beads having a diameter of 0.3 mm were charged into a container and dispersed in a paint shaker for 6 hours. After completion of dispersing, the beads and the dispersion were separated by filtration to prepare a light-scattering particle dispersion.

The emission spectra of compositions produced in Examples and Comparative Examples that will be described later were measured as follows.

Each composition was introduced into a glass cell having a gap of 4 μm (S-0088-4-N-W manufactured by Sun Trading Co., Ltd.), subsequently the glass cell was installed in an integrating sphere, the sample was irradiated by using a laser diode having a wavelength of 445 nm (SU-61C-445-50 manufactured by Audio-Technica Corporation) as a light source, and the emission spectrum was measured by using a spectrometric apparatus (manufactured by Spectra Co-op Co., Ltd. (Solid Lambda CCD UV-NIR). The light in the integrating sphere was guided to the spectrometric apparatus by using an optical fiber.

The coloring matters used in Examples and Comparative Examples that will be described later are shown in Table 1.

TABLE 1

| | |
|---|---|
| B1-1 | 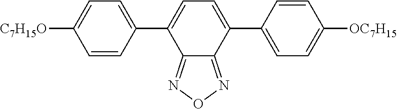 |
| B1-2 | 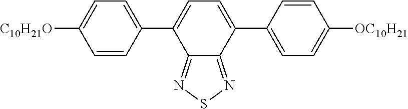 |

In Table 1, C₇H₁₅ is n-heptyl, and C₁₀H₂₁ is n-decyl.

Coloring matter B1-1 was synthesized by the method described in Japanese Patent Publication No. 5691235.

Coloring matter B1-2 was synthesized by the method described in Japanese Unexamined Patent Application, First Publication No. 2003-104976.

### Example A1

To 118 mg of a 30% by mass toluene solution of InP/ZnSeS/ZnS semiconductor nanoparticles (maximum emission wavelength over the wavelength range of 300 to 780 nm: 630 nm (excitation of a wavelength of 445 nm), having oleic acid as a ligand), 2 mg of pentaerythritol tetrakis(3-mercaptobutyrate) (manufactured by Showa Denko K.K., trade name “Karenz MT-PE1”), 3 mg of coloring matter B1-1, and 28 mg of a light-scattering particle dispersion were added, and the mixture was mixed with a vortex mixer to obtain composition A1.

### Example A2

The process was carried out in the same manner as in Example A1, except that coloring matter B1-2 was used instead of coloring matter B1-1, and composition A2 was obtained.

### Comparative Example A1

The process was carried out in the same manner as in Example A1, except that coloring matter B1-1 was not added, and composition A3 was obtained.

### Comparative Example A2

The process was carried out in the same manner as in Example A1, except that InP/ZnSeS/ZnS semiconductor nanoparticles were not added, and composition A4 was obtained.

### Comparative Example A3

The process was carried out in the same manner as in Example A2, except that InP/ZnSeS/ZnS semiconductor nanoparticles were not added, and composition A5 was obtained.

Table 2 shows the results of the relative value of the luminescence intensity (wavelength 630 nm) of each composition when the luminescence intensity of the composition of Comparative Example A1 was taken as 1.00, and the maximum emission wavelength (wavelength in the range of 300 to 780 nm) of each composition.

TABLE 2

| | | | | Relative | |
|---|---|---|---|---|---|
| | | | | value of | |
| | | | | lumines- | |
| | | | | cence | Maximum |
| | | Semi- | | intensity | emission |
| | | conductor | Color- | (wave- | wave- |
| | Compo- | nano- | ing | length | length |
| | sition | particles | matter | 630 nm) | (nm) |
| Example A1 | A1 | InP/ZnSeS/ | B1-1 | 1.35 | 630 |
| | | ZnS | | | |
| Example A2 | A2 | InP/ZnSeS/ | B1-2 | 1.22 | 630 |
| | | ZnS | | | |
| Comparative | A3 | InP/ZnSeS/ | None | 1.00 | 630 |
| Example A1 | | ZnS | | | |
| Comparative | A4 | None | B1-1 | 0.19 | 533 |
| Example A2 | | | | | |
| Comparative | A5 | None | B1-2 | 0.12 | 539 |
| Example A3 | | | | | |

From Table 2, compositions in which semiconductor nanoparticles whose maximum emission wavelength in the wavelength range of 300 nm to 780 nm is in the range of 500 to 670 nm, and a coloring matter (B1) having a partial structure represented by the above-described Formula [I] were used in combination (Examples A1 and A2), had higher luminescence intensity at a wavelength of 630 nm as compared with compositions containing each of them alone (Comparative Examples A1 to A3).

This is speculated that as the overlap between the emission spectrum derived from the partial structure represented by the Formula [I] of the coloring matter (B1) and the absorption spectrum of the semiconductor nanoparticles having a maximum emission wavelength of 500 to 670 nm was larger, the excited energy of the coloring matter (B1) was transferred to the semiconductor nanoparticles by Förster-type energy transfer, and the luminescence intensity of the semiconductor nanoparticles was increased. Furthermore, it is speculated that the lone electron pair on the N atom of the diazole part in Formula [1] of the coloring matter (B1) interacted with the surface of the semiconductor nanoparticles, and the distance between the coloring matter and the semiconductor nanoparticles was shortened, whereby the efficiency of the Forster-type energy transfer was further increased.

Particularly, in the coloring matters B1-1 and B1-2, since the end of the linking bond in Formula [I] was an aromatic ring, and the planarity of the molecular structure was decreased due to the steric hindrance between the lone electron pair in the diazole part and the hydrogen atoms of the adjoining aromatic ring, aggregates of coloring matter molecules caused by π-π stacking or the like are less likely to be formed. Therefore, since a decrease in the fluorescence intensity (concentration quenching) caused by the formation of aggregates is less likely to occur, the excited energy of the coloring matter (B1) was transferred to the semiconductor nanoparticles by the Forster-type energy transfer, so that the luminescence intensity of the semiconductor nanoparticles was further increased.

2. Experiment B

The light-scattering particle dispersion was prepared as follows.

2.53 parts by mass of PT-401M (manufactured by Ishihara Sangyo Kaisha, Ltd.) as titanium oxide, 0.24 parts by mass of DISPERBYK-111 (manufactured by BYK Chemie GmbH) as a dispersant, 7.25 parts by mass of 1,6-hexanediol diacrylate, and 20 parts by mass of zirconia beads having a diameter of 0.3 mm were charged into a container, and the mixture was dispersed in a paint shaker for 6 hours. After completion of dispersing, the beads and the dispersion were separated by filtration to prepare a light-scattering particle dispersion.

The emission spectra of the compositions produced in Examples and Comparative Examples that will be described later were measured in the same manner as in Experiment A.

The chemical structure of the coloring matter (C-Naphox-TEG (manufactured by Tokyo Chemical Industry Co., Ltd.)) used in Examples and Comparative Examples that will be described later is shown below.

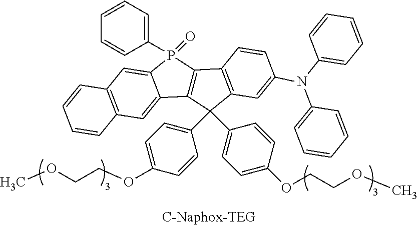

### Example B1

To 80 mg of a 1,6-hexanediol diacrylate solution (content proportion of the semiconductor nanoparticles was 50% by mass) of InP/ZnSeS/ZnS semiconductor nanoparticles (maximum emission wavelength over the wavelength range of 300 to 780 nm: 630 nm (excitation of a wavelength of 445 nm), having [2-(2-methoxyethoxy)ethoxy]acetic acid as a ligand), 2 mg of C-Naphox-TEG (manufactured by Tokyo Chemical Industry Co., Ltd.) was added, and the mixture was heated and mixed with a hot stirrer at 95° C. for 1 hour. Subsequently, 1 mg of pentaerythritol tetrakis(3-mercaptobutyrate) (manufactured by Showa Denko K.K., KARENZ MT-PE1) and 24 mg of a light-scattering particle dispersion were added and mixed thereto with a vortex mixer, and composition B1 was obtained.

### Comparative Example B1

The process was carried out in the same manner as in Example B1, except that C-Naphox-TEG was not added, and composition B2 was obtained.

### Comparative Example B2

The process was carried out in the same manner as in Example B1, except that the 1,6-hexanediol diacrylate solution of InP/ZnSeS/ZnS semiconductor nanoparticles was not added, and composition B3 was obtained.

Table 3 shows the results of the relative value of the luminescence intensity (wavelength 630 nm) of each composition when the luminescence intensity of the composition of Comparative Example B1 was taken as 1.00, and the maximum emission wavelength (wavelength in the range of 300 to 780 nm) of each composition.

TABLE 3

| | | | | Relative | |
|---|---|---|---|---|---|
| | | | | value of | |
| | | | | lumines- | |
| | | | | cence | Maximum |
| | | Semi- | | intensity | emission |
| | | conductor | | (wave- | wave- |
| | Compo- | nano- | Coloring | length | length |
| | sition | particles | matter | 630 nm) | (nm) |
| Example B1 | B1 | InP/ZnSeS/ | C-Naphox- | 1.29 | 630 |
| | | ZnS | TEG | | |
| Comparative | B2 | InP/ZnSeS/ | None | 1.00 | 630 |
| Example B1 | | ZnS | | | |
| Comparative | B3 | None | C-Naphox- | 0.21 | 535 |
| Example B2 | | | TEG | | |

From Table 3, a composition in which semiconductor nanoparticles whose maximum emission wavelength in the wavelength range of 300 nm to 780 nm is in the range of 500 to 670 nm, and a coloring matter (B2) represented by the above-described Formula [II] were used in combination (Example B1), had higher luminescence intensity at a wavelength of 630 nm as compared with compositions containing each of them alone (Comparative Examples B1 B2).

The reason why the luminescence intensity of the semiconductor nanoparticles increased in Example B1 may be that the excited energy of the coloring matter (B2) was transferred to the semiconductor nanoparticles (A) by Forster-type energy transfer. Particularly, the following three points may be mentioned as the reason why Forster-type energy transfer is likely to occur in the coloring matter (B2).

First, it is speculated that as the overlap between the emission spectrum derived from the phosphole oxide part of the coloring matter (B2), Ar¹, Ar², and Ar³, and the absorption spectrum of the semiconductor nanoparticles having a maximum emission wavelength of 500 to 670 nm was larger, the excited energy of the coloring matter (B2) was transferred to the semiconductor nanoparticles by Forster-type energy transfer, and the luminescence intensity of the semiconductor nanoparticles was increased.

Secondly, it is speculated that due to the steric hindrance caused by R¹ and R² of the coloring matter (B2), aggregates of the coloring matter (B2) molecules caused by π-π stacking or the like are less likely to be formed. Therefore, since a decrease in the fluorescence intensity (concentration quenching) caused by the formation of aggregates is less likely to occur, the excited energy of the coloring matter (B2) was transferred to the semiconductor nanoparticles by the Forster-type energy transfer, so that the luminescence intensity of the semiconductor nanoparticles was increased.

Thirdly, it is speculated that the phosphine oxide moiety of the coloring matter (B2) is coordinated to the surface of the semiconductor nanoparticles (A), and the distance between the coloring matter (B2) and the semiconductor nanoparticles (A) is closer.

3. Experiment C

A light-scattering particle dispersion was prepared in the same manner as in Experiment A.

The emission spectra of the compositions produced in Examples and Comparative Examples that will be described later were measured in the same manner as in Experiment A.

Coloring matter B3-1 used in the Examples and Comparative Examples that will be described later was synthesized as follows.

A mixture of an acid anhydride (9.87 g, 25.2 mmol), 1,8-diazabicyclo[5.4.0]-7-undecene (15.2 ml, 100 mmol), 2-ethyl-1-hexanol (21 ml, 134 mmol), 2-ethylhexyl bromide (14 ml, 81.2 mmol), and N,N-dimethylformamide (200 ml) was stirred at 70° C. for 10 hours. After cooling to room temperature, the mixture was poured into ice water, extracted with toluene, and concentrated under reduced pressure. The resultant was purified by silica gel column chromatography to obtain 15.3 g of coloring matter B3-1.

The total degree of branching of the coloring matter B3-1 is 4.

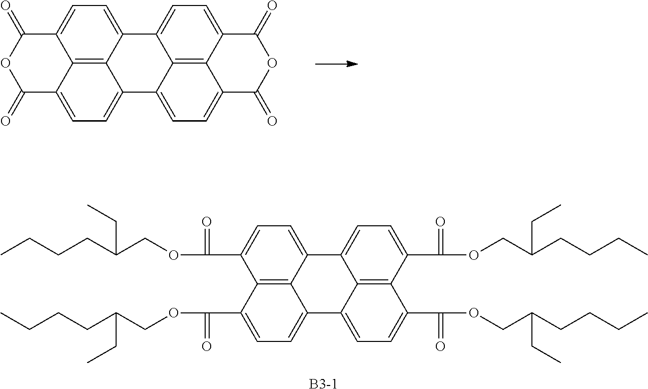

As coloring matter B3-2 in the Comparative Examples that will be described later, Lumogen F Yellow 083 manufactured by BASF SE, which is represented by the following formula, was used.

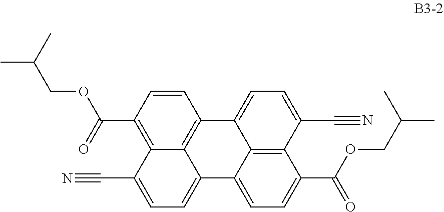 [SMILES: CC(C)COC(=O)c1ccc2c3ccc(C#N)c4c(C(=O)OCC(C)C)ccc(c5ccc(C#N)c1c52)c43]

The total degree of branching of the coloring matter B3-2 is 2.

### Example C1

To 118 mg of a 30% by mass toluene solution of InP/ZnSeS/ZnS semiconductor nanoparticles (maximum emission wavelength over the wavelength range of 300 to 780 nm: 630 nm (excitation of a wavelength of 445 nm), having oleic acid as a ligand), 2 mg of pentaerythritol tetrakis(3-mercaptobutyrate) (manufactured by Showa Denko K.K., trade name “Karenz MT-PE1”), 3 mg of coloring matter B3-1, and 28 mg of a light-scattering particle dispersion were added, and the mixture was mixed with a vortex mixer to obtain composition C1.

### Comparative Example C1

The process was carried out in the same manner as in Example C1, except that coloring matter B3-1 was not added, and composition C2 was obtained.

### Comparative Example C2

The process was carried out in the same manner as in Example C1, except that InP/ZnSeS/ZnS semiconductor nanoparticles were not added, and composition C3 was obtained.

### Comparative Example C3

The process was carried out in the same manner as in Example C1, except that coloring matter B3-2 was used instead of coloring matter B3-1, and composition C4 was obtained.

### Comparative Example C4

The process was carried out in the same manner as in Comparative Example C2, except that coloring matter B3-2 was used instead of coloring matter B3-1, and composition C5 was obtained.

<Measurement of Emission Spectrum>

Table 4 shows the results of the relative value of the luminescence intensity (wavelength 630 nm) of each composition when the luminescence intensity of the composition of Comparative Example C1 was taken as 1.00, and the maximum emission wavelength (wavelength in the range of 300 to 780 nm) of each composition.

TABLE 4

| | | | | Relative | |
|---|---|---|---|---|---|
| | | | | value of | |
| | | | | lumines- | |
| | | | Coloring | cence | Maximum |
| | | Semi- | matter | intensity | emission |
| | | conductor | (total | (wave- | wave- |
| | Compo- | nano- | degree of | length | length |
| | sition | particles | branching) | 630 nm) | (nm) |
| Example C1 | C1 | InP/ZnSeS/ | B3-1 (4) | 1.20 | 630 |
| | | ZnS | | | |
| Comparative | C2 | InP/ZnSeS/ | None | 1.00 | 630 |
| Example C1 | | ZnS | | | |
| Comparative | C3 | None | B3-1 (4) | 0.19 | 533 |
| Example C2 | | | | | |
| Comparative | C4 | InP/ZnSeS/ | B3-2 (2) | 0.53 | 630 |
| Example C3 | | ZnS | | | |
| Comparative | C5 | None | B3-2 (2) | 0.04 | 529 |
| Example C4 | | | | | |

From Table 4, a composition in which semiconductor nanoparticles whose maximum emission wavelength in the wavelength range of 300 nm to 780 nm is in the range of 500 to 670 nm, and a coloring matter (B3) represented by the above-described Formula [III] and having a total degree of branching of 3 or more were used in combination (Example C1), had higher luminescence intensity at a wavelength of 630 nm as compared with compositions containing each of them alone (Comparative Examples C1 and C2).

Since both the semiconductor nanoparticles and the coloring matter B3-1 used in the Examples and the Comparative Examples have absorption at a wavelength of 445 nm, when the semiconductor nanoparticles and the coloring matter B3-1 are mixed, the relative value of the luminescence intensity is not the sum of the luminescence intensities of compositions each containing the semiconductor nanoparticles and the coloring matter alone. When the relative value of the luminescence intensity at a wavelength of 630 nm was calculated from a synthetic spectrum obtained by superimposing the emission spectrum of the coloring matter B3-1 in Example C1 (emission spectrum obtained by subtracting the emission spectrum of the semiconductor nanoparticles from the emission spectrum of Example C1) and the emission spectrum of the coloring matter B3-1 of Comparative Example C1, the relative value was 1.20. Therefore, it can be seen that the composition of Example C1 has enhanced luminescence intensity at a wavelength of 630 nm.

This is speculated that as the overlap between the emission spectrum derived from the chemical structure represented by the Formula [III] of the coloring matter (B3) and the absorption spectrum of the semiconductor nanoparticles (A) having a maximum emission wavelength of 500 to 670 nm was larger, the excited energy of the coloring matter (B3) was transferred to the semiconductor nanoparticles (A) by Forster-type energy transfer, and the luminescence intensity of the semiconductor nanoparticles (A) was increased. Furthermore, it is speculated that the efficiency of Forster-type energy transfer was further increased, as a group having the ester moiety represented by the above-described Formula [Ina] in the coloring matter (B3) interacts with the surface of the semiconductor nanoparticles (A), and the distance between the coloring matter (B3) and the semiconductor nanoparticles (A) is shortened.

Furthermore, it is considered that the coloring matter B3-1 has a structure in which R⁵ in Formula [Ma] is branched, and due to the steric hindrance of the structure, aggregates of the coloring matter molecules caused by π-π stacking or the like are less likely to be formed. Therefore, since a decrease in the fluorescence intensity (concentration quenching) caused by the formation of aggregates is also less likely to occur, the excited energy of the coloring matter (B3) was transferred to the semiconductor nanoparticles (A) by the Forster-type energy transfer, so that the luminescence intensity of the semiconductor nanoparticles (A) was further increased.

On the other hand, since the coloring matter B3-2 used in Comparative Example C3 has a small total degree of branching and high molecular planarity, aggregates of the coloring matter molecules are formed by π-π stacking or the like, a decrease in the fluorescence intensity (concentration quenching) is likely to occur, and the excitation energy is lost. For that reason, it is speculated that the luminescence intensity was lowered.

4. Experiment D

A light-scattering particle dispersion was prepared in the same manner as in Experiment A.

The emission spectra of the compositions produced in Examples and Comparative Examples that will be described later were measured in the same manner as in Experiment A.

The coloring matters (all purchased from Tokyo Chemical Industry Co., Ltd.) used in the Examples and Comparative Examples that will be described later are shown in Table 5.

The total degree of branching of Coumarin 521T is 5.

The total degree of branching of Coumarin 504T is 5.

The total degree of branching of Coumarin 545T is 5.

The total degree of branching of Coumarin 334 is 1.

The total degree of branching of Coumarin 314 is 1.

TABLE 5

| | |
|---|---|
| Coumarin 521T | 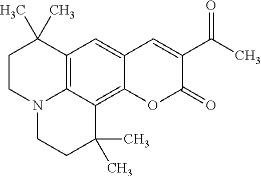 [SMILES: CC(=O)c1cc2cc3c4c(c2oc1=O)C(C)(C)CCN4CCC3(C)C] |
| Coumarin 504T | 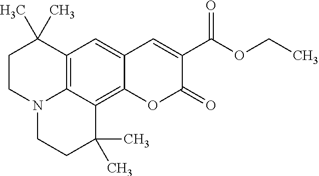 [SMILES: CCOC(=O)c1cc2cc3c4c(c2oc1=O)C(C)(C)CCN4CCC3(C)C] |
| Coumarin 545T | 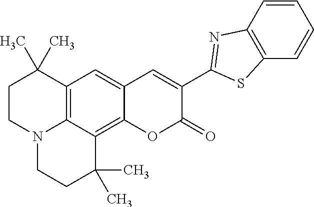 [SMILES: CC1(C)CCN2CCC(C)(C)c3c2c1cc1cc(-c2nc4ccccc4s2)c(=O)oc31] |
| Coumarin 334 | 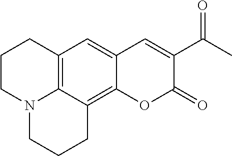 [SMILES: CC(=O)c1cc2cc3c4c(c2oc1=O)CCCN4CCC3] |
| Coumarin 314 | 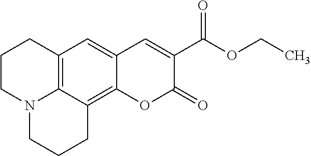 [SMILES: CCOC(=O)c1cc2cc3c4c(c2oc1=O)CCCN4CCC3] |

### Example D1

To 131 mg of a 30% by mass toluene solution of InP/ZnSeS/ZnS semiconductor nanoparticles (maximum emission wavelength over the wavelength range of 300 to 780 nm: 535 nm (excitation of a wavelength of 445 nm), having oleic acid as a ligand), 2 mg of pentaerythritol tetrakis(3-mercaptobutyrate) (manufactured by Showa Denko K.K., trade name “Karenz MT-PE1”), 0.3 mg of Coumarin 521T (manufactured by Tokyo Chemical Industry Co., Ltd.), and 19 mg of a light-scattering particle dispersion were added, and the mixture was mixed with a vortex mixer to obtain composition D1.

### Example D2

The process was carried out in the same manner as in Example D1, except that 0.6 mg of Coumarin 521T was added, and composition D2 was obtained.

### Comparative Example D1

The process was carried out in the same manner as in Example D1, except that Coumarin 521T was not added, and composition D3 was obtained.

### [Comparative Example D2] The process was carried out in the same manner as in Example D1, except that

InP/ZnSeS/ZnS semiconductor nanoparticles were not added, and composition D4 was obtained.

### Comparative Example D3

The process was carried out in the same manner as in Example D2, except that InP/ZnSeS/ZnS semiconductor nanoparticles were not added, and composition D5 was obtained.

### Comparative Example D4

The process was carried out in the same manner as in Example D1, except that Coumarin 334 was used instead of Coumarin 521T, and composition D6 was obtained.

### Comparative Example D5

The process was carried out in the same manner as in Example D2, except that Coumarin 334 was used instead of Coumarin 521T, and composition D7 was obtained.

### Comparative Example D6

The process was carried out in the same manner as in Comparative Example D2, except that Coumarin 334 was used instead of Coumarin 521T, and composition D8 was obtained.

### Comparative Example D7

The process was carried out in the same manner as in Comparative Example D3, except that Coumarin 334 was used instead of Coumarin 521T, and composition D9 was obtained.

### Example D3

To 118 mg of a 30% by mass toluene solution of InP/ZnSeS/ZnS semiconductor nanoparticles (maximum emission wavelength over the wavelength range of 300 to 780 nm: 630 nm (excitation of a wavelength of 445 nm), having oleic acid as a ligand), 2 mg of pentaerythritol tetrakis(3-mercaptobutyrate) (manufactured by Showa Denko K.K., trade name “Karenz MT-PE1”), 3 mg of Coumarin 504T (manufactured by Tokyo Chemical Industry Co., Ltd.), and 28 mg of a light-scattering particle dispersion were added, and the mixture was mixed with a vortex mixer to obtain composition D10.

### Example D4

The process was carried out in the same manner as in Example D3, except that 0.6 mg of Coumarin 521T was added instead of Coumarin 504T, and composition D11 was obtained.

### Example D5

The process was carried out in the same manner as in Example D3, except that 3 mg of Coumarin 521T was added instead of Coumarin 504T, and composition D12 was obtained.

### Example D6

The process was carried out in the same manner as in Example D3, except that 3 mg of Coumarin 545T (manufactured by Tokyo Chemical Industry Co., Ltd.) was added instead of Coumarin 504T, and composition D13 was obtained.

### Comparative Example D8

The process was carried out in the same manner as in Example D3, except that Coumarin 504T was not added, and composition D14 was obtained.

### Comparative Example D9

The process was carried out in the same manner as in Example D3, except that InP/ZnSeS/ZnS semiconductor nanoparticles were not added, and composition D15 was obtained.

### Comparative Example D10

The process was carried out in the same manner as in Example D4, except that InP/ZnSeS/ZnS semiconductor nanoparticles were not added, and composition D16 was obtained.

### Comparative Example D11

The process was carried out in the same manner as in Example D5, except that InP/ZnSeS/ZnS semiconductor nanoparticles were not added, and composition D17 was obtained.

### Comparative Example D12

The process was carried out in the same manner as in Example D6, except that InP/ZnSeS/ZnS semiconductor nanoparticles were not added, and composition D18 was obtained.

### Comparative Example D13

The process was carried out in the same manner as in Example D3, except that Coumarin 314 was used instead of Coumarin 504T, and composition D19 was obtained.

### Comparative Example D14

The process was carried out in the same manner as in Example D4, except that Coumarin 334 was used instead of Coumarin 521T, and composition D20 was obtained.

### Comparative Example D15

The process was carried out in the same manner as in Example D3, except that Coumarin 334 was used instead of Coumarin 504T, and composition D21 was obtained.

### Comparative Example D16

The process was carried out in the same manner as in Comparative Example D9, except that Coumarin 314 was used instead of Coumarin 504T, and composition D22 was obtained.

### Comparative Example D17

The process was carried out in the same manner as in Example D10, except that Coumarin 334 was used instead of Coumarin 521T, and composition D23 was obtained.

### Comparative Example D18

The process was carried out in the same manner as in Comparative Example D9, except that Coumarin 334 was used instead of Coumarin 504T, and composition D24 was obtained.

Table 6 shows the results of the relative value of the luminescence intensity (wavelength 535 nm) of each composition of Examples D1 and D2 and Comparative Examples D1 to D7 when the luminescence intensity of the composition of Comparative Example D1 was taken as 1.00, and the maximum emission wavelength (wavelength in the range of 300 to 780 nm) of each composition.

Table 7 shows the results of the relative value of the luminescence intensity (wavelength 630 nm) of each composition of Examples D3 to D6 and Comparative Examples D8 to D18 when the luminescence intensity of the composition of Comparative Example D8 was taken as 1.00, and the maximum emission wavelength (wavelength in the range of 300 to 780 nm) of each composition.

TABLE 6

| | | | | Content | Relative | |
|---|---|---|---|---|---|---|
| | | | | proportion | value of | |
| | | | | of coloring | luminescence | Maximum |
| | | | Coloring matter | matter | intensity | emission |
| | | Semiconductor | (total degree of | (% by | (wavelength | wavelength |
| | Composition | nanoparticles | branching) | mass) | 535 nm) | (nm) |
| Example D1 | D1 | InP/ZnSeS/ZnS | Coumarin 521T | 0.20 | 2.36 | 535 |
| | | | (5) | | | |
| Example D2 | D2 | InP/ZnSeS/ZnS | Coumarin 521T | 0.39 | 2.26 | 535 |
| | | | (5) | | | |
| Comparative | D3 | InP/ZnSeS/ZnS | None | None | 1.00 | 535 |
| Example D1 | | | | | | |
| Comparative | D4 | None | Coumarin 521T | 0.20 | 0.59 | 479 |
| Example D2 | | | (5) | | | |
| Comparative | D5 | None | Coumarin 52IT | 0.39 | 0.57 | 480 |
| Example D3 | | | (5) | | | |
| Comparative | D6 | InP/ZnSeS/ZnS | Coumarin 334 | 0.20 | 1.48 | 535 |
| Example D4 | | | (1) | | | |
| Comparative | D7 | InP/ZnSeS/ZnS | Coumarin 334 | 0.39 | 1.48 | 535 |
| Example D5 | | | (1) | | | |
| Comparative | D8 | None | Coumarin 334 | 0.20 | 0.36 | 480 |
| Example D6 | | | (1) | | | |
| Comparative | D9 | None | Coumarin 334 | 0.39 | 0.36 | 480 |
| Example D7 | | | (1) | | | |

TABLE 7

| | | | | | Relative | |
|---|---|---|---|---|---|---|
| | | | | Content | value of | |
| | | | | proportion of | luminescence | Maximum |
| | | | Coloring matter | coloring | intensity | emission |
| | | Semiconductor | (total degree of | matter | (wavelength | wavelength |
| | Composition | nanoparticles | branching) | (% by mass) | 630 nm) | (nm) |
| Example D3 | D10 | InP/ZnSeS/ZnS | Coumarin 504T | 2.00 | 1.13 | 630 |
| | | | (5) | | | |
| Example D4 | D11 | InP/ZnSeS/ZnS | Coumarin 521T | 0.39 | 1.28 | 630 |
| | | | (5) | | | |
| Example D5 | D12 | InP/ZnSeS/ZnS | Coumarin 521T | 2.00 | 1.21 | 630 |
| | | | (5) | | | |
| Example D6 | D13 | InP/ZnSeS/ZnS | Coumarin 545T | 2.00 | 1.36 | 630 |
| | | | (5) | | | |
| Comparative | D14 | InP/ZnSeS/ZnS | None | None | 1.00 | 630 |
| Example D8 | | | | | | |
| Comparative | D15 | None | Coumarin 504T | 2.00 | 0.01 | 471 |
| Example D9 | | | (5) | | | |
| Comparative | D16 | None | Coumarin 521T | 0.39 | 0.03 | 480 |
| Example D10 | | | (5) | | | |
| Comparative | D17 | None | Coumarin 521T | 2.00 | 0.06 | 512 |
| Example D11 | | | (5) | | | |
| Comparative | D18 | None | Coumarin 545T | 2.00 | 0.20 | 529 |
| Example D12 | | | (5) | | | |
| Comparative | D19 | InP/ZnSeS/ZnS | Coumarin 314 | 2.00 | 0.56 | 630 |
| Example D13 | | | (1) | | | |
| Comparative | D20 | InP/ZnSeS/ZnS | Coumarin 334 | 0.39 | 0.90 | 630 |
| Example D14 | | | (1) | | | |
| Comparative | D21 | InP/ZnSeS/ZnS | Coumarin 334 | 2.00 | 0.60 | 630 |
| Example D15 | | | (1) | | | |
| Comparative | D22 | None | Coumarin 314 | 2.00 | 0.04 | 565 |
| Example D16 | | | (1) | | | |
| Comparative | D23 | None | Coumarin 334 | 0.39 | 0.02 | 481 |
| Example D17 | | | (1) | | | |
| Comparative | D24 | None | Coumarin 334 | 2.00 | 0.05 | 485 |
| Example D18 | | | (1) | | | |

From Table 6 and Table 7, compositions in which semiconductor nanoparticles (A) whose maximum emission wavelength in the wavelength range of 300 nm to 780 nm is in the range of 500 to 670 nm, and a coloring matter (B4) having a coumarin skeleton and having a total degree of branching of 3 or more were used in combination (Examples D1 to D6), had higher luminescence intensity at the maximum emission wavelength of the semiconductor nanoparticles (A), as compared with compositions containing each of them alone (Comparative Examples D1 to D3 and D8 to D12).

This is speculated that as the overlap between the emission spectrum derived from the coumarin skeleton of the coloring matter (B4) and the absorption spectrum of the semiconductor nanoparticles (A) having a maximum emission wavelength of 500 to 670 nm was larger, the excited energy of the coloring matter (B4) was transferred to the semiconductor nanoparticles (A) by Forster-type energy transfer, and the luminescence intensity of the semiconductor nanoparticles (A) was increased.

Furthermore, it is speculated that the coloring matter (B4) and the semiconductor nanoparticles (A) attract each other due to the interaction caused by the lone electron pair on the oxygen atom at the 1-position and the lone electron pair on the oxygen atom of the carbonyl group at the 2-position of the 2H-1-benzopyran-2-one skeleton that constitutes the coumarin skeleton of the coloring matter (B4), and as the distance between the coloring matter (B4) and the semiconductor nanoparticles (A) was shortened, the efficiency of the Forster-type energy transfer was further increased.

Furthermore, it is considered that all of Coumarin 521T, Coumarin 504T, and Coumarin 545T used in Examples D1 to D6 have quaternary carbon atoms at the positions of R⁴ and R⁶ in the above-described Formula [IV-1], and due to their steric hindrance, the formation of aggregates of the coloring matter (B4) molecules caused by π-π stacking or the like is less likely to be achieved. Therefore, since a decrease in the fluorescence intensity (concentration quenching) caused by the formation of aggregates is less likely to occur, the excited energy of the coloring matter (B4) was transferred to the semiconductor nanoparticles (A) by the Forster-type energy transfer, so that the luminescence intensity of the semiconductor nanoparticles (A) was further increased.

On the other hand, in Comparative Examples D4, D5, and D13 to D15, since Coumarin 314 and Coumarin 334 have a small total degree of branching and high molecular planarity, aggregates of coloring matter molecules are formed by 7E-7E stacking or the like, a decrease in the fluorescence intensity (concentration quenching) is likely to occur, and the excitation energy is lost. For that reason, it is considered that the luminescence intensity at a wavelength of 535 nm or a wavelength of 630 nm was decreased as compared to the Examples.

5. Experiment E

A light-scattering particle dispersion was prepared in the same manner as in Experiment A.

The emission spectra of the compositions produced in Examples and Comparative Examples that will be described later were measured in the same manner as in Experiment A.

The coloring matters (all purchased from Sigma-Aldrich Corporation) used in the Examples and the Comparative Examples that will be described later are shown in Table 8.

TABLE 8

| | |
|---|---|
| B5-1 | 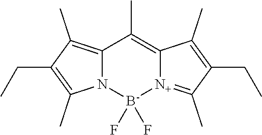 [SMILES: CCC1=C(C)C2=C(C)c3c(C)c(CC)c(C)n3[B-](F)(F)[N+]2=C1C] |
| B5-2 | 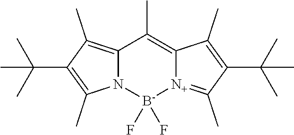 [SMILES: CC1=C(C(C)(C)C)C(C)=[N+]2C1=C(C)c1c(C)c(C(C)(C)C)c(C)n1[B-]2(F)F] |

### Example E1

To 118 mg of a 30% by mass toluene solution of InP/ZnSeS/ZnS semiconductor nanoparticles (maximum emission wavelength over the wavelength range of 300 to 780 nm: 630 nm (excitation of a wavelength of 445 nm), having oleic acid as a ligand), 1.5 mg of tetraphenyl dipropylene glycol diphosphite (manufactured by Johoku Chemical Co., Ltd., trade name “JPP-100”), 3 mg of coloring matter B5-1, and 28 mg of a light-scattering particle dispersion were added, and the mixture was mixed with a vortex mixer to obtain composition E1.

### Example E2

The process was carried out in the same manner as in Example E1, except that coloring matter B5-2 was added instead of coloring matter B5-1, and composition E2 was obtained.

### Comparative Example E1

The process was carried out in the same manner as in Example E1, except that coloring matter B5-1 was not added, and composition E3 was obtained.

### Comparative Example E2

The process was carried out in the same manner as in Example E1, except that InP/ZnSeS/ZnS semiconductor nanoparticles were not added, and composition E4 was obtained.

### Comparative Example E3

The process was carried out in the same manner as in Example E2, except that InP/ZnSeS/ZnS semiconductor nanoparticles were not added, and composition E5 was obtained.

Table 9 shows the results of the relative value of the luminescence intensity (wavelength 630 nm) of each composition when the luminescence intensity of the composition of Comparative Example E1 was taken as 1.00, and the maximum emission wavelength (wavelength in the range of 300 to 780 nm) of each composition.

TABLE 9

| | | | | | Relative | |
|---|---|---|---|---|---|---|
| | | | | | value of | |
| | | | | Blue light | luminescence | Maximum |
| | | | | absorptance | intensity | emission |
| | | Semiconductor | Coloring | (wavelength | (wavelength | wavelength |
| | Composition | nanoparticles | matter | 445 nm) | 630 nm) | (nm) |
| Example E1 | E1 | InP/ZnSeS/ZnS | B5-1 | 0.52 | 1.00 | 630 |
| Example E2 | E2 | InP/ZnSeS/ZnS | B5-2 | 0.56 | 1.11 | 630 |
| Comparative | E3 | InP/ZnSeS/ZnS | None | 0.44 | 1.00 | 630 |
| Example E1 | | | | | | |
| Comparative | E4 | None | B5-1 | 0.34 | 0.08 | 561 |
| Example E2 | | | | | | |
| Comparative | E5 | None | B5-2 | 0.30 | 0.14 | 579 |
| Example E3 | | | | | | |

From Table 9, in compositions in which semiconductor nanoparticles whose maximum emission wavelength in the wavelength range of 300 nm to 780 nm is in the range of 500 to 670 nm, and a coloring matter (B5) having a partial structure represented by the above-described Formula [V] were used in combination (Examples E1 and E2), the luminescence intensity at a wavelength of 630 nm was enhanced or maintained and the blue light absorptance was enhanced, as compared with the compositions containing each of them alone (Comparative Examples E1 to E3).

In Examples E1 and E2, the reason why the luminescence intensity of the semiconductor nanoparticles was increased or maintained regardless of the presence of a coloring matter having absorption at a wavelength of 445 nm, is that the excited energy of the coloring matters (B5-1 and B5-2) was transferred to the semiconductor nanoparticles by Forster-type energy transfer. Furthermore, particularly, the following three points may be mentioned as the reason why Forster-type energy transfer is likely to occur in the coloring matters (B5-1 and B5-2).

First, as the overlap between the emission spectrum derived from the partial structure represented by the Formula [V] of the coloring matter (B5) and the absorption spectrum of the semiconductor nanoparticles having a maximum emission wavelength of 500 to 670 nm was larger, the excited energy of the coloring matter (B5) was transferred to the semiconductor nanoparticles by Forster-type energy transfer, and the luminescence intensity of the semiconductor nanoparticles was increased.

Second, it is considered that a fluoro group in Formula [V] of the coloring matter (B5) caused an interaction with the surface of the semiconductor nanoparticles, the distance between the coloring matter and the semiconductor nanoparticles was shortened, and therefore, the efficiency of Forster-type energy transfer was further increased.

Thirdly, it is considered that due to the steric hindrance caused by R¹ and R² in Formula [V] of the coloring matter (B5), aggregates of the coloring matter (B5) molecules caused by π-π stacking or the like are less likely to be formed. Accordingly, since a decrease in the fluorescence intensity (concentration quenching) caused by the formation of aggregates is less likely to occur, the excited energy of the coloring matter (B5) was transferred to the semiconductor nanoparticles by the Forster-type energy transfer, and therefore, the luminescence intensity of the semiconductor nanoparticles was maintained or increased, while the blue light absorptance was enhanced.

### INDUSTRIAL APPLICABILITY

According to the present invention, a semiconductor nanoparticle-containing composition capable of forming a wavelength conversion layer that efficiently converts the wavelength of excitation light and exhibits a sufficient luminescence intensity, a color filter having a pixel part obtained by curing the composition, and an image display device having the color filter, can be provided.

### REFERENCE SIGNS LIST

10: Pixel part
10a: First pixel part
10b: Second pixel part
10c: Third pixel part
11a: First semiconductor nanoparticles
11b: Second semiconductor nanoparticles
12a: First light-scattering particles
12b: Second light-scattering particles
13a: First cured component
13b: Second cured component
13c: Third cured component
14a: First coloring matter
14b: Second coloring matter
20: Light-shielding part
30: Light conversion layer
40: Base material
100: Color filter

1. A semiconductor nanoparticle-containing composition comprising:
semiconductor nanoparticles (A); and
a coloring matter (B),
wherein the semiconductor nanoparticle-containing composition further comprises a polymerizable compound (C),
the semiconductor nanoparticles (A) have a maximum emission wavelength in a range of 500 to 670 nm over a wavelength range of 300 to 780 nm, and
the coloring matter (B) comprises at least one selected from the group consisting of:
a coloring matter (B1) having a partial structure represented by General Formula [I]: 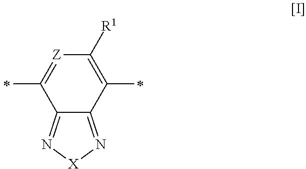
in General Formula [1], X represents an O atom or a S atom,
Z represents CR² or a N atom,
R¹ and R² each independently represent a hydrogen atom or any substituent, and
* represents a linking bond;
a coloring matter (B2) represented by General Formula [II]: 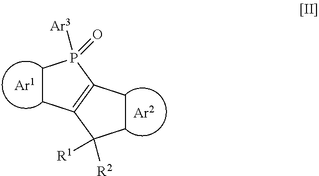
in General Formula [II], Ar¹, Ar², and Ar³ each independently represent an aryl group which may have a substituent, and
R¹ and R² each independently represent an alkyl group which may have a substituent, or an aryl group which may have a substituent;
a coloring matter (B3) represented by General Formula [III] and having a total degree of branching of 3 or more: 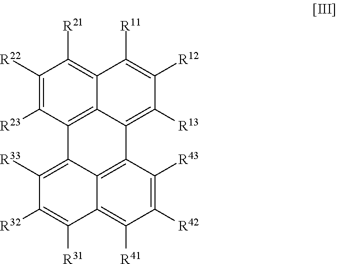
in General Formula [III], R¹¹, R²¹, R³¹, and R⁴¹ each independently represent a hydrogen atom or any substituent,
provided that one or more of R¹¹, R²¹, R³¹, and R⁴¹ are each a group represented by General Formula [IIIa]: 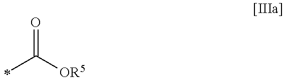
in General Formula [IIIa], R⁵ represents a hydrogen atom or any substituent, and
* represents a linking bond, and
R¹², R¹³, R²², R²³, R³², R³³, R⁴², and R⁴³ each independently represent a hydrogen atom or any substituent;
a coloring matter (B4) having a coumarin skeleton and having a total degree of branching of 3 or more; and
a coloring matter (B5) represented by General Formula [V]: 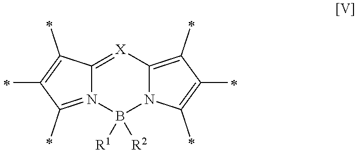
in General Formula [V], X represents C—* or N,
* represents a linking bond, and
R¹ and R² each independently represent a fluorine atom or a cyano group.

2. A semiconductor nanoparticle-containing composition comprising:
semiconductor nanoparticles (A); and
a coloring matter (B),
wherein the semiconductor nanoparticle-containing composition further comprises light-scattering particles,
the semiconductor nanoparticles (A) have a maximum emission wavelength in a range of 500 to 670 nm over a wavelength range of 300 to 780 nm, and
the coloring matter (B) comprises at least one selected from the group consisting of:
a coloring matter (B1) having a partial structure represented by General Formula [I]: 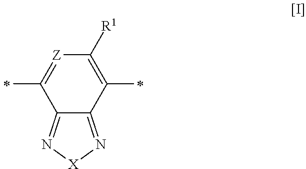
in General Formula [1], X represents an O atom or a S atom,
Z represents CR² or a N atom,
R¹ and R² each independently represent a hydrogen atom or any substituent, and
* represents a linking bond;
a coloring matter (B2) represented by General Formula [II]: 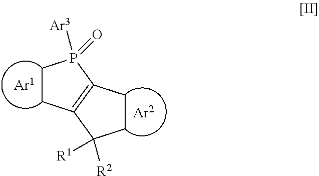
in General Formula [II], Ar¹, Ar², and Ar³ each independently represent an aryl group which may have a substituent, and
R¹ and R² each independently represent an alkyl group which may have a substituent, or an aryl group which may have a substituent;
a coloring matter (B3) represented by General Formula [III] and having a total degree of branching of 3 or more: 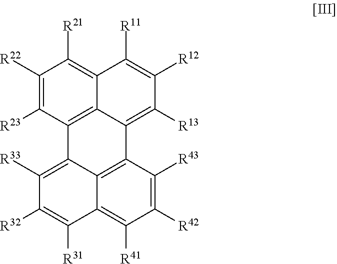
in General Formula [III], R¹¹, R²¹, R³¹, and R⁴¹ each independently represent a hydrogen atom or any substituent,
provided that one or more of R¹¹, R²¹, R³¹, and R⁴¹ are each a group represented by General Formula [IIIa]: 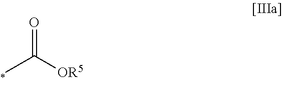
in General Formula [IIIa], R⁵ represents a hydrogen atom or any substituent, and
* represents a linking bond, and
R¹², R¹³, R²², R²³, R³², R³³, R⁴², and R⁴³ each independently represent a hydrogen atom or any substituent;
a coloring matter (B4) having a coumarin skeleton and having a total degree of branching of 3 or more; and
a coloring matter (B5) represented by General Formula [V]: 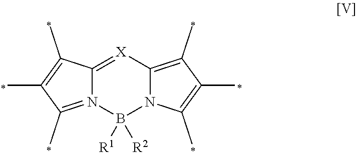
in General Formula [V], X represents or N,
* represents a linking bond, and
R¹ and R² each independently represent a fluorine atom or a cyano group.

3. A semiconductor nanoparticle-containing composition comprising:
semiconductor nanoparticles (A) whose maximum emission wavelength over a wavelength range of 300 to 780 nm is in a range of 500 to 670 nm; and
a coloring matter (B),
wherein the coloring matter (B) comprises a coloring matter (B1) having a partial structure represented by General Formula [1]: 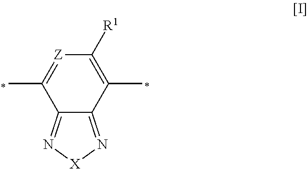
in General Formula [I], X represents an O atom or a S atom,
Z represents CR² or a N atom,
R¹ and R² each independently represent a hydrogen atom or any substituent, and
* represents a linking bond.

4. A semiconductor nanoparticle-containing composition comprising:
semiconductor nanoparticles (A) whose maximum emission wavelength over a wavelength range of 300 to 780 nm is in a range of 500 to 670 nm; and
a coloring matter (B),
wherein the coloring matter (B) comprises a coloring matter (B2) represented by General Formula [II]: 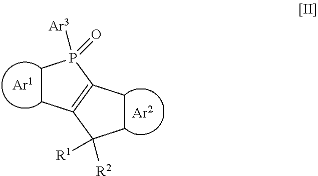
in General Formula [II], Ar¹, Ar², and Ar³ each independently represent an aryl group which may have a substituent, and
R¹ and R² each independently represent an alkyl group which may have a substituent, or an aryl group which may have a substituent.

5. A semiconductor nanoparticle-containing composition comprising:
semiconductor nanoparticles (A) whose maximum emission wavelength over a wavelength range of 300 to 780 nm is in a range of 500 to 670 nm; and
a coloring matter (B),
wherein the coloring matter (B) comprises a coloring matter (B3) represented by General Formula [III] and having a total degree of branching of 3 or more: 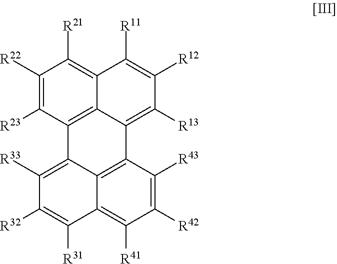
in General Formula [III], R¹¹, R²¹, R³¹, and R⁴¹ each independently represent a hydrogen atom or any substituent, provided that one or more of R¹¹, R²¹, R³¹, and R⁴¹ are each a group represented by General Formula [Ma]: 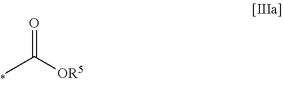
in General Formula [IIIa], R⁵ represents a hydrogen atom or any substituent, and
* represents a linking bond, and
R¹², R¹³, R²², R²³, R³², R³³, R⁴², and R⁴³ each independently represent a hydrogen atom or any substituent.

6. A semiconductor nanoparticle-containing composition comprising:
semiconductor nanoparticles (A) whose maximum emission wavelength over a wavelength range of 300 to 780 nm is in a range of 500 to 670 nm; and
a coloring matter (B),
wherein the coloring matter (B) comprises a coloring matter (B4) having a coumarin skeleton and having a total degree of branching of 3 or more.

7. A semiconductor nanoparticle-containing composition comprising:
semiconductor nanoparticles (A) whose maximum emission wavelength over a wavelength range of 300 to 780 nm is in a range of 500 to 670 nm; and
a coloring matter (B),
wherein the coloring matter (B) comprises a coloring matter (B5) represented by General Formula [V]: 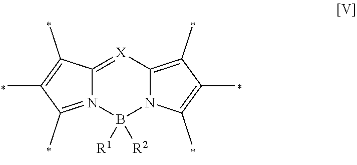
in General Formula [V], X represents C—* or N,
* represents a linking bond, and
R¹ and R² each independently represent a fluorine atom or a cyano group.

8. The semiconductor nanoparticle-containing composition according to claim 3,
wherein the coloring matter (B1) is a coloring matter represented by General Formula [1-1]: 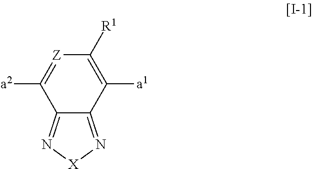
in General Formula [1-1], X represents an O atom or a S atom,
Z represents CR² or a N atom,
R¹ and R² each independently represent a hydrogen atom or any substituent, and
a¹ and a² each independently represent a group represented by General Formula [I-1a]: 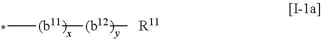
in General Formula [I-1a], b¹¹ represents an arylene group which may have a substituent, a —CH═CH— group which may have a substituent, a —C≡C— group, a —CH═N— group which may have a substituent, a —N═CH— group which may have a substituent, a —CO— group, or a —N═N— group,
b¹² represents a single bond or a divalent group other than b¹¹,
x represents an integer of 0 to 3, when x is an integer of 2 or more, a plurality of b¹¹'s may be identical or different,
y represents an integer of 1 to 3, when y is an integer of 2 or more, a plurality of b¹²'s may be identical or different,
R¹¹ represents a hydrogen atom or any substituent; and
* represents a linking bond.

9. The semiconductor nanoparticle-containing composition according to claim 4,
wherein Ar² in General Formula [II] is a group represented by any one of General Formula [IIa], General Formula [IIb], and General Formula [IIc]: 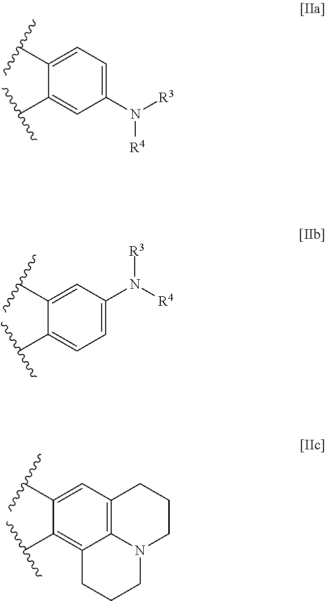
in General Formulae [IIa] and [IIb], R³ and R⁴ each independently represent an alkyl group which may have a substituent, or an aryl group which may have a substituent.

10. The semiconductor nanoparticle-containing composition according to claim 4,
wherein Ar¹ in General Formula [II] is a benzene ring group or a naphthalene ring group.

11. The semiconductor nanoparticle-containing composition according to claim 4,
wherein R¹ and R² in General Formula [II] are each independently an aryl group which may have a substituent.

12. The semiconductor nanoparticle-containing composition according to claim 5,
wherein R⁵ in General Formula [III] is a hydrogen atom or a hydrocarbon group which may have a substituent, provided that some of —CH₂— in the hydrocarbon group may be substituted with —O—.

13. The semiconductor nanoparticle-containing composition according to claim 5,
wherein in General Formula [III], two or more of R¹¹, R²¹, R³¹, and R⁴¹ are each a group represented by General Formula [IIIa]: 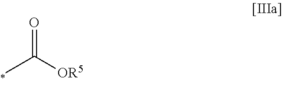
in General Formula [IIIa], R⁵ represents a hydrogen atom or any substituent, and
* represents a linking bond.

14. The semiconductor nanoparticle-containing composition according to claim 6,
wherein the coloring matter (B4) is a coloring matter represented by General Formula [IV-1] and having a total degree of branching of 3 or more: 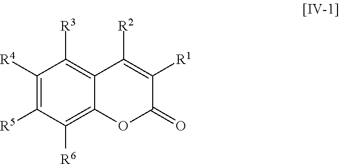
in General Formula [IV-1], R¹, R², R³, R⁴, and R⁶ each independently represent a hydrogen atom or any substituent,
R⁵ represents a hydrogen atom, N(R⁷)₂, or OR⁷,
when R⁵ is N(R⁷)₂, R⁷'s may be linked to form a ring,
R⁷ represents a hydrogen atom or any substituent, and
two or more selected from the group consisting of R⁴, R⁵, and R⁶ may be linked to form a ring.

15. The semiconductor nanoparticle-containing composition according to claim 14,
wherein R¹ in General Formula [1V-1] is a group represented by General Formula [IV-1a]: 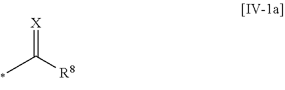
in General Formula [IV-1a], X represents an oxygen atom, a sulfur atom, or NR⁹,
R⁸ represents a hydrogen atom or any substituent,
R⁹ represents a hydrogen atom or an alkyl group,
when X is NR⁹, R⁹ and R⁸ may be linked to form a ring, and
* represents a linking bond.

16. The semiconductor nanoparticle-containing composition according to claim 7,
wherein the coloring matter (B5) is represented by General Formula [V-1]: 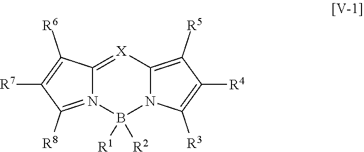
in General Formula [V-1], X represents C—R⁹ or N,
R³ to R⁹ each independently represent a hydrogen atom or any substituent,
R⁴ and R³ or R⁵ may be linked to form a ring,
R⁷ and R⁶ or R⁸ may be linked to form a ring, and
R¹ and R² each independently represent a fluorine atom or a cyano group.

17. The semiconductor nanoparticle-containing composition according to claim 16,
wherein in General Formula [V-1], R¹ and R² are each a fluorine atom, X is C—R⁹, and R⁹ is a hydrogen atom or any substituent.

18. The semiconductor nanoparticle-containing composition according to claim 2, further comprising a polymerizable compound (C).

19. The semiconductor nanoparticle-containing composition according to claim 1,
wherein the semiconductor nanoparticle-containing composition includes a (meth)acrylate-based compound as the polymerizable compound (C).

20. The semiconductor nanoparticle-containing composition according to claim 1, further comprising a polymerization initiator (D).

21. The semiconductor nanoparticle-containing composition according to claim 1, further comprising light-scattering particles.

22. The semiconductor nanoparticle-containing composition according to claim 1,
wherein the semiconductor nanoparticle-containing composition is used for an inkjet method.

23. A color filter comprising a pixel part prepared by curing the semiconductor nanoparticle-containing composition according to claim 1.

24. An image display device comprising the color filter according to claim 23.
